(19) United States
(12) Patent Application Publication
(10) Pub. No.: US 2010/0059604 A1
(43) Pub. Date: Mar. 11, 2010

(54) Shower apparatus

(75) Inventors: Takahiro Ohashi, Fukuoka-ken (JP); Kazuki Kuroda, Fukuoka-ken (JP); Takuya Oshikawa, Fukuoka-ken (JP); Ryoko Ishimaru, Fukuoka-ken (JP)

Correspondence Address: CARRIER BLACKMAN AND ASSOCIATES, 43440 WEST TEN MILE ROAD, EATON CENTER, NOVI, MI, 48375, US

(73) Assignee: Toto Ltd., Kitakyushu-shi (JP)

(21) Appl. No.: 12/584,575

(22) Filed: Sep. 8, 2009

Related U.S. Application Data
(63) Continuation-in-part of application No. 11/681,296, filed on Mar. 2, 2007.
(60) Provisional application No. 61/094,988, filed on Sep. 8, 2008.

(30) Foreign Application Priority Data
Mar. 2, 2006 (JP) 2006-056992
Mar. 1, 2007 (JP) PCT/JP07/53975

(51) Int. Cl. B05B 3/16

(52) U.S. Cl. 239/239

(57) ABSTRACT

A shower apparatus includes: a shower unit operable for swinging and sprinkling water while swinging; a driving unit configured to generate driving force which is used for the swing of the shower unit by water; a shower channel configured to guide water to the shower unit via the driving unit; a power transmission unit configured to couple the driving unit with the shower unit and transmit the driving force generated by the driving unit to the shower unit; and a swing stop mechanism operable to stop the swinging of the shower unit. The shower unit sprinkles the water that is used for generating the driving force at the driving unit. The swing stop mechanism is configured to stop the swinging of the shower unit while keeping sprinkling water from the shower unit. The sprinkling flow rate from the shower unit before stopping the swinging is equal to the sprinkling flow rate from the shower unit after stopping the swinging.

### CROSS-REFERENCE TO RELATED APPLICATIONS

This application is based upon and claims the benefit of priority from the prior U.S. patent application Ser. No. 11/681,296 filed on Mar. 2, 2007 and U.S. Provisional Patent Application 61/094,988, filed on Sep. 8, 2008; the entire contents of which are incorporated herein by reference.

### BACKGROUND OF THE INVENTION

1. Field of the Invention

This Invention relates to a shower apparatus for use in a bathroom, shower booth and the like.

2. Background Art

A shower apparatus capable of vertical reciprocating action is disclosed (Japanese Patent Application Publication No. 2-134119A(1990)), where a piston is combined with a four-way valve. In this shower apparatus, a piston provided in a cylinder is moved vertically by hydraulic pressure, and a shower head is moved vertically through a wire. The vertical motion of the piston is switched by switching the water supply channel to the cylinder using the four-way valve.

U.S. Pat. No. 7,014,128 discloses a shower apparatus which uses the rotation force of a waterwheel to reciprocate (swing) a shower unit.

### DISCLOSURE OF INVENTION

### Technical Problem

Usage scenes of a shower apparatus include the scene of taking a shower on a wide area of the body to wash off the soap and the like or to relax, and the scene of taking a shower on a particular site of the body to shampoo the hair or to intensively warm or stimulate the shoulder, waist and the like. That is, a shower apparatus having a reciprocating shower unit requires the state of changing the direction and position of water discharge, and the state of fixing the direction and position of water discharge.

Here, there is demand to ensure the continuity of the feeling of shower bathing when the aforementioned two states are switched. On the other hand, in the fixed state, there is demand to easily adjust the hit position of water discharge as desired.

Further ingenuities are required to meet these demands.

This invention has been made in view of these problems. An object of the invention is to provide a shower apparatus with improved feeling of shower bathing. More preferably, an object of the invention is to provide a shower apparatus with improved usability when switched between the state of discharging water while swinging the shower unit and the state of discharging water with the shower unit fixed.

### SUMMARY OF THE INVENTION

According to an aspect of the invention, there is provided a shower apparatus including: a shower unit operable for swinging and sprinkling water while swinging; a driving unit configured to generate driving force which is used for the swing of the shower unit by water; a shower channel configured to guide water to the shower unit via the driving unit; a power transmission unit configured to couple the driving unit with the shower unit and transmit the driving force generated by the driving unit to the shower unit; and a swing stop mechanism operable to stop the swinging of the shower unit, wherein the shower unit sprinkles the water that is used for generating the driving force at the driving unit, the swing stop mechanism is configured to stop the swinging of the shower unit while keeping sprinkling water from the shower unit, and the sprinkling flow rate from the shower unit before stopping the swinging is equal to the sprinkling flow rate from the shower unit after stopping the swinging.

According to another aspect of the invention, there is provided a shower apparatus including: a shower unit operable for swinging and sprinkling water while swinging; a driving unit configured to generate driving force which is used for the swing of the shower unit by water; a shower channel configured to guide water to the shower unit via the driving unit; a power transmission unit configured to couple the driving unit with the shower unit and transmit the driving force generated by the driving unit to the shower unit; and a swing stop mechanism operable to stop the swinging of the shower unit, wherein the shower unit sprinkles the water that is used for generating the driving force at the driving unit, the swing stop mechanism is operable to restart the swinging of the shower unit by operation of the driving unit irrespective of the stopped position of the shower unit, and a sprinkling direction of the shower unit can be manually changed in a state where the swinging of the shower unit is stopped while keeping sprinkling the water.

According to another aspect of the invention, there is provided a shower apparatus including: a shower unit operable for swinging; a shower channel configured to guide water to the shower unit; a driving unit provided on the shower channel and including a core moved by water and two pressure chambers formed across the core; a control mechanism configured to reverse moving direction of the core; a power transmission unit configured to couple between the driving unit and the shower unit and transmit motion of the core to the shower unit; and a bypass channel communicating between the two pressure chambers; and an opening degree adjustment valve provided on the bypass channel, the opening degree adjustment valve being operable to adjust pressure difference occurring between the two pressure chambers.

### BRIEF DESCRIPTION OF THE DRAWINGS

FIG. 1 is a schematic view for describing the operation mechanism of a driving unit 100;

FIG. 2 is a schematic view for describing the mechanism of the driving unit 100;

FIG. 3 is a schematic view for describing the mechanism of the driving unit 100;

FIG. 4 is a schematic view for describing the mechanism of the driving unit 100;

FIGS. 5A to 5C are schematic views for describing the operation and effect of providing an opening degree difference between introducing ports 132, 134;

FIG. 6 is a perspective view of the driving unit 100;

FIG. 7 is a perspective cutaway view of the driving unit 100;

FIG. 8 is a cross-sectional view of the driving unit 100;

FIG. 9 is a cross-sectional view along line A-A in FIG. 8;

FIG. 10 is a perspective view showing the main valve and the slide bar;

FIGS. 11A to 11C are schematic views showing the reciprocating action of the driving unit 100;

FIGS. 12A to 12D are schematic views for describing the operation of a control mechanism;

FIG. 13 is a schematic view of a driving unit including a control mechanism based on two springs;

FIG. 14 is a schematic view of a driving unit including a control mechanism based on two springs;

FIG. 15 is a schematic view of a driving unit including a control mechanism based on magnets;

FIG. 16 is a schematic view of a driving unit including a control mechanism based on magnets;

FIG. 17 is a schematic cross-sectional view showing a variation of the driving unit 100;

FIG. 18 is a perspective view of a driving unit 200;

FIG. 19 is a perspective cutaway view of the driving unit 200;

FIGS. 20A and 20B are a perspective view and a cutaway view of the driving unit 200 as viewed from the bottom side;

FIG. 21 is a vertical cross-sectional view of the driving unit 200;

FIG. 22 is a cross-sectional view along line B-B in FIG. 21;

FIGS. 23A to 23C are schematic views for describing the action of the driving unit;

FIG. 24 is a cross-sectional view showing the driving unit 200 according to a specific example of the invention;

FIG. 25 is a schematic view showing a shower booth 950 installed with a shower apparatus 4 according to a first embodiment of the invention;

FIG. 26 is a schematic view illustrating the external appearance of the shower apparatus 4;

FIG. 27 is a perspective view of the shower apparatus 4 as viewed from on high at an angle;

FIG. 28 is a front view of the shower apparatus 4;

FIG. 29 is a perspective view of the shower apparatus 4 as viewed from the rear at an angle;

FIG. 30 is a schematic view showing the channel configuration of the shower apparatus 4;

FIG. 31 is a cross-sectional view along line A-A in FIG. 28;

FIG. 32 is a cross-sectional view along line B-B in FIG. 28;

FIG. 33 is a cross-sectional view along line B-B in FIG. 28;

FIG. 34 is a cross-sectional view along line B-B in FIG. 28;

FIG. 35 is a cross-sectional view along line C-C in FIG. 31;

FIG. 36 is a cross-sectional view along line C-C in FIG. 31;

FIG. 37 is a schematic view of part of an opening/closing mechanism as viewed from the backside of a flame 400;

FIG. 38 is a cross-sectional view along line A-A in FIG. 37;

FIG. 39 is a cross-sectional view along line B-B in FIG. 37;

FIG. 40 is a cross-sectional view along line A-A in FIG. 37;

FIG. 41 is a cross-sectional view along line B-B in FIG. 37;

FIG. 42 is a schematic view illustrating the configuration of a shower apparatus 10 of a second embodiment;

FIG. 43 is a schematic perspective view illustrating the external appearance of the shower apparatus 10;

FIG. 44 is a plan cross-sectional view of the shower apparatus 10;

FIG. 45 is a schematic perspective view of a channel switching unit used in the shower apparatus 10;

FIGS. 46A and 46B are schematic views for illustrating the flow rate control by a switching valve 513;

FIGS. 47A and 47B are views of the channel switching unit and the switching valve corresponding to the state of FIG. 46A;

FIGS. 48A and 48B are views of the channel switching unit and the switching valve corresponding to the state of FIG. 46B;

FIGS. 49A and 49B are schematic views for illustrating the flow rate control by a switching valve 523;

FIGS. 50A and 50B are views of the channel switching unit and the switching valve corresponding to the state of FIG. 49A;

FIGS. 51A and 51B are views of the channel switching unit and the switching valve corresponding to the state of FIG. 49B;

FIGS. 52A and 52B are schematic cross-sectional views showing the channel switching unit having a switching valve 533;

FIG. 53 is a schematic perspective view illustrating a channel switching unit 544;

FIGS. 54A and 54B are schematic views for illustrating the flow rate control by the channel switching unit 544;

FIG. 55 is a schematic view for illustrating the configuration of a shower apparatus 11 according to a third embodiment;

FIG. 56 is a schematic exploded view for illustrating the shape of the shower apparatus 11;

FIG. 57 is a schematic view showing a part of a shower apparatus 5 according to a fourth embodiment of the invention;

FIG. 58 is a schematic view showing a part of the shower apparatus 5 according to the fourth embodiment of the invention;

FIG. 59 is a schematic view showing a part of the shower apparatus 5 according to the fourth embodiment of the invention;

FIG. 60 is a schematic view illustrating the configuration of a shower apparatus 12 according to a fifth embodiment;

FIG. 61 is a schematic view illustrating a first example of the driving unit used in the shower apparatus 12;

FIG. 62 is a schematic view illustrating a second example of the driving unit used in the shower apparatus 12; and

FIG. 63 is a schematic view showing the configuration of a shower apparatus 13 according to a sixth embodiment.

### DETAILED DESCRIPTION OF THE INVENTION

Embodiment of the invention will now be described with reference to the drawings.

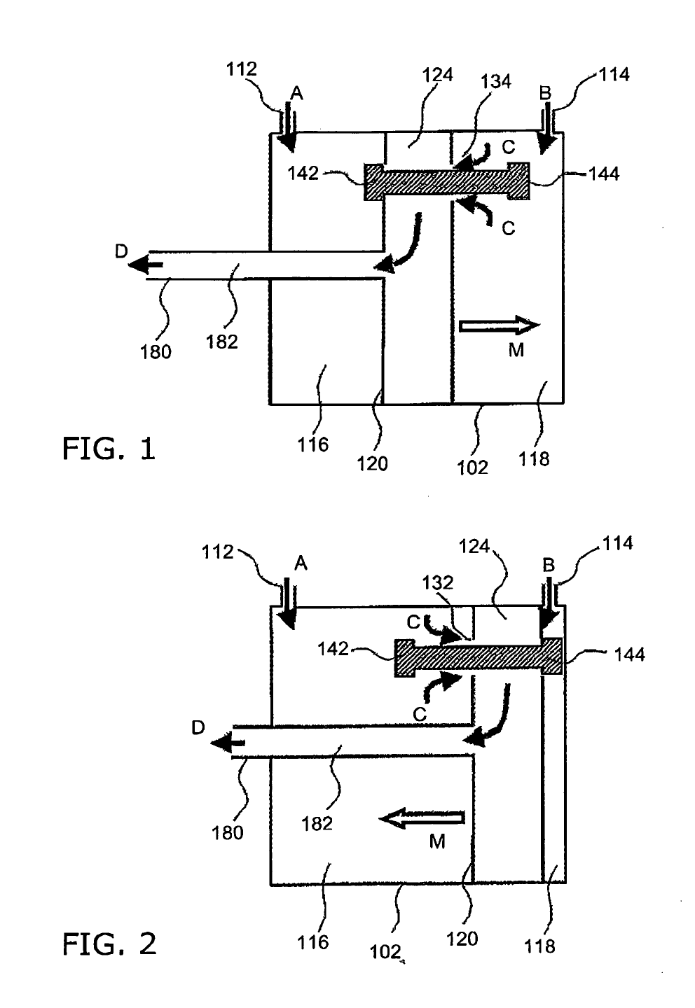

Firstly, the structure and the mechanism of a driving unit 100 provided in the shower apparatus of the embodiment are described in detail. FIGS. 1 to 4 are schematic views for describing the mechanism of the driving unit 100 of the embodiment. In addition, for convenience, the driving unit 100 is horizontally oriented, and a core 120 and a water discharge tubular body 180 are allowed to reciprocate horizontally in-plane of the paper.

More specifically, the driving unit 100 has a housing 102 and the water discharge tubular body 180 protruding from the housing 102. Inside the water discharge tubular body 180 is provided a water discharge channel 182. The housing 102 has two water inlet ports 112, 114. The water inlet ports 112, 114 are coupled in parallel. When water (including hot water and cold water) is supplied to the water inlet ports 112, 114 at nearly the same pressure, the water discharge tubular body 180 discharges water from the water discharge channel 182 while reciprocating right and left as shown by arrow M.

The driving unit 100 has the core 120 movably provided in the housing 102. The interior of the housing 102 is divided by the core 120 into a first pressure chamber 116 and a second pressure chamber 118. The core 120 has a hollow structure. The hollow space constitutes a core inner channel 124 communicating with the water discharge channel 182 provided in the water discharge tubular body 180. The core inner channel 124 communicates with pressure chambers 116, 118 via introducing ports (drain hole) 132, 134, respectively. More specifically, two pressure chambers are provided across the core.

The core 120 is provided with valve bodies 142, 144 for changing opening degree of the introducing ports 132, 134. The core 120 is also provided with a control mechanism for controlling the valve bodies 142, 144. The control mechanism can produce an opening degree difference between the introducing ports 132 and 134, thereby causing a difference in channel resistance between the right and left channel extending from the water inlet port to the core inner channel 124. The resulting pressure difference between the right and left pressure chamber 116, 118 can be used to move the core 120.

In the state shown in FIG. 1, the control mechanism causes the valve bodies 142, 144 to be biased to the right end, and an introducing port 134 for water is opened on the right side of the core 120. Therefore the water supplied from the water inlet port 114 flows from the pressure chamber 118 into the core inner channel 124 of the core 120 along the path shown by arrow C, passes through the water discharge channel 182 provided in the water discharge tubular body 180, and flows out as shown by arrow D. On the other hand, because the water supplied from the water inlet port 112 of the housing has no outflow path, the pressure in the pressure chamber 116 becomes higher than the pressure in the pressure chamber 118. As a result, the core 120 moves in the direction of arrow M.

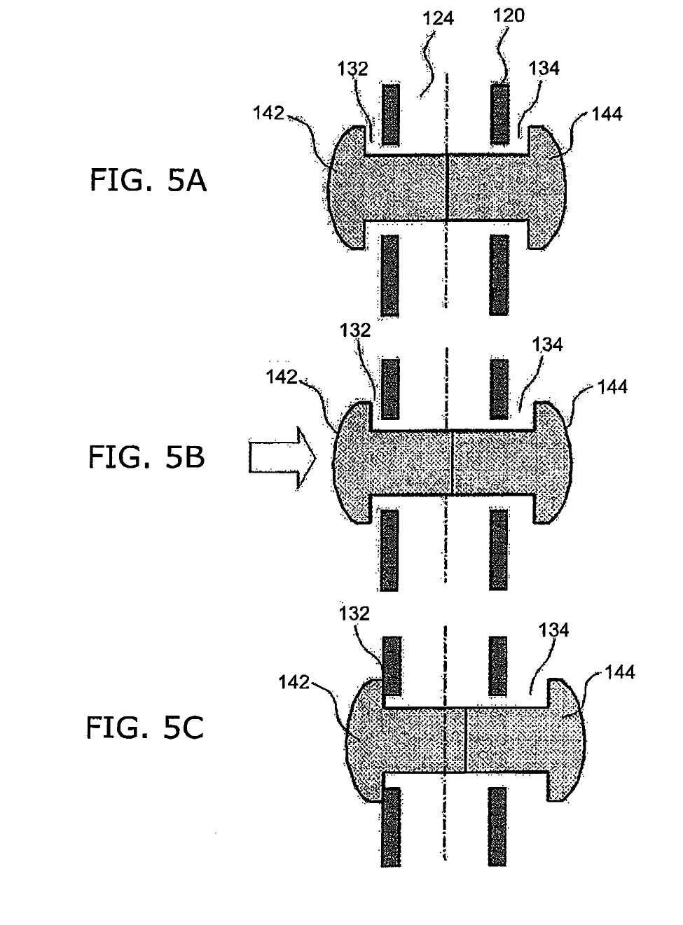

FIG. 5 is a schematic view for describing the function and effect of providing an opening degree difference between the introducing ports 132, 134. As illustrated in FIG. 5A, when the valve bodies 142, 144 are in a neutral state and the introducing ports 132, 134 have nearly the same opening degree, the channels through the introducing ports 132, 134 also have nearly the same channel resistance and hence cause no pressure difference between the right and left side of the core 120. Therefore, the core 120 does not move unless any external force acts thereon.

On the other hand, as illustrated in FIG. 5B, when the valve bodies 142, 144 deviate from the neutral state and an opening degree difference occurs between the introducing ports 132 and 134, a difference also occurs in the channel resistance and causes a pressure difference between the right and left side of the core 120.

Note that the “opening degree” of the introducing port used herein refers to a parameter determining the channel resistance for fluid flowing between the introducing port and the valve body. For example, in the state shown in FIG. 5B, the channel resistance of the channel formed between the introducing port 132 and the valve body 142 is larger than the channel resistance of the channel formed between the introducing port 134 and the valve body 144. In this case, the opening degree of the introducing port 132 is smaller than the opening degree of the introducing port 134. In the specific example shown in FIG. 5B, because the opening degree of the introducing port 134 is larger than the opening degree of the introducing port 132, the channel through the introducing port 132 has a larger channel resistance. As a result, the pressure on the left side of the core 120 is higher than that on the right side. Consequently, forces due to the pressure difference act on the core 120 and the valve body 142, respectively.

Hence, when the force applied to the core 120 exceeds the sliding resistance, the core 120 moves to the right side. On the other hand, the valve body 142 is also movable relative to the core 120. Hence, when the force applied to the valve body 142 exceeds the sliding resistance of the valve body 142, the valve body 142 moves to the right side relative to the core 120. If the valve body 142 moves to the right side, the channel through the introducing port 132 has an even higher channel resistance, which expands the pressure difference.

That is, the forces applied to the core 120 and the valve 142 are increased, respectively, and the movement of the core 120 and the valve body 142 is promoted. Ultimately, as shown in FIG. 5C, the introducing port 132 is fully opened. At this time, the left-right difference in channel resistance is maximized, and forces corresponding to the maximum pressure difference act on the core 120 and the valve body 142, respectively.

As described above, in the driving unit 100 of the embodiment, the core 120 can be moved simply by providing an opening degree difference between the introducing ports 132, 134 to produce a pressure difference required for the movement. Then the pressure difference is maximized by causing one of the introducing ports to be in the open state and the other to be in the closed state. This achieves the most reliable and stable force for the movement.

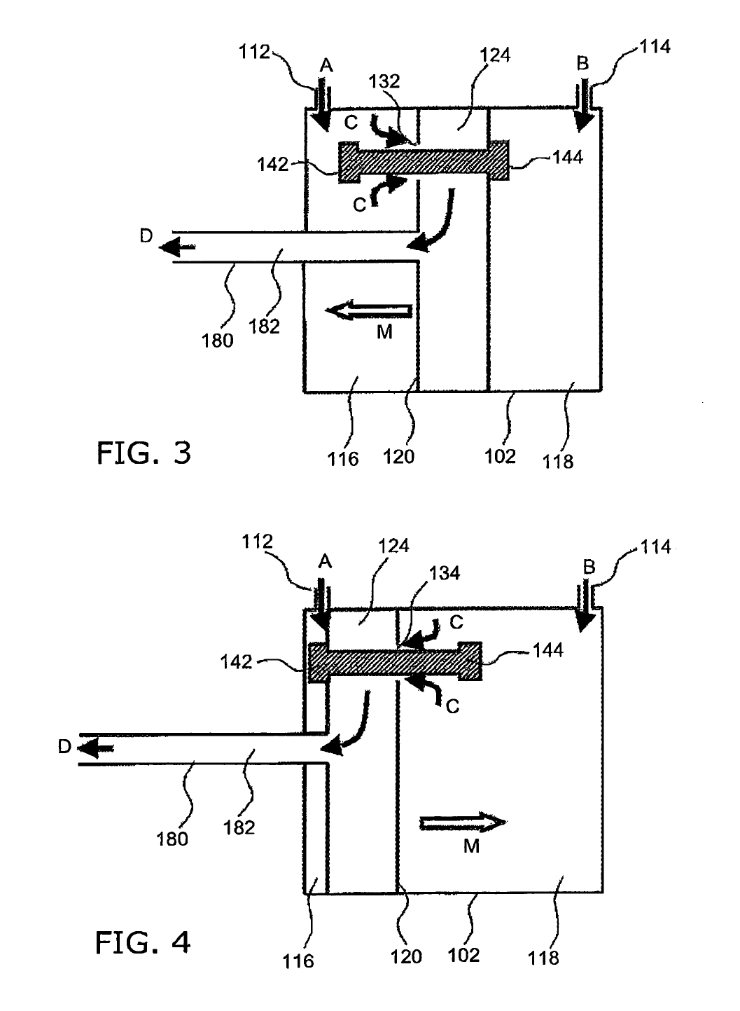

Returning again to FIG. 2, as shown in this figure, when the core 120 moves in the housing 102 to or near the right end of its moving stroke, the valve bodies 142, 144 move to the left side by the control mechanism. Then, the introducing port 134 on the right side of the core 120 is closed, and the introducing port 132 on the left side is opened. In this state, the water supplied from the water inlet port 112 flows from the pressure chamber 116 via the introducing port 132 into the core inner channel 124 of the core 120 as shown by arrow C, and flows out of the water discharge tubular body 180 as shown by arrow D. On the other hand, because the water supplied from the water inlet port 114 has no outflow path, the pressure in the pressure chamber 118 becomes higher than the pressure in the pressure chamber 116. As a result, the core 120 moves to the left as shown by arrow M in FIGS. 2 and 3.

When the core 120 continues to move to the left side and arrives at or near the left end of the housing 102 as shown in FIG. 4, the valve bodies 142, 144 move to the right side by the control mechanism. Then, as described above with reference to FIG. 1, the introducing port 132 on the left side of the core 120 is closed, and the introducing port 134 on the right side is opened. As a result, the pressure in the pressure chamber 116 becomes higher than the pressure in the pressure chamber 118, and the core 120 moves to the right side as shown by arrow M. Subsequently, by repeating the action described above with reference to FIGS. 1 to 4, the core 120 continues to reciprocate in the housing 102.

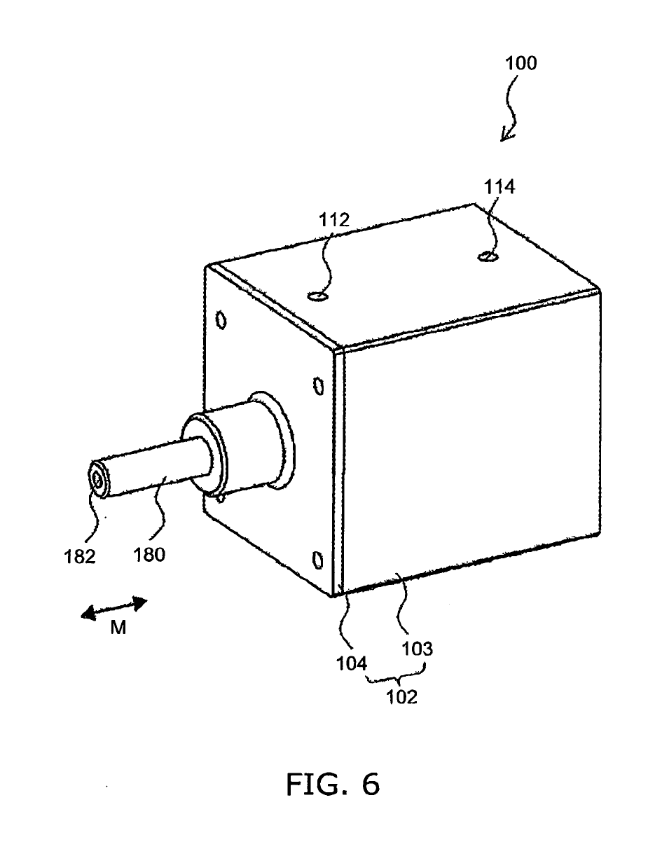

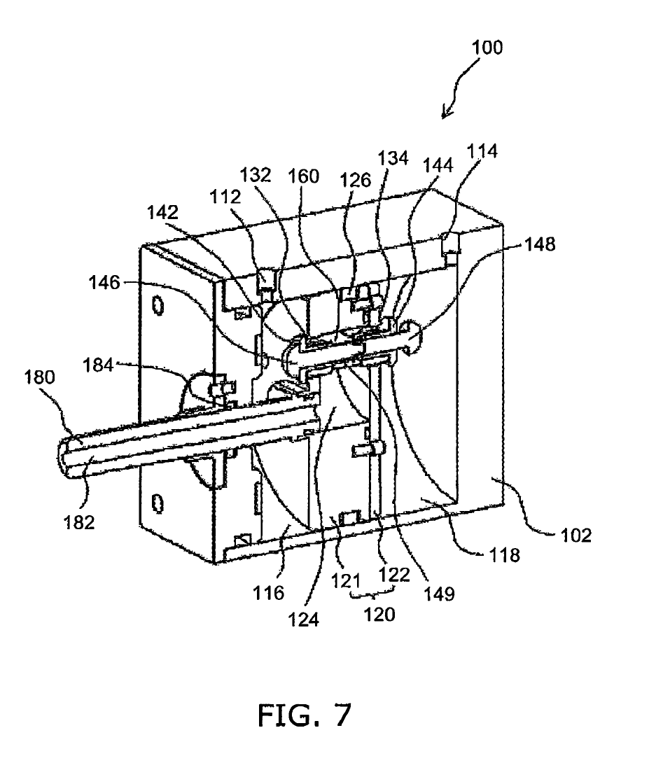

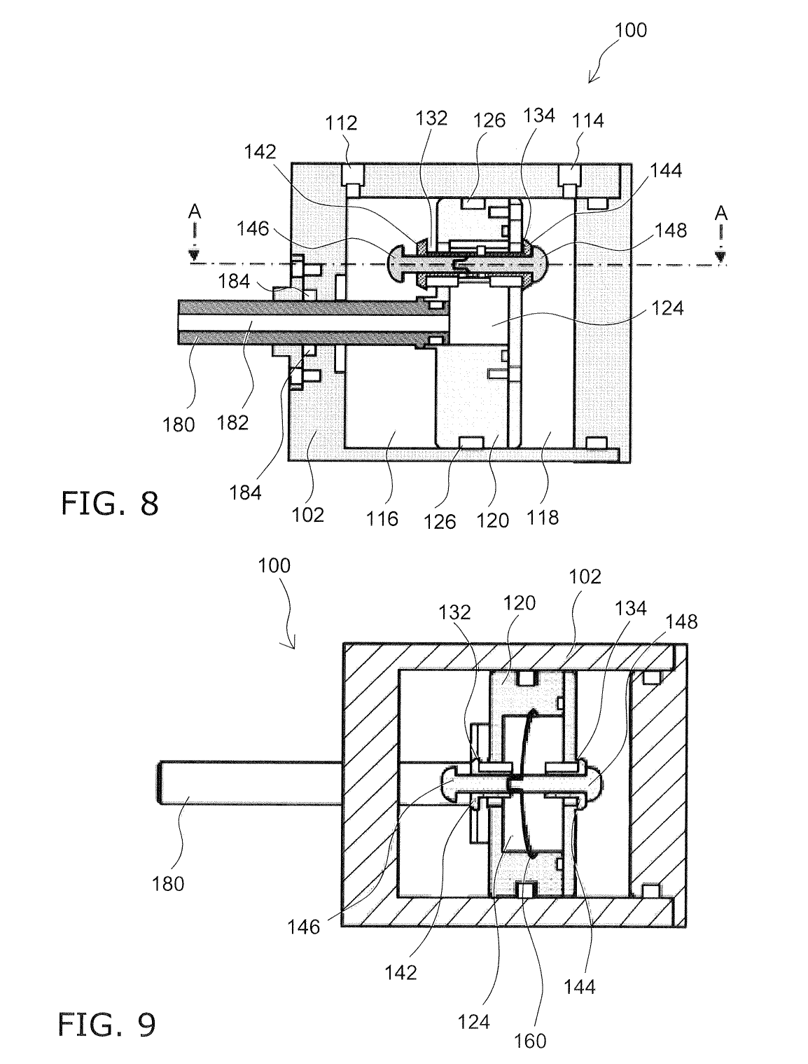

In the following, the structure of the driving unit 100 of the embodiment will be described in more detail with reference to specific examples. FIG. 6 is a perspective view of the driving unit 100 of the specific example, FIG. 7 is a perspective cutaway view thereof, FIG. 8 is a cross-sectional view, and FIG. 9 is a cross-sectional view along line A-A in FIG. 8. The driving unit 100 of the specific example has the water discharge tubular body 180 that illustratively protrudes from the housing 102 formed from a housing main body 103 and a housing lid 104. The water discharge tubular body 180 has a hollow structure having the water discharge channel 182 inside and opened at the tip. The water discharge tubular body 180 does not necessarily need to be shaped as a circular cylinder, but various other examples may be contemplated including a rectangular cylinder and a flattened shape.

When hot water is introduced into the water inlet ports 112, 114 provided in the housing main body 103, the water discharge tubular body 180 undergoes a reciprocating linear motion in the direction of arrow M.

The internal structure is described. As shown in FIGS. 7 to 9, the core 120 composed of a core main body 121 and a core lid 122 is movably contained in a tubular space inside the housing 102 formed from the housing main body 103 and the housing lid 104. The core 120 is coupled to the water discharge tubular body 180 protruding from the housing 102, and move like a piston, dividing the tubular space inside the housing 102 into the first pressure chamber 116 and the second pressure chamber 118. Water is introduced from the water inlet ports 112, 114 into the pressure chambers 116, 118, respectively. The sliding portion between the core 120 and the inner wall of the housing 102 is provided with a seal 126 for facilitating sliding while maintaining liquid tightness. The sliding portion between the tubular body 180 and the housing 102 is also provided with a seal 184 for the same purpose. The seals 126, 184 are for facilitating sliding while maintaining the liquid tightness and can be made of such materials as Teflon®, NBR (nitrile rubber), EPDM (ethylene-propylene rubber), and POM (polyacetal). The “liquid tightness” used herein can be satisfied by ensuring the condition sufficient for producing a pressure difference between the right and left pressure chamber.

Next, the structure of the core 120 is described. The core inner channel 124 is formed by combining the core lid 122 with the core main body 121. The core inner channel 124 communicates with the water discharge channel 182 provided in the water discharge tubular body 180. The core main body 121 and the core lid 122 have the introducing ports 132, 134 allowing the core inner channel 124 to communicate with the pressure chambers 116, 118.

In the specific example, a leaf spring 160 and slide bars 146, 148 are provided in the core 120 as the control mechanism. The slide bars 146, 148 are provided so as to traverse the core inner channel 124 with the main valves.

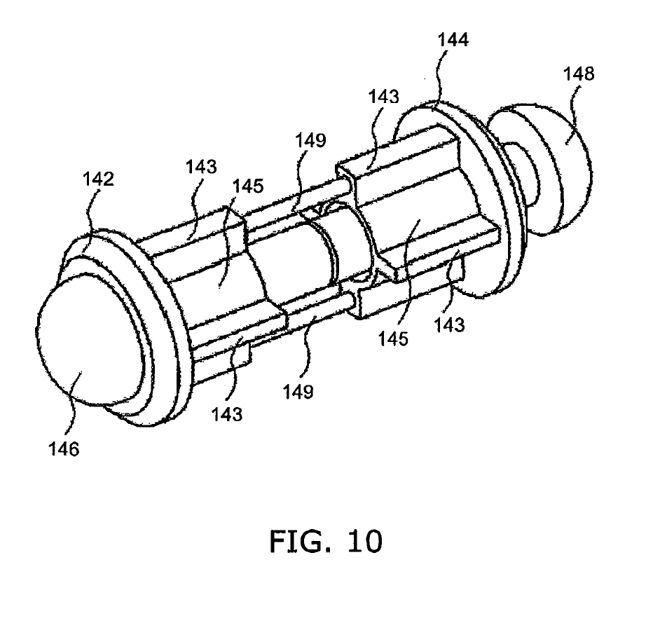

FIG. 10 is a perspective view showing the main valves and the slide bars. The right and left main valves 142, 144 are coupled to each other by coupling rods 149, and provided through the introducing ports 132, 134 provided in the core main body 121 and the core lid 122 so as to move from side to side. That is, the main valves 142, 144 as valve bodies are provided so as to move from side to side relatively to the core 120 with a prescribed stroke. Ribs 143 are formed on the main valves 142, 144 so that the main valves 142, 144 move coaxially with respect to the introducing ports 132, 134. When the main valves 142, 144 move away from the core 120, respectively, a groove portion 145 provided between the ribs 143 becomes the opening portion of the introducing ports 132, 134 and forms a channel for the water. Furthermore, the slide bars 146, 148 coaxially penetrating the main valves 142, 144 are also provided so as to move from side to side. That is, the slide bars 146, 148 are provided so as to move from side to side with a longer stroke than the action stroke of the main valves 142, 144.

As illustrated in FIGS. 8 to 9, when the main valve 142 is moved away from the core 120, the introducing port 132 is opened. Conversely, when the main valve 144 is moved away from the core 120, the introducing port 134 is opened. The introducing ports 132, 134 both communicate with the core inner channel 124. That is, the introducing port 132 allows the pressure chamber 116 in the housing to communicate with the core inner channel 124, and the introducing port 134 allows the pressure chamber 118 to communicate with the core inner channel 124.

The action of the main valves 142, 144 to vary the opening degree of the introducing ports 132, 134 is determined by the coaxially provided slide bars 146, 148. More specifically, as shown in FIG. 9, both sides of the slide bar 146, 148 are coupled to each other across the compressed leaf spring 160, and subjected to a biasing force toward the right end or the left end depending on the bend direction of the leaf spring 160. The leaf spring 160 is supported at both ends by the core 120. The slide bars 146, 148 move relatively to the core 120 via the leaf spring 160. The main valves 142, 144 are subjected to the biasing force from the slide bars 146, 148 to place the introducing ports 132, 134 to one of the fully open state and the fully closed state alternatively. That is, the slide bars 146, 148 and the leaf spring 160 act as a control mechanism to control the main valves 142, 144 as the valve bodies.

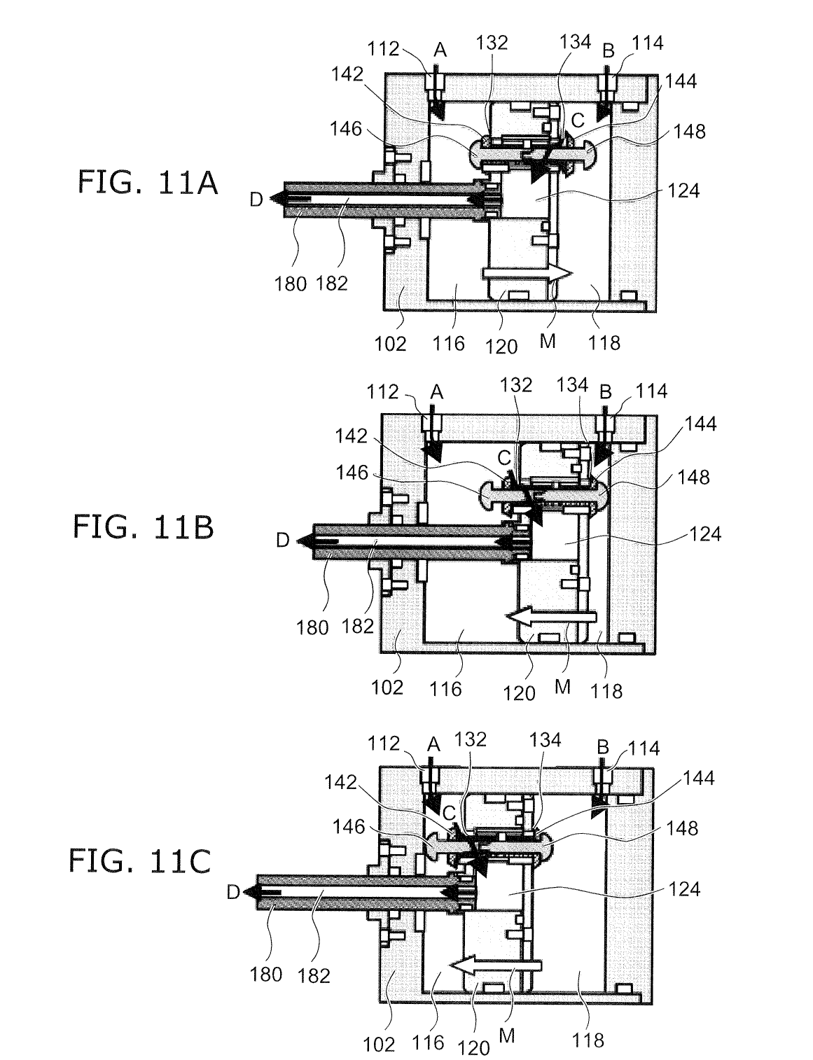

In the following, the action of the driving unit of the specific example is described. FIG. 11 is a schematic view for describing the reciprocating action of the driving unit of the specific example. More specifically, FIG. 11A shows a state where the slide bars 146, 148 are biased toward the right side under the action of the leaf spring 160. At this time, because the main valves 142, 144 are also biased toward the right side by the slide bar 146, a state occurs where the introducing port 132 is closed and the introducing port 134 is opened.

In this state, when water is supplied to the water inlet ports 112, 114 at nearly the same pressure, the water introduced from the water inlet port 114 into the pressure chamber 118 as shown by arrow B flows from the introducing port 134 into the core inner channel 124 as shown by arrow C and flows out as shown by arrow D via the water discharge channel 182. On the other hand, because the introducing port 132 is closed, the water introduced from the water inlet port 112 into the pressure chamber 116 as shown by arrow A has no outflow path and the pressure in the pressure chamber 116 becomes higher than the pressure in the pressure chamber 118. That is, by providing an opening degree difference between the introducing ports 132, 134, a difference in the channel resistance occurs, which causes a pressure difference. As a result, the core 120 is pushed and moved In the direction of arrow M.

When the core 120 moves in the direction of arrow M, the volume of the pressure chamber 116 increases, and the volume of the pressure chamber 118 decreases by that amount. Therefore, the water in the pressure chamber 118 is pushed out by the amount of water flowing into the pressure chamber 116 via the path of arrow A, and is included in the discharge amount of water flowing out of the channel 182.

As the core 120 continues to move in the direction of arrow M from the state shown in FIG. 11A, the slide bar 148 abuts against the inner wall of the housing 102 and is pushed against the core. Then the bend direction of the leaf spring 160 is reversed, and the slide bars 146, 148 are biased toward the left side as shown in FIG. 11B. Then the slide bar 148 pushes the main valve 144, and thereby the main valves 142, 144 are also moved to the left side. That is, the introducing port 132 is opened, and the introducing port 134 is closed. In the state shown in FIG. 11B, the water introduced from the water inlet port 112 into the pressure chamber 116 as shown by arrow A flows through the introducing port 132 into the core inner channel 124 as shown by arrow C and flows out via the water discharge channel 182, as shown by arrow D. On the other hand, because the introducing port 134 is closed, the water introduced from the water inlet port 114 into the pressure chamber 118 as shown by arrow B has no outflow path and the pressure in the pressure chamber 118 becomes higher than the pressure in the pressure chamber 116. As a result, a pressure difference occurs between the pressure chambers 116 and 118, and the core 120 begins to move toward the left side as shown by arrow M.

As shown in FIG. 11C, the core 120 continues to move to the position where the slide bar 146 abuts against the inner wall of the housing 102. From this state, the core 120 moves further, and the slide bar 146 is pushed against the core 120 to reverse the bend direction of the leaf spring 160, which is thus biased to the right side. Then, like the state shown in FIG. 11A, the introducing port 132 is closed, the introducing port 134 is opened, and the core 120 begins to move toward the right side.

As described above, according to the specific example, because the core 120 is provided with the main valves 142, 144 as the valve bodies and with a control mechanism composed of the slide bars 146, 148 and the leaf spring 160, the size relation of the opening degree of the introducing ports 132 and 134 can be appropriately inverted depending on the movement of the core 120. Thus the core 120 is able to reciprocate. The stroke of reciprocation of the core 120 of the specific example can be configured appropriately on the basis of the length of the interior space of the housing 102 and the thickness (width) of the core 120.

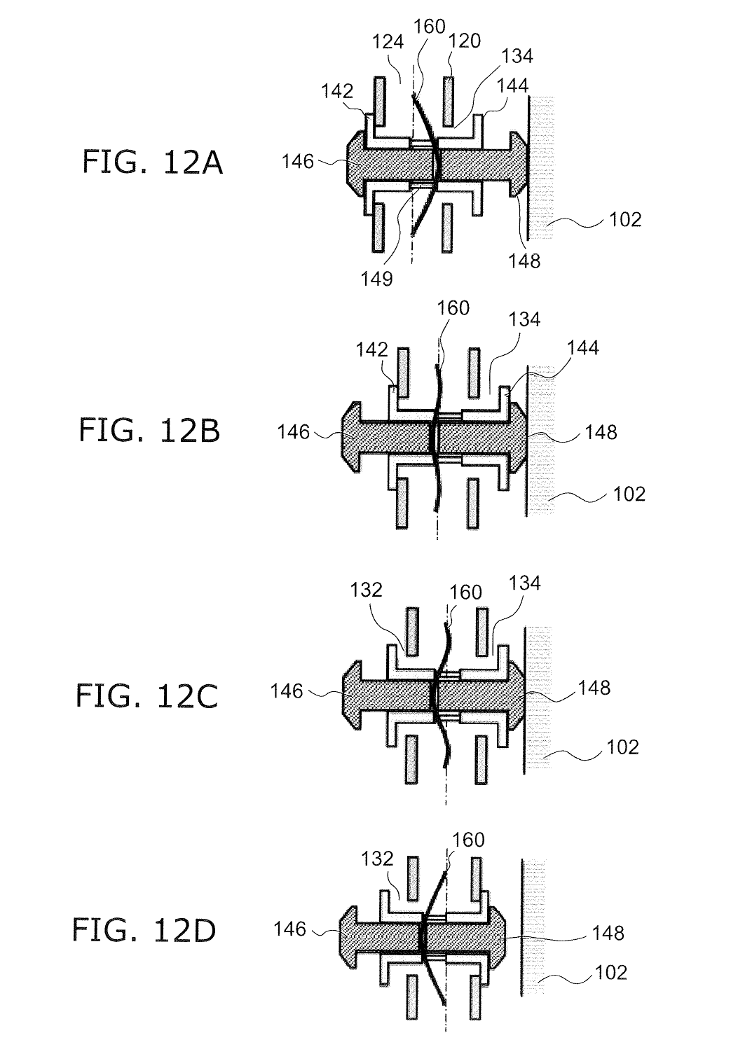

Next, the function of the control mechanism in the specific example is described in more detail. FIG. 12 is a schematic view for describing the operation of the control mechanism in the example. More specifically, FIG. 12A shows the state where the leaf spring 160 is bent to the right side to bias the slide bars 146, 148 in this direction. At this time, the introducing port 132 is closed by the main valve 142, and the introducing port 134 is opened by the main valve 144. In this state, as the core 120 moves to the right side, the slide bar 148 abuts against the inner wall of the housing 102 as shown in this figure A. Because a pressure difference is acting on the core 120, the core 120 moves further to the right with the slide bar 148 abutting against the housing inner wall, and results in the state shown in FIG. 12B. That is, the relative position of the core 120 and the slide bar 148 is varied against the biasing force of the leaf spring 160, and the slide bar 148 is pushed against the core 120. As a result, the leaf spring 160 is also pushed to the left side and deformed to take a generally S-shaped configuration as illustrated in this figure. At this time, the main valves 142, 144 are subjected to the pressure difference like the core 120 and do not change the open/closed state of the introducing ports 132, 134.

Subsequently, the core 120 moves further, and thereby the slide bar 148 is further pushed against the core 120. Then, as shown in FIG. 12C, the leaf spring 160 begins to reverse its bend direction to the left side and biases slide bars 146, 148 to the left side.

Then, as shown in FIG. 12D, the main valves 142, 144 are moved to the left side by the biasing force of the leaf spring 160. Thus, the introducing port 132 is fully opened, and the introducing port 134 is fully closed.

As described above, in the specific example, the bend direction of the compressed leaf spring 160 is appropriately reversed by the slide bars 146, 148, and its biasing force is used to operate the main valves 142, 144, thereby alternatively controlling the introducing ports 132, 134 to be in one of the fully open state and the fully closed state. That is, the biasing force of the leaf spring 160 is used to reliably produce the opening degree difference between both of the introducing ports 132, 134 for reversing the core 120.

The control mechanism of the specific example for the controlling main valves 142, 144 via the slide bars 146, 148 plays a very important role in the smooth action of the driving unit of the example. More specifically, the compressed leaf spring 160, which is stable in the state bent to the right side or the left side, may fall into a metastable and neutral state about halfway between these stable states as shown in FIG. 12B. That is, in this state, a sufficient biasing force to the left or right does not occur in the leaf spring 160. Therefore, in this state, if the introducing ports 132, 134 happen to have nearly the same opening degree, the water flows in through the introducing ports 132, 134 on both sides of the core. Thus the pressure difference vanishes, and the core 120 stops moving. That is, if the timing at which the main valves 142, 144 begin to move is earlier than the timing of the reversal of the leaf spring 160, the core 120 may stop moving.

In contrast, according to the specific example, the slide bars 146, 148 are provided, and their stroke is appropriately adjusted. Thus, in the metastable and neutral state as shown in FIG. 12B, a state can be maintained where the main valves 142, 144 do not yet move while the core 120 continues to move under pressure. The main valves 142, 144 are allowed to begin to move only when the leaf spring 160 traverses this neutral state and begins to be reversed. That is, the timing at which the main valves 142, 144 begin to move can be synchronized with the timing of the reversal of the leaf spring 160.

In other words, before the opening degree difference enough to move the core 120 is lost, the leaf spring 160 is reversed, and the main valves 142, 144 are moved by the reversing force (biasing force) via the slide bars 146, 148. Thus the opening degree difference between the introducing ports 132, 134 can be inverted to the opening degree difference enough to move the core 120 in the opposite direction.

This eliminates the problem that the introducing ports 132, 134 may have nearly the same opening degree resulting in stopping the core 120 when the leaf spring 160 is in the neutral state. Thus a smooth repetitive motion can be achieved.

Furthermore, in this configuration, even when shower water sprinkle is started from the state where the core 120 is stopped about halfway through its moving stroke, the main valves 142, 144 can be controlled by the leaf spring 160 at the beginning of shower water sprinkle to be in the state where one of the introducing ports 132, 134 is alternatively opened. Thus a pressure difference is produced between both sides of the core 120, and a stable initial action can be started. That is, the state where the opening degree of the introducing port 134 is larger than the opening degree of the introducing port 132, or the state where the opening degree of the introducing port 132 is larger than the opening degree of the introducing port 134, can be retained alternatively.

As described above, in the specific example, the moving direction of the core 120, the movable direction of the main valves 142, 144, the movable direction of the slide bars 146, 148, and the biasing direction of the leaf spring 160 can be made generally the same to avoid waste in the action of force and to effectively use the moving force of the core having a large pressure-receiving area. Thus a smooth and stable action is achieved. That is, the moving action and the opening degree control action of the core 120 are interlocked, and thereby the control action to invert the size relation of the opening degree of the introducing ports 132, 134 for the reversal of the core 120 is made reliable and easy. Thus the valve bodies and the control mechanism are made simple and compact.

In the specific example shown in FIGS. 6 to 12, while the slide bars 146, 148 abut against the inner wall of the housing 102 when the core 120 is reversed, the invention is not limited thereto. For example, the slide bars 146, 148 can be provided with a magnet, the inner wall of the housing 102 can also be provided with a magnet, and the repulsive force acting therebetween can be used to stop the slide bars 146, 148 relative to the housing 102. That is, in this case, in the state corresponding to FIGS. 12A to 12C, the slide bars 146, 148 do not abut against the inner wall of the housing 102, but is located at a prescribed distance apart from the inner wall of the housing 102 by the repulsive force of the magnets (not shown). Thus, the core 120 can be reversed in a noncontact manner.

Furthermore, the thrust obtained in the reciprocating linear action of the driving unit 100 of this embodiment is determined by the product of the pressure of water loaded on the core 120 and the pressure-receiving area of the core. Therefore, as the pressure-receiving area of the core 120 is increased, a correspondingly larger thrust can be obtained.

While FIGS. 7 to 9 show a specific example where the circular core 120 is contained in a generally cylindrical space provided in the housing, the invention is not limited thereto. For example, the interior space of the housing 102 may be shaped as a rectangular cylinder or a flattened cylinder, and the core 120 may have any of various shapes correspondingly.

The outer peripheral shape of the water discharge tubular body 180 does not need to be circular, but may be in a polygonal or flattened shape. Furthermore, the water discharge tubular body 180 does not need to be placed at the center of the core 120, but may be decentered from the center of the core 120. This facilitates downsizing the core 120, and the driving unit 100 can be downsized. In the core 120, a distance from the water discharge tubular body 180 to the periphery of the core 120 increases, thereby a space for providing the control mechanism can be acquired. A protrusion position of the water discharge tubular body 180 in the core 120 can be optionally selected, hence degree of freedom in housing design of the shower apparatus increases and the whole shower apparatus can be downsized.

In the case where the inner space of the housing 102 is shaped like a cylinder and the water discharge tubular body 180 is placed at the center of the cylindrical core 120 as in the specific example, the force acting on the core 120 is uniform with respect to the water discharge tubular body 180, and no extra force is applied to the water discharge tubular body 180. Thus, such problems as tilt and wear are less likely to occur.

As described above, the core 120 can be moved simply by providing an opening degree difference between the introducing ports 132 and 134 to produce a pressure difference required for the movement. Likewise, the moving direction of the core 120 can be reversed simply by inverting the size relation of the opening degree of the introducing ports 132, 134 using the control mechanism. For example, the ratio of opening degree between the introducing ports 132, 134 can be changed from 70:30 to 30:70 by the control mechanism to achieve the reversal action. Furthermore, when the opening degree is changed from 100:0 to 0:100 by the control mechanism, the most reliable and stable reversal action is achieved.

The specific example has described the case where a biased force is not applied to the core 120, however threshold values of the opening degree in reversed control are different, for example, in the case where only one of the water discharge tubular body 180 protrudes or the core 120 moves up and down (vertically). More specifically, in the former case, the product force of an area of the water discharge tubular body 180 and a pressure in the pressure chamber always acts on the core in a protrusion direction of the water discharge tubular body 180. In the latter case, a self-weight of the core always acts on the core in a vertically downward direction. Existence of this force causes the threshold value of the opening degree of the introducing ports 132, 134 for reverse of the core 120 to shift from 50:50. In this case, if the threshold value is illustratively 40:60, the reverse comes to be possible by control from 30:70 to 50:50. That is, the control mechanism controls the opening degree of the introducing ports so that the core 120 exceeds the threshold value enough for the reverse of its moving direction. As described above, the change of the opening degree allows the reverse control, but it is most preferable to invert the size relation of the opening degree.

According to the driving unit 100 of the embodiment, the core contained in the housing 102 is provided with the valve bodies 142, 144 and the control mechanism. The core 120 can be reciprocated by supplying water into the pressure chambers on both sides thereof. Here, the moving direction of the core 120 is made generally the same as the movable direction of the valve bodies 142, 144 to interlock the moving action and the opening degree control action of the core 120. Thus, the reversal action of the valve bodies to invert the size relation of the opening degree of the introducing ports 132, 134 for the reversal of the core 120 is made reliable and easy, and the valve bodies and the control mechanism are made simple and compact.

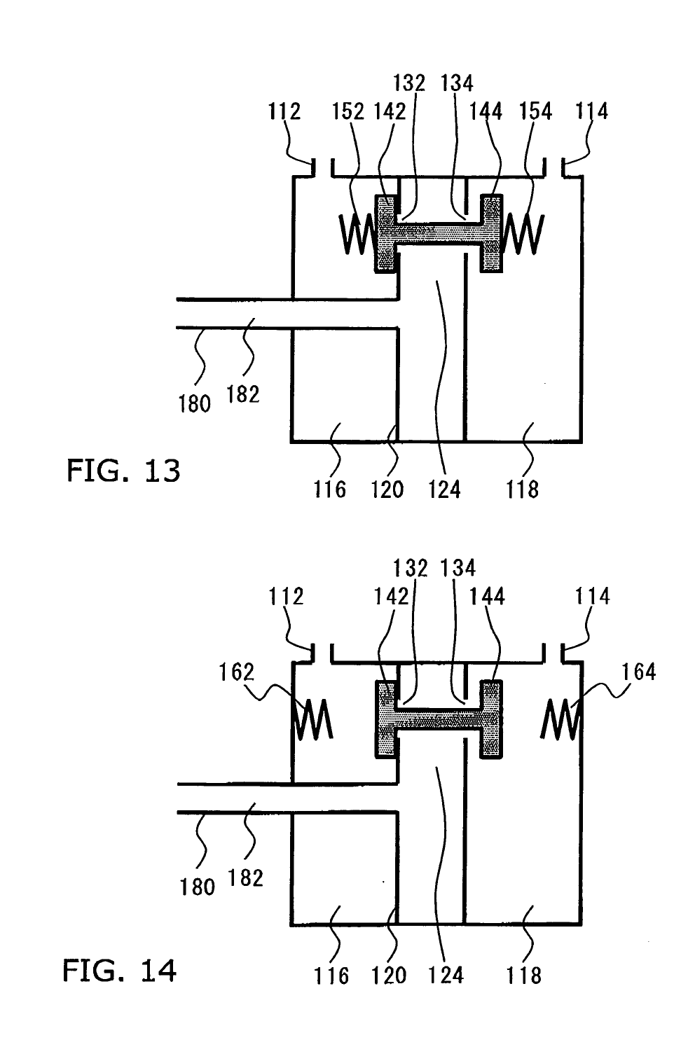

Here, another example serving as a control mechanism is described. FIGS. 13 and 14 are schematic views of a driving unit including a control mechanism based on two springs.

Referring to FIG. 13, two compression springs 152, 154 are provided on the pressure chamber 116, 118 side of the valve bodies 142, 144. The compression axis of the compression spring 152, 154 agrees with the movable axis of the valve body 142, 144. The end portion of the compression spring 152, 154 on the pressure chamber side, at least at its free length, protrudes more toward the pressure chamber 116, 118 side than the end portion of the valve body 142, 144. Here, the two compression springs 152, 154 serve as a control mechanism.

The function of the compression springs 152, 154 is now described. When the core 120 moves rightward in the housing 102, the compression spring 154 provided on the valve body 144 is brought into contact with the wall surface of the pressure chamber 118. From this state, the core 120 further moves to the right and compresses the compression spring 154 to the position where the fluid force (the force resulting from the pressure difference between the two pressure chambers) acting on the valve bodies 142, 144 is balanced with the spring force. Then, the moment the spring force overcomes the aforementioned fluid force, the compression spring 154 starts to expand toward its free length, and the valve bodies 142, 144 move to the left side relative to the core 120. Consequently, the opening degree of the introducing ports 132, 134 is varied and exceeds the threshold. Thus, the moving direction of the core 120 can be reversed. This function also applies to the compression spring 152. Consequently, the core 120 can be reciprocated.

Because the compression springs 152, 154 are independently provided on the valve bodies 142, 144, the design can be adapted to each reversal state. More specifically, parameters of the compression springs, such as spring constant and natural length, can be independently designed so that the opening degree exceeds the threshold corresponding to each reversal from rightward to leftward and from leftward to rightward. This increases the design freedom, and also increases operational reliability due to dedicated design.

Furthermore, the structure including only the compression springs 152, 154 provided on the valve bodies 142, 144 serves for reduction in the number of components, ease of assembly, and low cost. Furthermore, the simple structure leads to high reliability.

The connection between the valve body and the compression spring can be implemented by such methods as using an adhesive, embedding the compression spring while thermally melting the valve body, screwing the compression spring using its end turn, and swaging the compression spring with the valve body using its end turn.

Referring next to FIG. 14, in this case, two compression springs 162, 164 are provided on the wall surface (housing 102 wall surface) of the pressure chamber 116, 118. The compression springs 162, 164 are positioned so as to act on the valve bodies 142, 144 at the moving end of the core. The compression axis is parallel to the moving direction of the valve bodies. The end portion of the compression springs 162, 164 on the pressure chamber side, at least at its free length, protrudes more toward the pressure chamber 116, 118 side than the end surface of the housing. Here, the two compression springs 162, 164 serve as a control mechanism.

The two compression springs 162, 164 thus provided have a function similar to that of the two compression springs 152, 154 described above with reference to FIG. 13, and can reciprocate the core 120.

The compression springs 162, 164 are provided on the wall surface of the housing 102, and hence are superior in assemblability. If the housing 102 is configured so that a portion of the wall surface of the housing 102 can be detached from outside the housing 102, and the compression springs 162, 164 are attached to the wall surface portion, then only the compression springs 162, 164 can be taken out without removing the core 120, increasing ease of maintenance. Furthermore, in a configuration where the amount of protrusion of the springs 162, 164 into the pressure chamber can be varied by external manipulation, the reciprocation stroke of the core 120 can be varied.

The control mechanism described with reference to FIGS. 13 and 14 can be based on elastic bodies in general. For instance, rubber can be used. However, for reasons of linearity and durability, springs are superior to rubber. Furthermore, although compression springs are illustratively described here, a leaf spring and a torsion spring can also be used as a spring member operable to store the compression force as a repulsive force.

Furthermore, the valve body 142 and the valve body 144 can include a holding mechanism (latch mechanism) so as to alternatively maintain the open/closed state of the introducing port 132 and the introducing port 134. For instance, the holding mechanism can be the structure of a leaf spring provided between the valve body and the core as described above. In this configuration, the driving unit can reliably start to move.

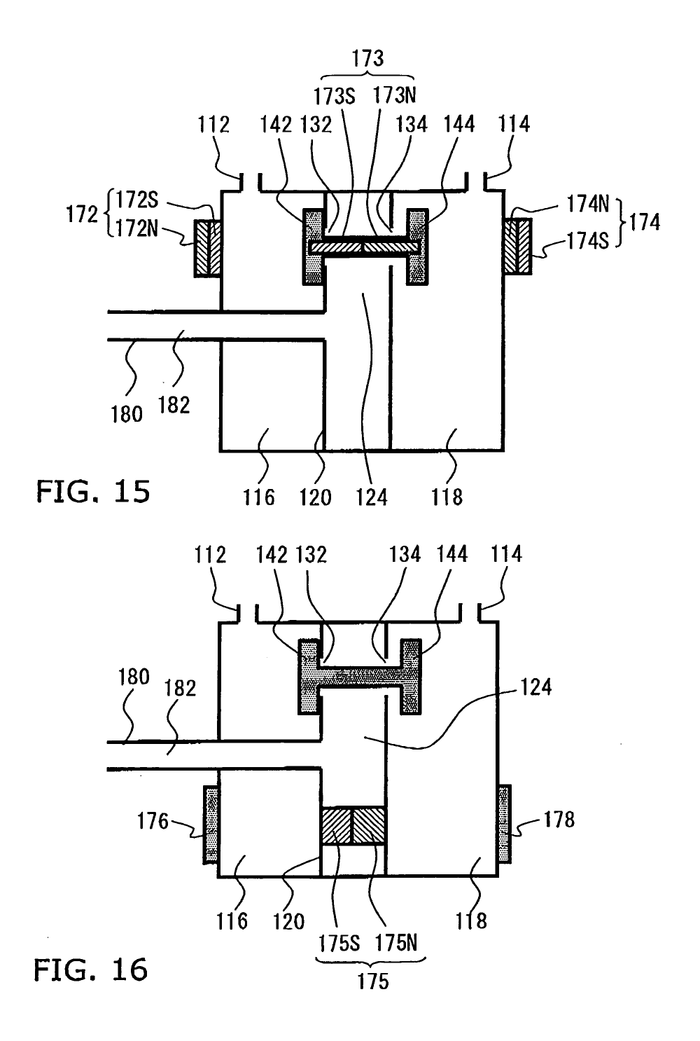

Next, another example serving as a control mechanism is described. FIGS. 15 and 16 are schematic views of a driving unit including a control mechanism based on magnets.

Referring to FIG. 15, the valve bodies 142, 144 include a magnet 173 (S-pole 173S, N-pole 173N). The S-pole 173S is placed on the valve body 142 side, and the N-pole 173N is placed on the valve body 144 side. A magnet 172 (S-pole 172S, N-pole 172N) is provided on the wall surface (housing 102 wall surface) of the pressure chamber 116 with the S-pole 172S oriented to the inside of the driving unit. A magnet 174 (S-pole 174S, N-pole 174N) is provided on the wall surface (housing 102 wall surface) of the pressure chamber 118 with the N-pole 174N oriented to the inside of the driving unit. The magnets 172, 174 are positioned so that the magnetic force of the magnets 172, 174 acts on the magnet 173 at the moving end of the core 120. That is, like poles are opposed to each other between the magnet in the valve bodies and the magnet provided on the housing. Here, the three magnets 172, 173, 174 serve as a control mechanism.

The function of the magnets 172, 173, 174 is now described. When the core 120 moves rightward in the housing 102 to the neighborhood of its right end, a repulsive force starts to occur between the magnet 173 and the magnet 174. From this state, the core 120 further moves to the right to the position where the fluid force acting on the valve bodies 142, 144 is balanced with the magnetic force. Then, the moment the magnetic force overcomes the aforementioned fluid force, the repulsive force by the magnets causes the valve bodies 142, 144 to move to the left side relative to the core 120. Consequently, the opening degree of the introducing ports 132, 134 is varied and exceeds the threshold. Thus, the moving direction of the core 120 can be reversed. This function also applies to the magnet 173 and the magnet 172. Consequently, the core 120 can be reciprocated.

Because the magnets 172, 173, 174 are independently provided on the valve bodies 142, 144, the design can be adapted to each reversal state. More specifically, parameters of the magnets, such as the material, shape, and volume, can be independently designed so that the opening degree exceeds the threshold corresponding to each reversal from rightward to leftward and from leftward to rightward. This increases the design freedom, and also increases operational reliability due to dedicated design.

Furthermore, the structure including only the magnets 172, 173, 174 provided on the valve bodies 142, 144 and the housing 102 serves for reduction in the number of components, ease of assembly, and low cost. Furthermore, the valve body and the housing are noncontact, avoiding such problems as wear and breakage. Furthermore, in a configuration where the magnetic force of the magnets 172, 174 can be varied by external manipulation, the reciprocation stroke of the core 120 can be varied.

Referring next to FIG. 16, the core 120 includes a magnet 175 (S-pole 175S, N-pole 175N). A ferromagnet 176 is provided on the wall surface (housing 102 wall surface) of the pressure chamber 116, and a ferromagnet 178 is provided on the wall surface (housing 102 wall surface) of the pressure chamber 118. The ferromagnets 176, 178 are positioned so that a magnetic force acts between the magnet 175 and the ferromagnets 176, 178 at the moving end of the core 120. Here, the magnet 175 and the ferromagnets 176, 178 serve as a control mechanism.

The function of the magnet 175 and the ferromagnets 176, 178 is now described. When the core 120 moves rightward in the housing 102, the valve body 144 is brought into contact with the wall surface of the pressure chamber 118. From this state, the core 120 moves to the right until the opening degree of the introducing ports 132, 134 reaches the threshold. At this time, the core further moves to the right by the magnetic force (attractive force) acting between the magnet 175 and the ferromagnet 178. Consequently, the valve bodies 142, 144 exceed the threshold of the introducing ports. Thus, the pressure difference between the pressure chambers 116, 118 is inverted, and the moving direction of the core 120 is reversed. This function also applies to the magnet 175 and the ferromagnet 176. Consequently, the core 120 can be reciprocated.

Also in the example based on magnets as described above, the valve body 142 and the valve body 144 can include a holding mechanism (latch mechanism) so as to alternatively maintain the open/closed state of the introducing port 132 and the introducing port 134. For instance, the holding mechanism can be the structure of a leaf spring provided between the valve body and the core as described above. In this configuration, the driving unit can reliably start to move.

In the foregoing, the control mechanism has been illustratively described with reference to a control mechanism based on two springs and a control mechanism based on magnets.

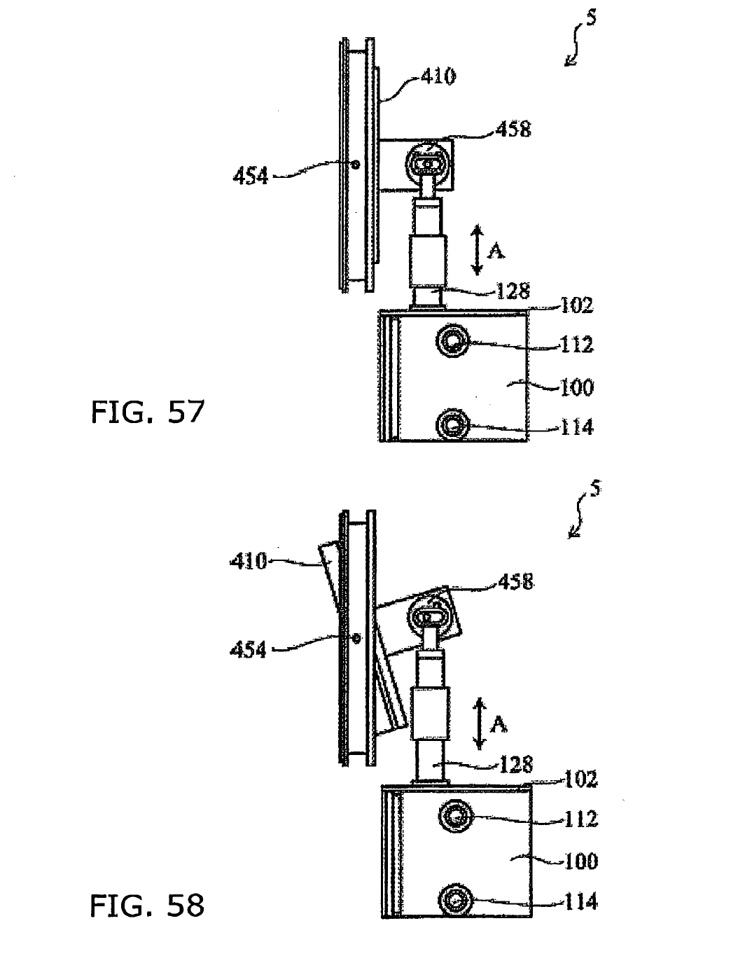

As described later in detail, the water discharge channel 182 inside the water discharge tubular body 180 of the embodiment plays a role as a water guide channel introducing the water flowed in from the core 120 into a shower unit. Moreover, for example, as described later with respect to FIGS. 57 to 59, a reciprocating linear motion of the core 120 can achieve a swinging motion of a shower unit 410 via a mechanism 458 (power transmission unit) converting the linear motion to a rotary motion.

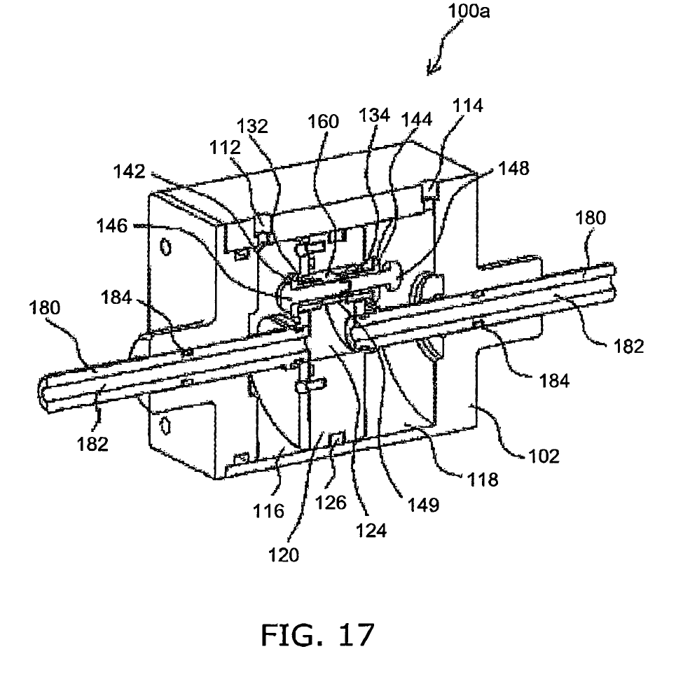

FIG. 17 is a schematic cross-sectional view showing a variation of the driving unit 100. With regard to this figure, elements similar to those described above with reference to FIGS. 6 to 9 are marked with the same reference numerals and not described in detail. A driving unit 100a of this variation is provided with the water discharge tubular body 180 on both sides of the core 120. That is, the water discharge tubular body 180 protrudes from both sides of the housing 102 and is particularly useful when sprinkling water from both sides is desired. In such a case, the water discharge channel 182 inside the water discharge tubular body 180 of the embodiment plays a role as a water guide channel introducing the water flowed in from the core 120 into the shower unit. In this way, when the water discharge tubular body 180 is protruded on both sides, forces acting on the core 120 are the same in a longitudinal direction, thus the design of the driving unit (design on the operation speed, design on the reverse) is performed easily. In particular, when the pressure loss of the shower unit provided on a tip of the water discharge tubular body 180 is large, pressure in the pressure chamber becomes high, hence the configuration of protrusion on both sides is effective on consideration of the force balance acting on the core 120. Here, the water discharge tubular body 180 having the water discharge channel 182 formed can be only on one side.

In the first embodiment of the driving unit described above, the unit in which the core reciprocates linearly was described. Next, a second embodiment of the driving unit in which the core oscillates reciprocatorily will be described.

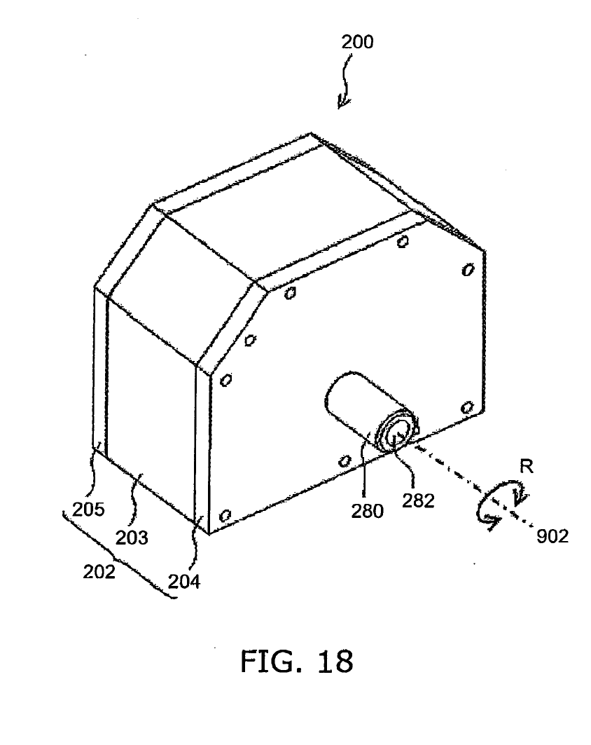

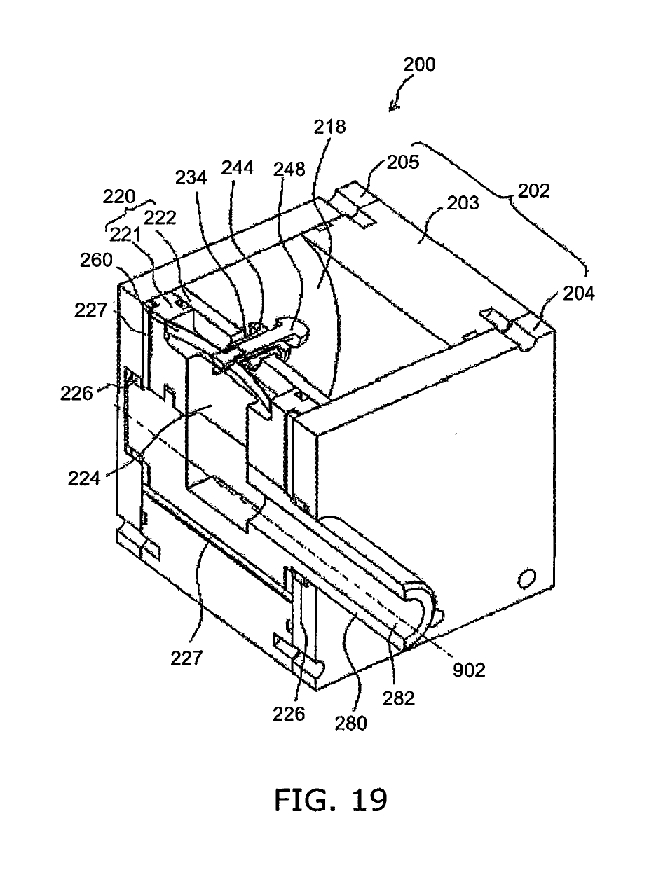

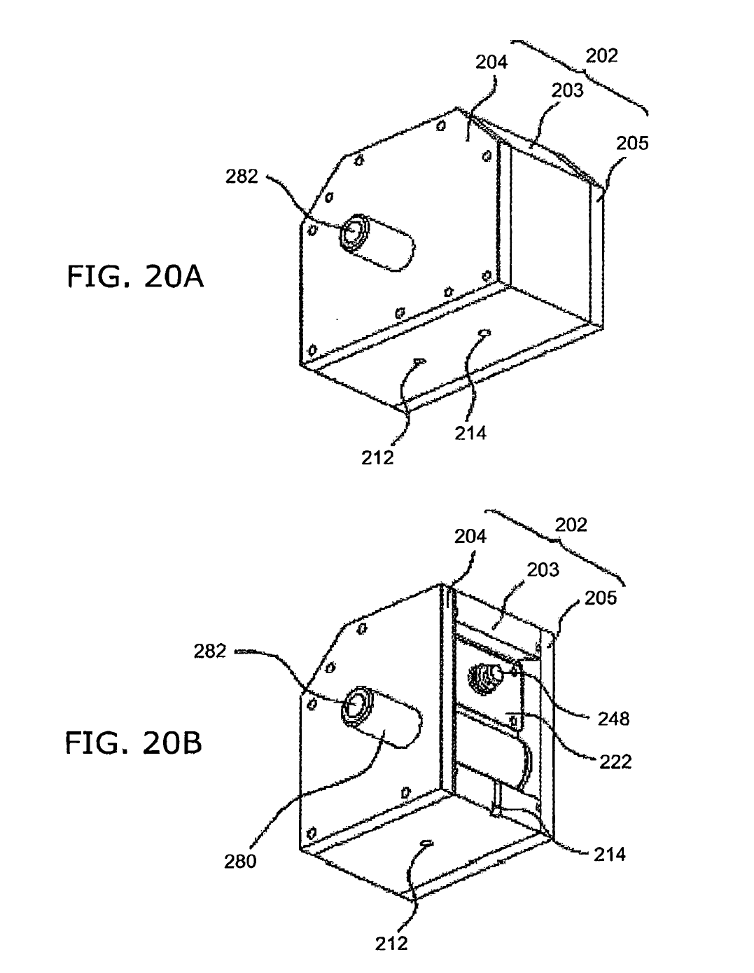

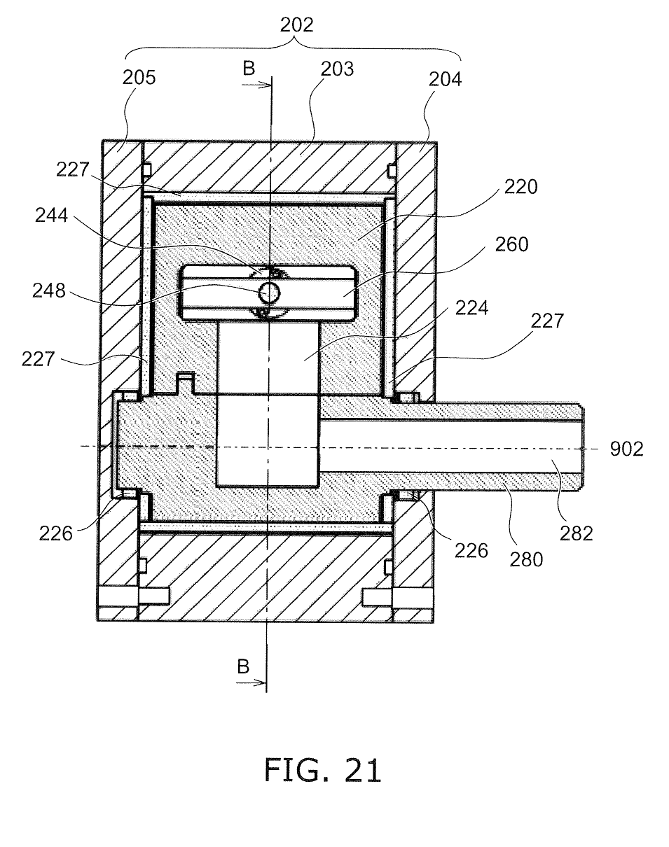

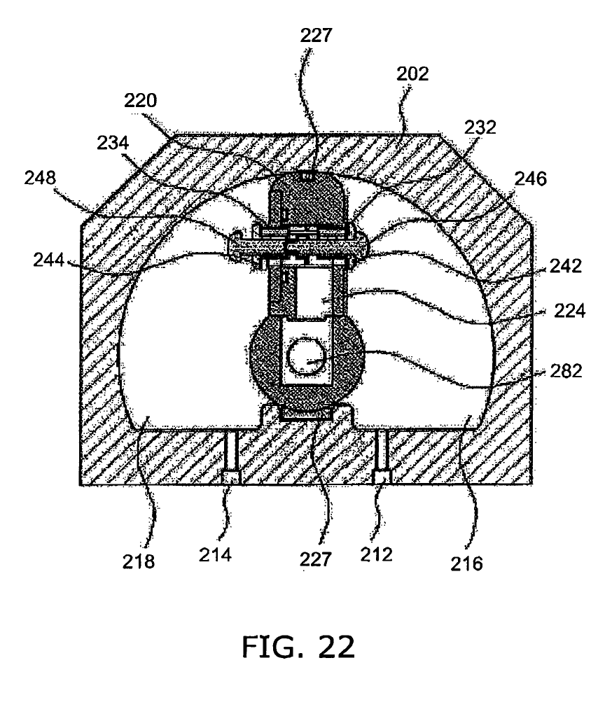

FIGS. 18 to 22 are schematic views showing the relevant part of a driving unit 200 of this embodiment. More specifically, FIG. 18 is a perspective view of the driving unit 200 of the example, FIG. 19 is a perspective cutaway view thereof, FIG. 20 shows a perspective view and a cutaway view as viewed from the bottom side, FIG. 21 is a vertical cross-sectional view, and FIG. 22 is a cross-sectional view along line B-B in FIG. 21.

The driving unit 200 of this embodiment has a water discharge tubular body 280 that illustratively protrudes on one side from a housing 202 formed from a housing main body 203 and housing lids 204, 205. The water discharge tubular body 280 has a hollow structure having a water discharge channel 282 inside and opened at the tip. When water is introduced into water inlet ports 212, 214 provided in the housing 202, the water discharge tubular body 280 oscillates reciprocatorily in the direction of arrow R.

The internal structure is described. As shown in FIGS. 19 to 22, a core 220 composed of a core main body 221 and a core lid 222 is contained in a fan-shaped housing space formed from the housing main body 203 and the housing lids 204, 205, where the core is able to oscillate about a core oscillating axis 902. The core 220 is coupled to the water discharge tubular body 280 penetrating in the housing lid 204, and oscillates, dividing the interior of the fan-shaped housing into a first pressure chamber 216 and a second pressure chamber 218. Water is introduced from the water inlet ports 212, 214 into the pressure chambers 216, 218, respectively. The sliding portion between the core 220 and the inner wall of the housing 202 is provided with a seal 227 for facilitating sliding while maintaining liquid tightness. The sliding portion between the water discharge tubular body 280 and the housing 202 is also provided with a seal 226 for the same purpose. The seals 227, 226 are for facilitating sliding while maintaining the liquid tightness and can again be made of such materials as Teflon®, NBR (nitrile rubber), EPDM (ethylene-propylene rubber), and POM (polyacetal). “Liquid tightness” used herein can be satisfied by ensuring the condition sufficient for producing a pressure difference between the right and left pressure chamber.

Next, the structure of the core 220 is described. In this embodiment again, the core 220 has a valve body and a control mechanism similar to the driving unit 100 described above. A core inner channel 224 is formed in the core 220. The core inner channel 224 communicates with the water discharge channel 282 provided in the water discharge tubular body 280. The core 220 has introducing ports (drain hole) 232, 234 allowing the core inner channel 224 to communicate with the pressure chambers 216, 218. Main valves 242, 244, slide bars 246, 248 are provided so as to traverse the core inner channel 224. The shape of the main valve and the slide bar is as described above with reference to FIG. 10. The operation of the valve body and the control mechanism composed of these elements is also similar to that described above with reference to the driving unit 100.

That is, a leaf spring 260 is supported at both ends by the core 220. The slide bars 246, 248 move relatively to the core 220 via the leaf spring 260. The action of the main valves 242, 244 to vary an opening degree of the introducing ports 232, 234 is determined by the coaxially provided slide bars 246, 248. The slide bars 246, 248 are subjected to a biasing force depending on the bend direction of the leaf spring 260. As a result, the main valves 242, 244 are subjected to the biasing force from the slide bars 246, 248 to place the introducing ports 232, 234 in one of the state of the fully open state and the fully closed state alternatively.

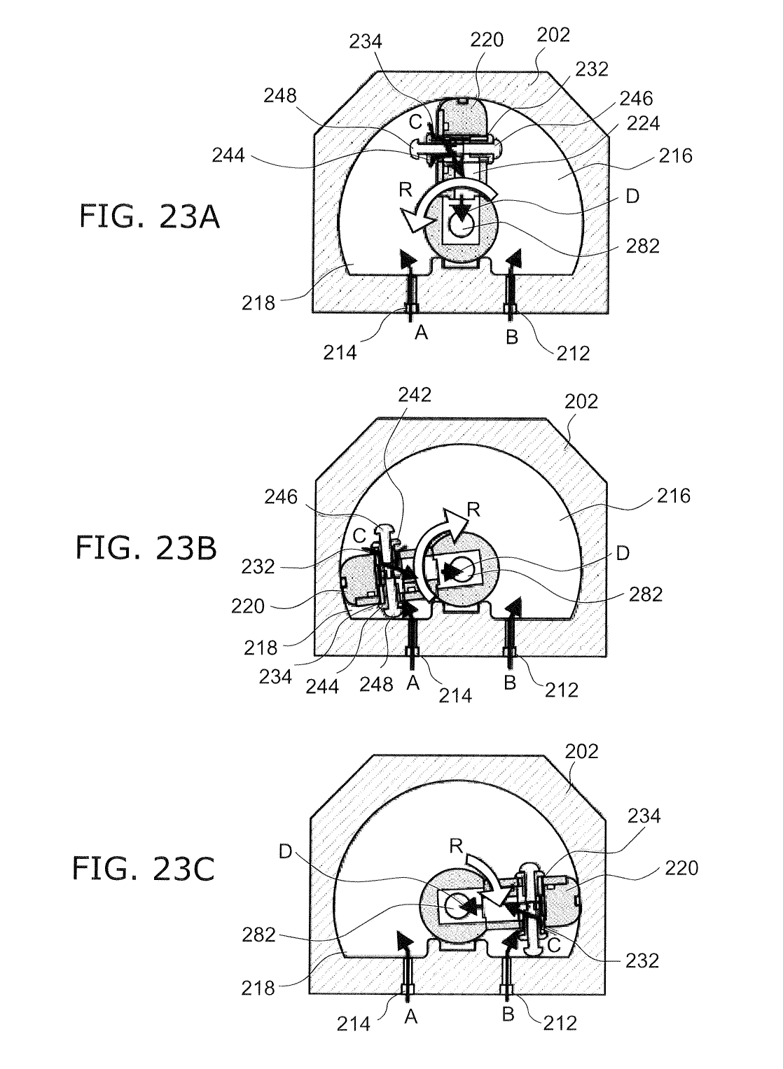

In the following, the action of driving unit 200 is described. FIGS. 23A to 23C are schematic views for describing the action of the driving unit 200.

First, FIG. 23A shows a state where the slide bars 246, 248 are biased toward the left side under the action of the leaf spring 260. At this time, because the main valves 242, 244 are also biased toward the left side by the slide bar 246, a state occurs where the introducing port 232 is closed and the introducing port 234 is opened.

In this state, when water is supplied to the water inlet ports 212, 214 at nearly the same pressure, the water introduced from the water inlet port 214 into the pressure chamber 218 as shown by arrow A flows from the introducing port 234 into the core inner channel 224 as shown by arrow C and flows out as shown by arrow D via the water discharge channel 282. On the other hand, because the introducing port 232 is closed, the water introduced from the water inlet port 212 into the pressure chamber 216 as shown by arrow B has no outflow path and the pressure in the pressure chamber 216 becomes higher than the pressure in the pressure chamber 218. That is, by providing an opening degree difference between the introducing ports 232, 234, a difference in the channel resistance occurs, which causes a pressure difference. As a result, the core 220 is pushed and oscillates in the direction of arrow R.

When the core 220 oscillates in the direction of arrow R, the volume of the pressure chamber 216 increases, and the volume of the pressure chamber 218 decreases by that amount. Therefore, the water in the pressure chamber 218 is pushed out by the amount of water flowing into the pressure chamber 216 via the path of arrow B, and is included in the discharge amount of water flowing out of the channel 282.

The core 220 further continues to oscillate and the slide bar 248 abuts against the inner wall of the housing 202 and is pushed against the core 220. Then the bend direction of the leaf spring 260 is reversed, and the slide bars 246, 248 are biased toward the opposite side as shown in FIG. 23B. Then the slide bar 248 pushes the main valve 244, and thereby the main valves 242, 244 are also moved to the right side (in the clockwise direction in FIG. 19). That is, the introducing port 232 is opened, and the introducing port 234 is closed. In the state shown in FIG. 23B, the water introduced from the water inlet port 212 into the pressure chamber 216 as shown by arrow B flows through the introducing port 232 into the core inner channel 224 as shown by arrow C and flows out via the water discharge channel 282 as shown by arrow D. On the other hand, because the introducing port 234 is closed, the water introduced from the water inlet port 214 into the pressure chamber 218 as shown by arrow A has no outflow path and the pressure in the pressure chamber 218 becomes higher than the pressure in the pressure chamber 216. As a result, a pressure difference occurs between the pressure chambers 216 and 218, and the core 220 begins to oscillate toward the right side as shown by arrow R.

As shown in FIG. 23C, the core 220 further oscillates to the position where the slide bar 246 abuts against the inner wall of the housing 202. From this state, the core 220 moves further, and the slide bar 246 is pushed against the core 220 to reverse the bend direction of the leaf spring 260, which is thus biased to the opposite side. Then, like the state shown in FIG. 23A, the introducing port 232 is closed, the introducing port 234 is opened, and the core 220 begins to oscillate toward the left side.

As described above, in driving unit 200 again, the core 220 is provided with the valve bodies composed of the main valves 242, 244, and the control mechanism composed of the leaf spring 260 and the slide bars 246, 248. Thus the size relation of the opening degree of the introducing ports can be appropriately inverted depending on the movement of the core 220 to move the core 220 right and left repetitively. In addition, in the driving unit 200 again, as described above with reference to FIG. 12, the timing at which the main valves 242, 244 begin reversal action can be synchronized with the timing of the reversal of the leaf spring 260. This eliminates the problem that the main valves 242, 244 may have nearly the same opening degree resulting in stopping the core 220 when the leaf spring 260 is in the neutral state. Thus a smooth repetitive motion can be achieved.

In other words, before the opening degree difference enough to move the core 220 is lost, the leaf spring 260 is reversed, and the main valves 242, 244 are moved by the reversing force (biasing force) via the slide bars 246, 248. Thus the opening degree difference between the introducing ports 232, 234 can be reversed to the opening degree difference enough to move the core 220 in the opposite direction.

In the driving unit 200 again, the oscillating direction of the core 220, the movable direction of the main valves 242, 244, the movable direction of the slide bars 246, 248, and the biasing direction of the leaf spring 260 can be made generally the same to avoid waste in the action of force and to effectively use the moving force of the core having a large pressure-receiving area. Thus a smooth and stable action is achieved. That is, when the core 220 approaches the inner wall of the housing 202, the moving direction of the core 220 is made generally the same as the movable direction of the main valves 242, 244, the biasing direction of the leaf spring 260, and the movable direction of the slide bars 246, 248. Thus the oscillating action and the opening degree control action of the core 220 are interlocked, and the action of inverting the size relation of the opening degree of the introducing ports 232, 234 for the reversal of the core 220 is made reliable and easy. Thus the valve bodies and the control mechanism are made simple and compact.

Furthermore, in this configuration, even when shower water sprinkle is started from the state where the core 220 is stopped about halfway through its oscillating stroke, the main valves 242, 244 can be controlled by the leaf spring 260 at the beginning of the shower water sprinkle to be in the state where one of the introducing ports 232, 234 is opened alternatively. Thus a pressure difference is produced between both sides of the core 220, and a stable initial action can be started. That is, the state where the opening degree of the introducing port 234 is larger than the opening degree of the introducing port 232, or the state where the opening degree of the introducing port 232 is larger than the opening degree of the introducing port 234, can be retained alternatively.

Here, the control mechanism can be any of those described above with reference to FIGS. 13 to 16.

The stroke (oscillating angle) of the oscillating motion of the core 220 in the driving unit 200 can be appropriately configured by the opening angle of the fan-shaped space of the housing 202.

Furthermore, the thrust obtained by the oscillating action in the driving unit 200 is determined by the product of the pressure of water applied to the core 220 and the pressure-receiving area of the core. Therefore, as the pressure-receiving area of the core 220 is increased, a correspondingly larger thrust can be obtained.

In this embodiment again, the water discharge channel 282 inside the water discharge tubular body 280 plays a role as a water guide channel introducing water flowed in from the core 120 into the shower unit. Furthermore, as described later with respect to FIGS. 32 to 34, the swinging motion of the shower unit 410 is achieved by transmitting the reciprocating oscillatory motion of the core 220 to the shower unit 410 via a power transmission unit.

Application of the driving unit 100 and the driving unit 200 described above allows the shower apparatus of this invention to be capable of smooth reciprocating linear motion and reciprocating oscillatory motion of the core only by the supplied pressure of water without the necessity of electrical or mechanical motive energy. Furthermore, the shower apparatus without waste of water is realized by sprinkle the water in swinging state of the shower unit.

Furthermore, in the shower apparatus of the invention, the valve bodies and the control mechanism allowing reciprocating motion accompany the core inside the driving unit. Therefore, the need for an external four-way valve, for example, is eliminated, and smooth reciprocating reverse motion can be achieved by a simple configuration. This facilitates downsizing of a whole apparatus, and the beauty and the layout of bathroom space are advantageous.

It is configured that the shower unit is coupled to the water discharge tubular body reciprocating and water is discharged from the interior of the water discharge tubular body. Therefore, advantageously, the flow channel is simplified, the pressure loss can be reduced, and a sufficient amount and pressure of water discharge can be ensured.

Furthermore, because of the structure of incorporating the valve bodies and the control mechanism in the housing, smooth action resistant to external disturbances can be achieved while an assembly process can be simplified. As a result, highly reliable and stable operation of the shower water sprinkle can be achieved.

Moreover, water supply to the driving unit can be implemented simply by coupling the lines branched from a common water tubular channel to two water inlet ports, achieving good workability. In addition, with respect to water inlet ports, water inlet ports corresponding to left and right pressure chambers may be simply formed, respectively. For example, divided channels are formed in the housing, coupled to each water inlet port, and water inlet coupling port to the housing is unified to be one, thereby, piping can be also further simplified.

Next, a method to stop the swinging motion of the shower unit for improving convenience during taking a shower is described. Here, a specific example where the motion of the core is stopped while discharging the hot water from the shower unit is described.

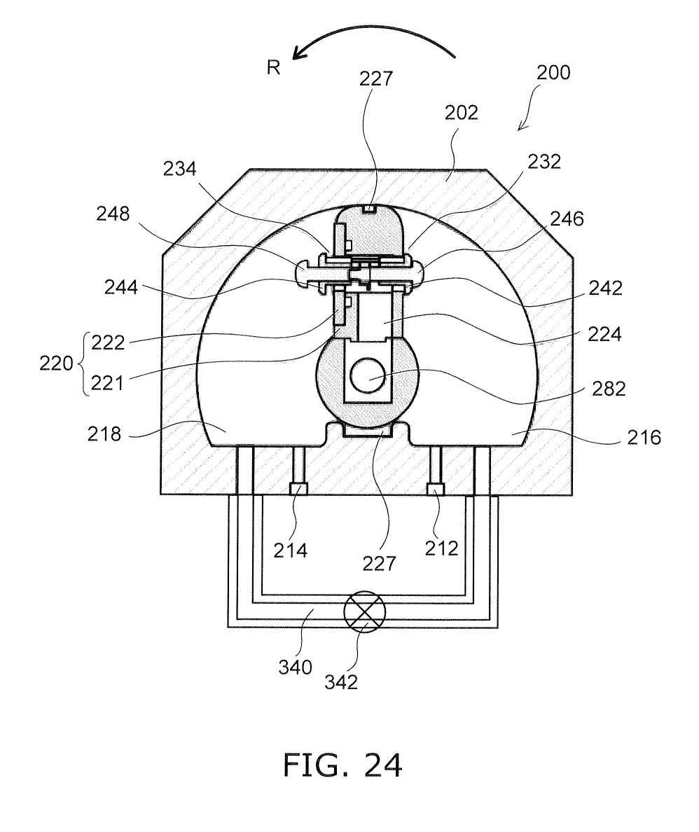

FIG. 24 is a cross-sectional view showing the driving unit 200 according to the specific example.

In the case of the specific example, a bypass channel 340 is provided communicating the pressure chamber 216, 218 formed from side to side of the core 220. Moreover, an opening/closing valve 342 is provided in the bypass channel 340. Operation of the opening/closing valve 342 makes it possible to stop the core 220 and control the speed.

That is, when the right and left pressure chambers 216, 218 are communicated to the bypass channel 340 by the opening/closing valve 342, water is bypassed from the pressure chamber of which the volume should have increased to the pressure chamber of which the volume should have decreased. For example, as shown by arrow R in FIG. 24, when the opening/closing valve 342 is opened during movement of the core 220 to left side, the water supplied from the water inlet port 212 to the pressure chamber 216 is bypassed to the pressure chamber 218 via the bypass channel 340. As a result, enough pressure difference from side to side of the core 220 does not occur and oscillating action of the core 220 stops. At this time, the introducing port 234 is kept to be opened, thus water discharge continues and the flow amount of water discharge does not almost change. More specifically, while maintaining water discharge, the core 220 can be stopped at any position.

On the other hand, when the opening degree of the opening/closing valve 342 is adjusted, the oscillating speed of the core 220 can be adjusted. That is, when the amount of bypass water flow via the bypass channel 340 is smaller, the speed of the core 220 becomes higher, and when the amount of bypass water flow via the bypass channel 340 is larger, the speed of the core 220 becomes lower. Therefore, adjusting the opening degree of the opening/closing valve 342 makes it possible to adjust the speed of the core 220. Here, the opening/closing valve 342 is an opening degree adjustment valve adjusting communicating state of the bypass channel 340, and is possible to adjust the pressure difference occurring between the two pressure chambers. In other words, the fluid force (the force resulting from the pressure difference between the two pressure chambers) acting on the core necessary for moving the core increases and decreases.

In the case of the specific example, one opening/closing valve 342 can stop the core 220 or control the speed independently of the oscillating direction of the core 220. The channel resistance of the right and left water channel extending to the water inlet ports 212, 214 does not change, therefore, the pressure loss in a water inlet pass does not change and the total amount of water discharge can be kept substantially constant during normal operation, during stopping, and during decreasing speed also.

In addition, the bypass channel 340 is preferred to communicate with the pressure chamber 216, 218 at both ends of the inside space of the housing 202. That is, the opening port of the bypass channel 340 is preferred to be formed close to the end of the housing 202 as much as possible so that the bypass channel 340 is not obstructed even if the core 220 is located at the end of right and left stroke.

The method of stopping of the specific example described above is applicable similarly to the driving unit 100 described previously with reference to FIG. 1 to FIG. 17.

As described above, the oscillating speed (including stop) can be controlled, thereby a user is allowed to stop the swinging motion of the shower unit at a desired angle while maintaining water sprinkle during taking a shower by sprinkle water from the shower unit, therefore gets ease of use.

Up to this point, driving unit 100 and driving unit 200 were described.

Next, a first embodiment of the shower apparatus of the invention is described. A shower apparatus 4 according to the first embodiment includes the driving unit 200 described above (the embodiment in which the core undergoes a reciprocating oscillatory motion).

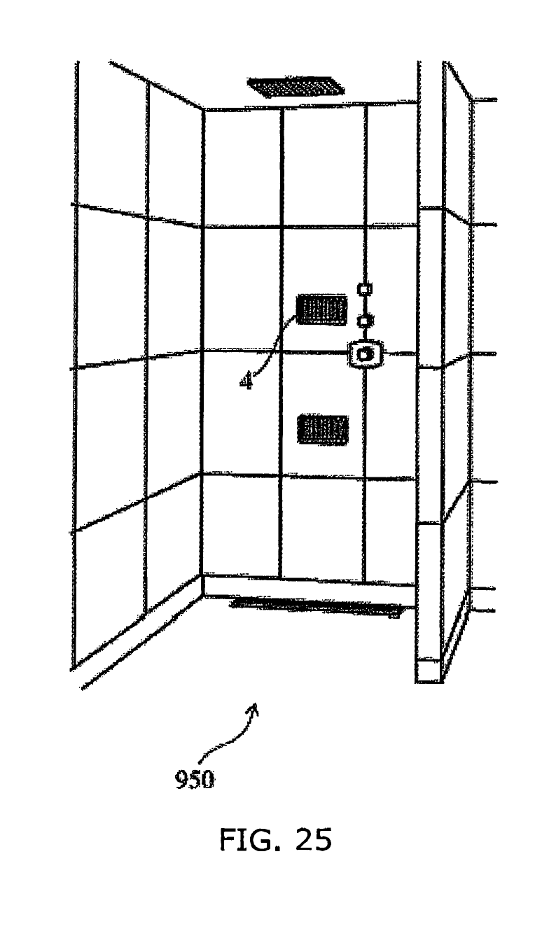

FIG. 25 is a schematic view showing a shower booth 950 installed with the shower apparatus 4 according to this embodiment.

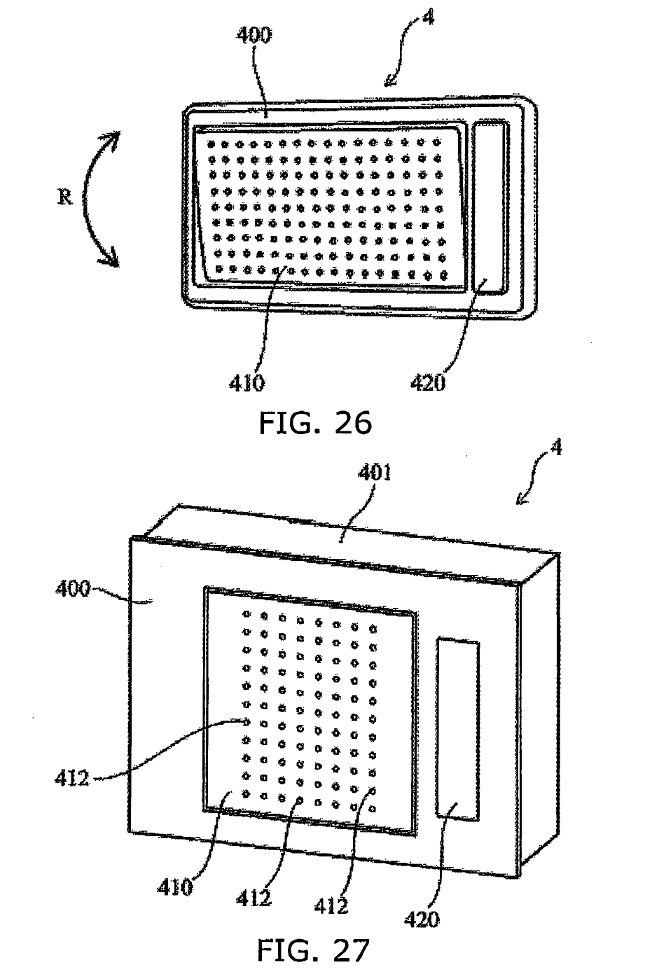

Moreover, FIG. 26 is a schematic view illustrating the appearance of the shower apparatus 4 of this embodiment.

The shower apparatus 4 of this embodiment includes a flame 400, and a shower unit 410 and a switch 420 supported by this flame. The flame 400 is allowed to be embedded in a wall of the shower booth 950 and a bathroom or the like. FIG. 25 illustrates the case of usage as a body shower, however this invention is not limited thereto. The shower apparatus 4 is installed on a ceiling of the shower booth 950 and a bathroom or the like, and can be used as an overhead shower.

The shower unit 410 swings up and down in the direction of arrow R. FIG. 24 shows the shower unit 410 pointing downward a little. In this way, the shower unit 410 swings up and down, thereby a user standing in front of the shower apparatus 4 can take a shower over a broad region of the body with free hands. As a result the user can not only take a shower effectively but also can get comfortable feeling of massage, because a shower water sprinkling site about the body changes periodically.

Furthermore, according to this embodiment, the shower apparatus 4 can be embedded in the wall of the shower booth and the bathroom. This not only allows a simple and good appearance but also can prevent giving an oppressive feeling to a user and colliding with the body in a tight shower booth and a bathroom or the like.

In the following, the structure of the shower apparatus 4 of this embodiment will be described.

FIG. 27 is a perspective view of the shower apparatus 4 of this embodiment as viewed from on high at an angle.

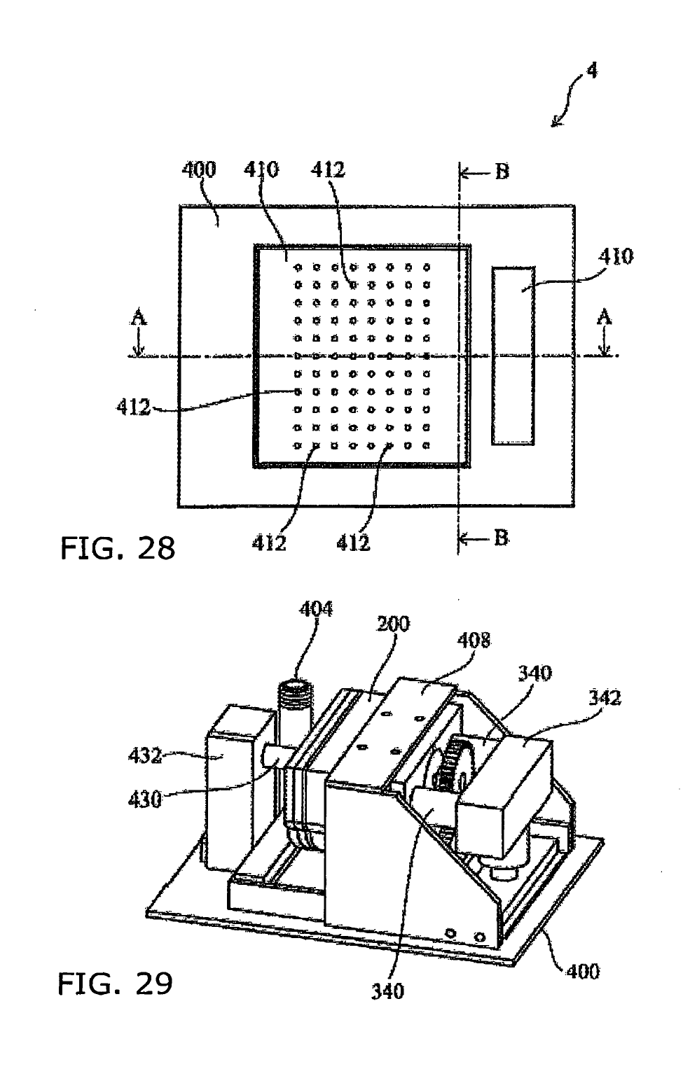

Moreover, FIG. 28 is a front view of the shower apparatus 4.

Additionally, FIG. 29 is a perspective view of the shower apparatus as viewed from the rear at an angle.

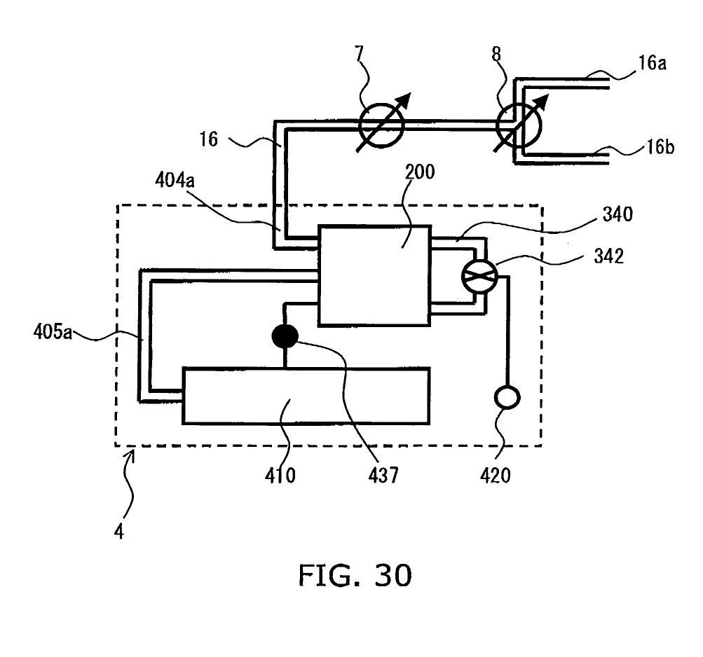

Furthermore, FIG. 30 is a schematic view showing the channel configuration of the shower apparatus 4.

In addition, the shower apparatus 4 shown in FIGS. 27 to 29 has a little different appearance from those shown in FIG. 25 and FIG. 26, but has the same interior structure.

The shower unit 410 is provided with plural shower sprinkle ports 412 in two dimensions with dual orientation, is allowed to sprinkle water in a broad area. A supporting flame 408 is provided in the interior protected by a casing 401 on the back side of the flame 400, and the driving unit 200 is fixed described previously with reference to FIGS. 18 to 24. Fixed water guide channels 430, 432 fixed to the flame 400 without associating with the core 220 are provided at one end of the driving unit 200, and introduce water to the shower unit 410. On the other hand, at another end of the driving unit 200, the bypass channel 340 and the opening/closing valve 342 described previously with reference to FIG. 24 are provided. The opening/closing valve 342 is allowed to open and close by a switch 420 provided in front of the flame 400. Furthermore, reciprocating oscillatory motion of the core of the driving unit 200 is transmitted to a gear 450 and causes the shower unit 410 to swing. Moreover, the casing 401 accommodating parts of the shower apparatus such as the supporting flame 400 and the driving unit 200 is provided on the backside of the flame 400. In addition, a part of a water supplier 404 is protruded outside the casing 401 and coupled to a water supply pipe on back of the wall. At this time, the coupling portion between the water supplier 404 and the casing 401 is covered with a seal member.

Referring to FIG. 30, the channel and the transmission path are described. Behind the wall, a water supply piping 16a, a hot water supply piping 16b, a temperature adjustment valve 8, a water stop valve 7, and a water supply channel 16 are provided. The temperature adjustment valve 8 controls the water temperature, and the water stop valve 7 regulates the flow of hot water to the water supply channel 16. The shower apparatus 4 includes a shower channel communicating from a channel 404a in the water supply unit 404 through the driving unit 200 and a water passage channel 405a to the shower unit 410. That is, the driving unit 200 is located on the shower channel. The channel 404a is connected to the water supply channel 16. The driving unit 200 is provided with a bypass channel 340, and an opening/closing valve 342 serving as an opening degree adjustment valve is provided on the bypass channel. The opening/closing valve 342 is operated by the switch 420. Here, the opening/closing valve 342 serves as a swing stop mechanism. Furthermore, a power transmission unit 437 serving to transmit the motion of the core of the driving unit 200 to the shower unit 410 is provided. Here, the gear 450 on the driving unit side and a gear 452 on the shower unit side serve as the power transmission unit 437.

The user opens the water stop valve 7, manipulates the temperature adjustment valve 8 to adjust the water temperature, and allows hot water to be discharged from the shower unit 410. Then, the user can manipulate the switch 420 to swing the shower unit 410, to stop swinging, and to adjust the speed of swinging.

Here, the water stop valve 7 can also include flow regulation capability.

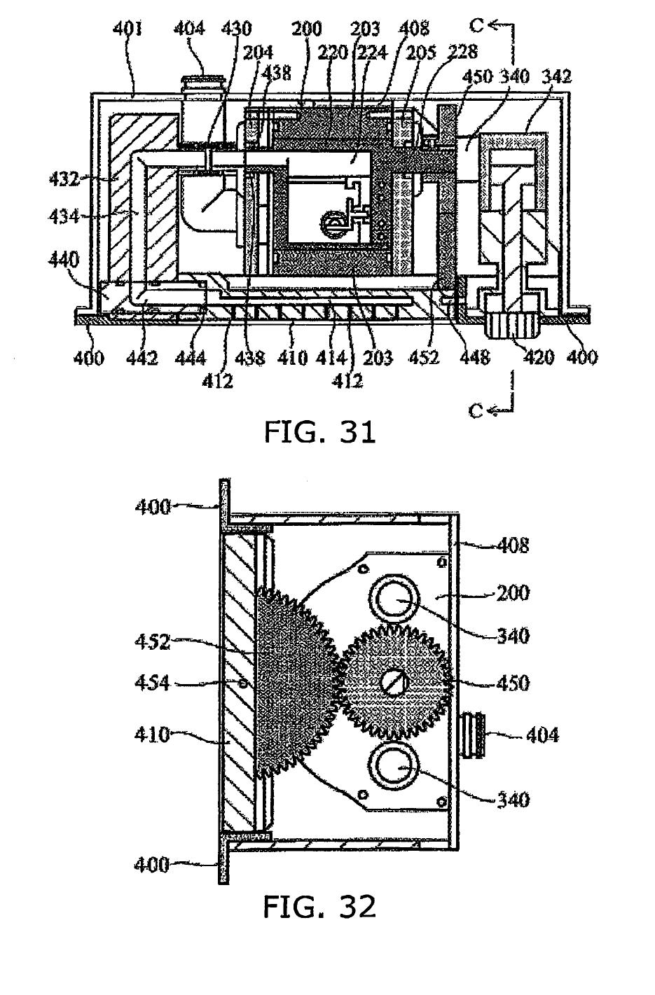

FIG. 31 is a cross-sectional view along line A-A in FIG. 28.

Moreover, all of FIGS. 32 to 34 are cross-sectional views along line B-B in FIG. 28.

One end of the shower unit 410 is axially supported by a pivotal supporting unit 440 and the other end is axially supported by a pivotal supporting unit 448.

Water supplied from a water supply source not shown in the figures is introduced to the water supplier 404. As described previously with reference to FIGS. 18 to 24, the water introduced to the water supplier 404 is introduced to the water inlet ports 212, 214 (See FIG. 23), causes the core 220 to oscillate reciprocatorily. And the water introduced into the core inner channel 224 is supplied to a water guide channel 414 provided in the shower unit 410 via the water guide channel 434 provided in the fixed water guide channels 430, 432 and the pivotal supporting unit 440, and sprinkled from the shower sprinkle port 412. A seal 438 such as O-ring or the like is provided between the core 220 reciprocatorily oscillating and the fixed water guide channel 430. Moreover, a seal 444 such as O-ring or the like is provided between the swinging shower unit 410 and the fixed pivotal supporting unit 440, too.

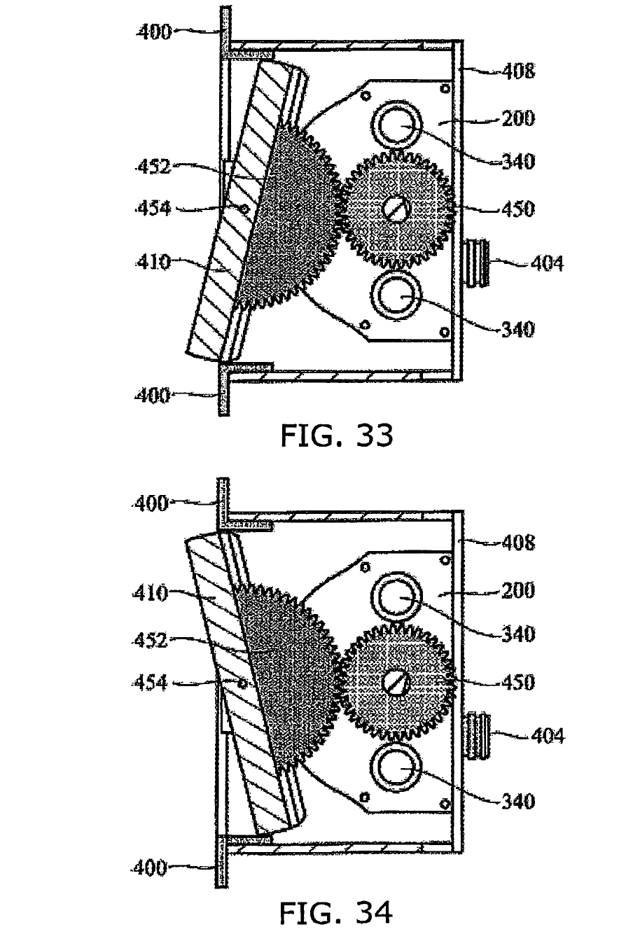

One end 228 of the core 220 in the driving unit 200 penetrates the housing lid 205 and protrudes, where is fixed to the gear 450 and transmits reciprocating oscillatory motion of the core 220 to the gear 450. The gear 450 transmits the reciprocating oscillatory motion to the gear 452 which is fixed to the shower unit 410 (power transmission unit). As a result, the shower unit 410 swings. FIG. 32 shows the state of the shower unit 410 facing front face, FIG. 33 shows the state of the shower unit 410 facing up at an angle and FIG. 34 shows the state of the shower unit 410 facing down at an angle. A movable range of the shower unit 410 can be, for example, approximately between plus and minus 30 degrees. In this way, the reciprocating oscillatory motion of the core 220 causes the shower unit 410 to swing repetitively up and down. More specifically, the gear 450 and the gear 452 bear the power transmission unit.

According to this embodiment, the size of the driving unit 200 and the gear ratio between the gears 450 and 452 can be suitably selected to select the speed and angle of the swinging motion of the shower unit 410.

With regard to the swing angle, if it is too wide, hot water is wastefully discharged to unnecessary directions. Hence, preferably, the swing angle is approximately ±30 degrees as described above. Furthermore, if the swing angle is set in the range of ±10-20 degrees, the area from the shoulders to the waist, for instance, can be targeted more restrictively, and the massage effect due to the swinging water discharge can be achieved more effectively.

To provide a user with a comfortable effect of massage, such as caressing massage and gentling massage, the swing speed is preferably in the range of 0.1-10 rpm. Swinging at fast swing speed feels busy and makes it impossible to perceive the motion. On the other hand, swinging at slow swing speed causes impatience and frustration, and feels cold because the discharged water takes long to come. It is more effective to set the swing speed in the range of 0.5-9 rpm. Moreover, the swing speed in the range of 1-8 rpm can provide numerous users with much more comfort.

The frequency of swinging motion of the shower unit 410 is preferred to be 0.01 hertz or more and 5 hertz or less to give a comfortable feeling of massage and effect of working out of stiffness. Moreover, it is more effective when the frequency is 0.1 hertz or more and 3 hertz or less. Furthermore, when the frequency is 0.2 hertz or more and 1 hertz or less, a user can receive still more comfortable feeling. According to this embodiment, the swinging motion of the shower unit 410 can be achieved at the frequency like this.

The preferable range of the swing angle, the swing speed, and the frequency of the swinging motion also applies to the shower apparatuses according to the other embodiments described later.

Moreover, in this embodiment, the oscillating axis of the reciprocating oscillatory motion of the core 220 is different from the swinging axis of the swinging motion of the shower unit 410. That is, the oscillating axis of the reciprocating oscillatory motion of the core 220 is provided on the backside apart from the flame 400, on the other hand, the swinging axis of the swinging motion of the shower unit 410 is provided near to the flame 400. In this way, the shower unit 410 can be provided in front of the shower flame 400 while accommodating the driving unit 200 on the rear side. That is, the shower apparatus can be provided, which has no protruding portion around the shower unit 400 and is easy to use with clear appearance.

On the other hand, in the shower apparatus of this embodiment, the swinging motion of the shower unit 410 can be stopped at any angle by operation of the switch 420.

That is, the bypass channel 340 and the opening/closing valve 342 are provided in the driving unit 200 and the bypass channel 340 is allowed to be opened and closed by the switch 420.

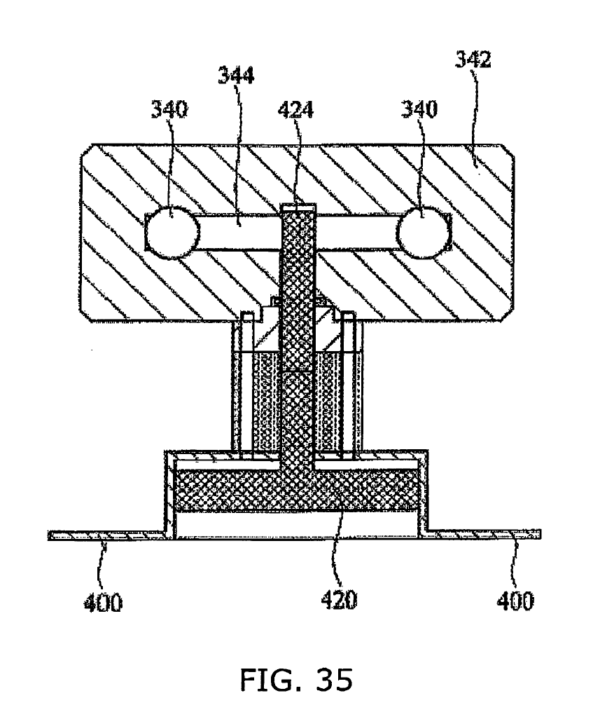

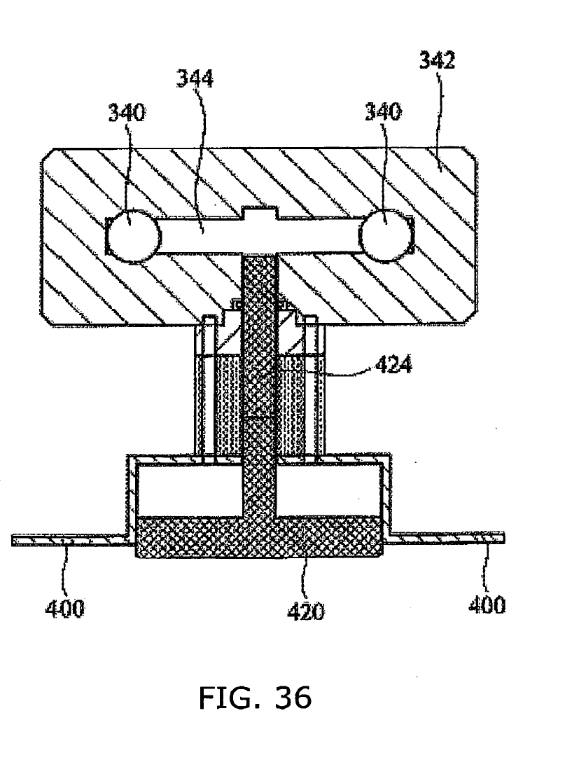

FIG. 35 and FIG. 36 are cross-sectional views along line C-C in FIG. 31.

A valve inner channel 344 existing on a way to the bypass channel 340 is provided in the interior of the opening/closing valve 342. And a screening body 424 is supported so as to be capable of opening and closing the valve inner channel 344. FIG. 35 shows the state that the switch 420 is pushed and the valve inner channel 344 is Interrupted by forward movement of the screening body 424. In this state, the bypass channel 340 is interrupted, therefore, as described previously with reference to FIG. 24, core 220 in driving unit 200 oscillates reciprocatorily and the shower unit 410 swings.

On the other hand, as shown in FIG. 36, in the state of the switch 420 being unpushed, the valve inner channel 344 is opened by backward movement of the screening body 424. In this state, the bypass channel 340 is not interrupted, therefore, as described previously with reference to FIG. 24, the pressure difference between the right and left pressure chamber 216, 218 diminishes and the core 220 stops. That is, the shower unit 410 stops without the swinging motion. Moreover, in this state, for example, a user can also change the direction of the shower unit 410 freely by pushing the shower unit 410 in either direction of up or down. That is, in the state of the shower unit 410 of stopping the swinging motion, the direction of water sprinkle can be changed depending on user's preference, providing excellent usability.

In addition, the switch 420 is allowed to hold the state shown in FIG. 35 and the state shown in FIG. 36, respectively by providing a biasing mechanism and a latch mechanism or the like. That is, every time of pushing the switch 420, the state shown in FIG. 35 and the state shown in FIG. 36 are realized alternatively, and a user can enjoy taking a shower by the swinging motion of the shower unit 410 leaving one's hands from the switch 420.

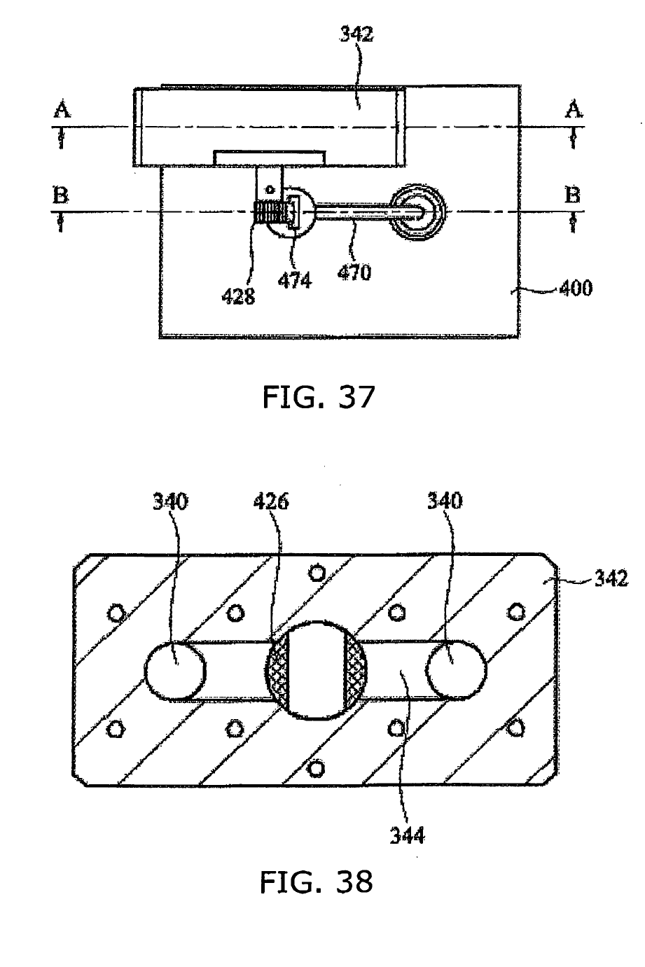

FIGS. 37 to 41 are schematic views showing variations of mechanism opening and closing the bypass channel 340.

That is, FIG. 37 is a schematic view of the part of the opening/closing mechanism as viewed from the backside of the flame 400.

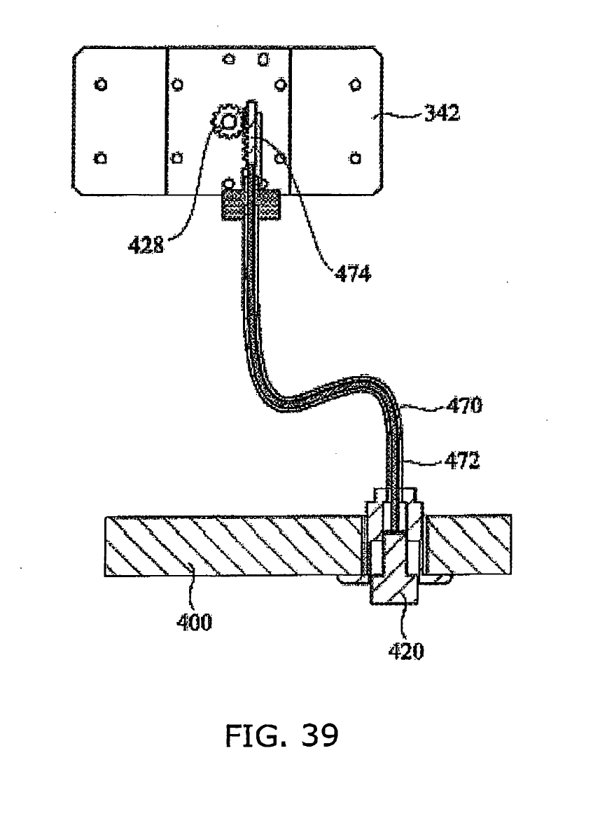

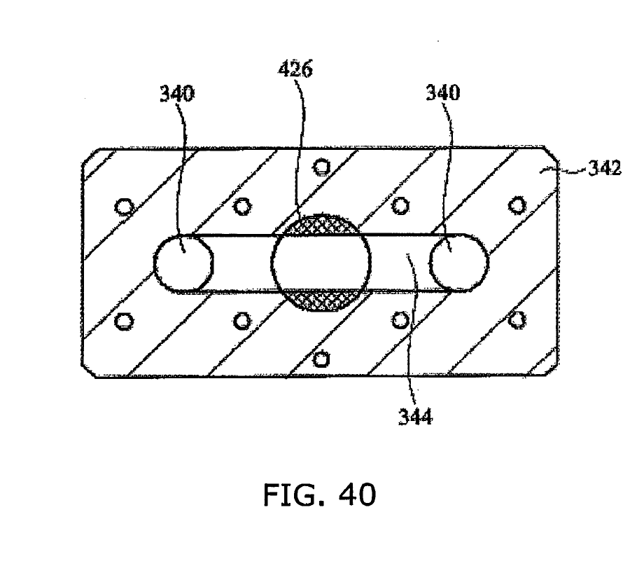

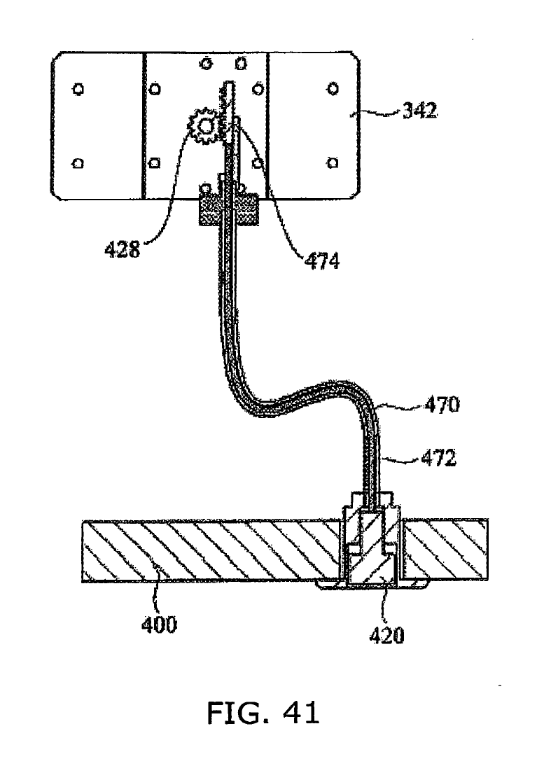

Moreover, FIG. 38 and FIG. 40 are cross-sectional views along line A-A in FIG. 37, and FIG. 39 and FIG. 41 are cross-sectional views along line B-B in FIG. 37.

Also in this variation, opening/closing valve 342 is provided on a way to bypass channel 340. Valve inner channel 344 is provided in the interior of opening/closing valve 342 and is allowed to be opened and closed by rotating screening body 426. A screening body 426 is driven by a gear 428. A wire 472 slidably kept in a guide 470 is coupled to the switch 420. The tip of the wire 472 is coupled to a rack 474. When the switch 420 is pushed, the wire 472 slides and the rack 474 rotates the gear 428. The rotation of the gear 428 is transmitted to the screening body 426 and the valve inner channel 344 is opened and closed.

As shown in FIG. 38 and FIG. 39, in the state of the screening body 426 screening the valve inner channel 344, the core 220 in the driving unit 200 oscillates reciprocatorily and the shower unit 410 swings.

On the other hand, as shown in FIG. 40 and FIG. 41, in the state of the screening body 426 opening the valve inner channel 344, the core 220 in the driving unit 200 stops and the shower unit 410 also stops. In this way, the shower unit 410 can either swing or stop on depending user's preference.

Also in this variation, the state shown in FIG. 38 and FIG. 39 and the state shown in FIG. 40 and FIG. 41 are allowed to be hold, respectively by providing a latch mechanism to the switch 420 and providing a biasing mechanism to the wire 472. That is, every time pushing the switch 420, the state shown in FIG. 38 and FIG. 39 and the state shown in FIG. 40 and FIG. 41 are realized alternatively, and a user can enjoy taking a shower by swinging motion of the shower unit 410 leaving one's hands from the switch 420.

Here, the channel resistance of the bypass channel 340 depends on the open/closed state of the opening/closing valve 342, but the channel resistance of the shower channel remains substantially unchanged. Hence, the sprinkling flow rate from the shower unit 410 is substantially the same between the swing state and the swing stopped state of the shower unit 410. The user switches the swing state of the shower unit 410 in accordance with the scene of taking a shower on a wide area of the body to wash off the soap and the like or to relax, and the scene of taking a shower on a particular site of the body to shampoo the hair or to intensively warm or stimulate the shoulder, waist and the like. Thus, the sprinkling flow rate which can be kept nearly unchanged serves to eliminate the need of cumbersome adjustment of flow rate at the time of switching the swing state, and to bring no discomfort due to varied flow rate, ensuring the continuity of the feeling of shower bathing. Furthermore, even during switching the swing state, the sprinkling flow rate is kept constant without substantial change in the channel resistance of the shower channel, and hence the continuity can be ensured. Furthermore, the ignition determination of the water heater is not affected, and the temperature of hot water can be kept substantially constant.

Here, the term “same”, “constant”, “equal”, or “unchanged” used in connection with the sprinkling flow rate also includes such variation in flow rate that falls short of the user's feeling of unpleasantness or discomfort, and the term refers to the case where the deviation of flow rate is 20% or less, and more preferably 10% or less.

The feeling of shower bathing tends to be more favorable as the flow rate increases. However, swinging can provide the feeling of bathing even with lower flow rate. In terms of sprinkling flow rate, a sufficient feeling of bathing can be achieved with, but not limited to, 9.5 L/min or less, more preferably 8.0 L/min or less, and still more preferably 6.5 L/min or less. Thus, swinging provides a water-saving effect.

Furthermore, the core 220 and the shower unit 410 are stopped by decreasing the fluid force acting on the core 220 in the driving unit 200. Hence, when the shower unit 410 stops swinging, the user can manually change the sprinkling direction of the shower unit 410. Thus, in the stopped state, the user can accurately position the discharged water at a desired site. At this time, the power transmission unit 437 (gear 450 and gear 452) remains coupled, and the core 220 is interlocked with the shower unit 410. That is, no matter how the user manually adjusts the position of the shower unit 410, the core 220 and the shower unit 410 continue to be coupled. Hence, the shower unit 410 can restart swinging without such problems as coupling failure, time-consuming restart, and off-centered swinging. Thus, the swing state can be smoothly and accurately reproduced.

Here, for a driving unit including pressure chambers across a core, such as the driving unit 200 and the driving unit 100, a damper effect acts on the core from hot water in the pressure chambers. Hence, more advantageously, when manually moved, the shower unit 410 can be easily positioned without a jerk, and a moderate feeling of manipulation is achieved. Furthermore, as compared with a waterwheel, the core moves more slowly and does not need a deceleration mechanism such as a multistage gear train, thus simplifying the power transmission unit. Hence, more advantageously, the torque required to manually move the shower unit is reduced.

The sliding torque for the swing of the shower unit 410 is preferably in the range of 10-1500 mN·m. When the shower unit 410 stops while keeping sprinkling, the user can easily push the shower unit 410 to change the sprinkling direction of the shower unit. Furthermore, the shower unit does not move spontaneously by the reaction force of sprinkling and by gravity. Hence, the changed position of the shower unit can be maintained. Thus, the user can bathe with hands free. Here, the sliding torque for the swing of the shower unit 410 in the range of 10-1000 mN·m allows more users to easily use it. In the range of 10-250 mN·m, still more users from adults to children can use it more conveniently.

In the configuration of the driving unit 200, the housing 202 (housing main body 203 and housing lids 204, 205) is fixed to the frame 400, and the core 220 is interlocked with the shower unit 410. Thus, as compared with the configuration in which the core 220 is fixed to the frame and the housing 202 is coupled and interlocked with the shower unit 410, the driving torque can be reduced, and the driving unit is potentially downsized. Thus, the weight of the shower unit is reduced and becomes easy to move manually.

The operation of the opening/closing valve 342 has been described with reference to the opening/closing of the bypass channel 340. Alternatively, the operation can be configured so as to adjust the opening degree of the bypass channel 340. That is, the fluid force acting on the core is adjusted. For instance, the aforementioned switch 420 is stopped halfway, and accordingly, the shield 424 or the shield 426 is stopped halfway between the open and closed position. This configuration can realize a state between the state of the fastest swing speed (the closed state of the bypass channel 340) and the swing stopped state (the open state of the bypass channel 340). Hence, this configuration can also respond to scenes of the user desiring to quickly wet a wide area of the body or to slowly and sufficiently wash off the soap, and can further meet the user's preferences. Furthermore, the channel resistance of the shower channel remains substantially unchanged. Hence, the swing speed can be adjusted while keeping the sprinkling flow rate constant, and the continuity of the feeling of shower bathing can be ensured. Furthermore, variations during manufacturing can be absorbed.

Thus, the configuration including a bypass communicating between two pressure chambers and an opening degree adjustment valve provided on the bypass is effective in controlling the swing state of the shower unit. Here, the driving unit used in the shower apparatus is not limited to the driving units 100, 200 described above, but can be any driving unit composed of a piston and a cylinder. For instance, the driving unit can be of the type using a four-way valve to switch incoming water and outgoing water of two pressure chambers. In the case where the core undergoes a reciprocating linear motion as in the driving unit 100, the power transmission unit serves as a mechanism for converting linear motion into rotary motion. For instance, it can be a mechanism composed of a rack and a pinion.

Moreover, a clearance between the shower unit having the shower sprinkle port and the flame 400 is formed to have dimension so that hands are not caught even if the shower unit 410 swings. It is more preferred that an opening side plane for providing the shower unit 410 of the flame is formed in a shape along swinging track of the end of the shower unit 410 so that the clearance is substantially constant even if the shower unit 410 swings.

Furthermore, the casing 401 is preferred to be formed in a shape of a box having an opening on the side of the shower unit 410 of the shower apparatus 4. In this way, even if water flows into the clearance between the shower unit 410 and the flame 400, the water does not leak to the backside of the wall by the casing 401 formed in a shape of a box. It is more preferred that the bottom surface of the casing 401 has a downward slope on the side of the shower unit 410, the water flowed into the casing 401 can be drained off to a bath room or the shower booth.

The swinging motion in the invention is referred to as a reciprocating motion about the swinging axis. The swinging axis may point in any direction. The swinging motion can be an up-and-down motion, a left-and-right motion, and a slanted motion depending on the swinging axis.

Here, ‘swinging motion’ in this embodiment means by action of the shower unit described above. That is, the shower unit having the sprinkle port has a swinging axis, and the shower unit swings reciprocatorily about the axis. At this time, the water sprinkle plane of the shower unit is substantially parallel (the opening direction of the sprinkle port of the shower unit is substantially perpendicular) to the swinging axis. In this way, the region allowing the shower unit to exist can be reduced and maintained to be substantially constant while discharging water in a broad area by the swinging action of the shower unit, therefore, the shower apparatus with improved design can be realized. Moreover, the swinging axis is preferred to be provided close to the sprinkle port of the shower unit. Furthermore, in the state of the shower apparatus installed, the sprinkle port is preferred to be provided more forward than the swinging axis. In addition, because the shower unit is that swings vertically, the swinging axis in this embodiment is provided substantially parallel to a floor surface.

Next, embodiments including a plurality of routes are described. Here, the route refers to the course of the water channel leading to the shower unit.

First, a second embodiment of the shower apparatus of the invention is described. A shower apparatus 10 according to the second embodiment includes a plurality of channels guiding hot water to the shower unit, and includes the driving unit 200 described above (the embodiment in which the core undergoes a reciprocating oscillatory motion). Furthermore, the shower apparatus 10 includes a switching valve 513, which is a first example of the switching valve.

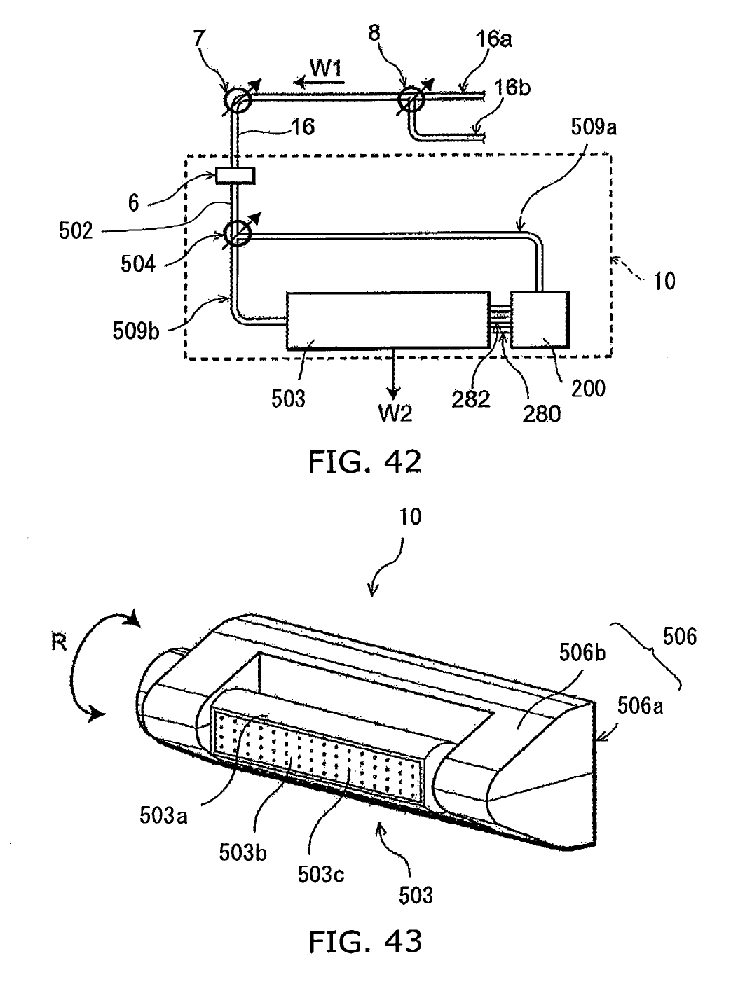

FIG. 42 is a schematic view illustrating the configuration of the shower apparatus 10 according to the second embodiment.

FIG. 43 is a schematic perspective view illustrating the appearance of the shower apparatus 10.

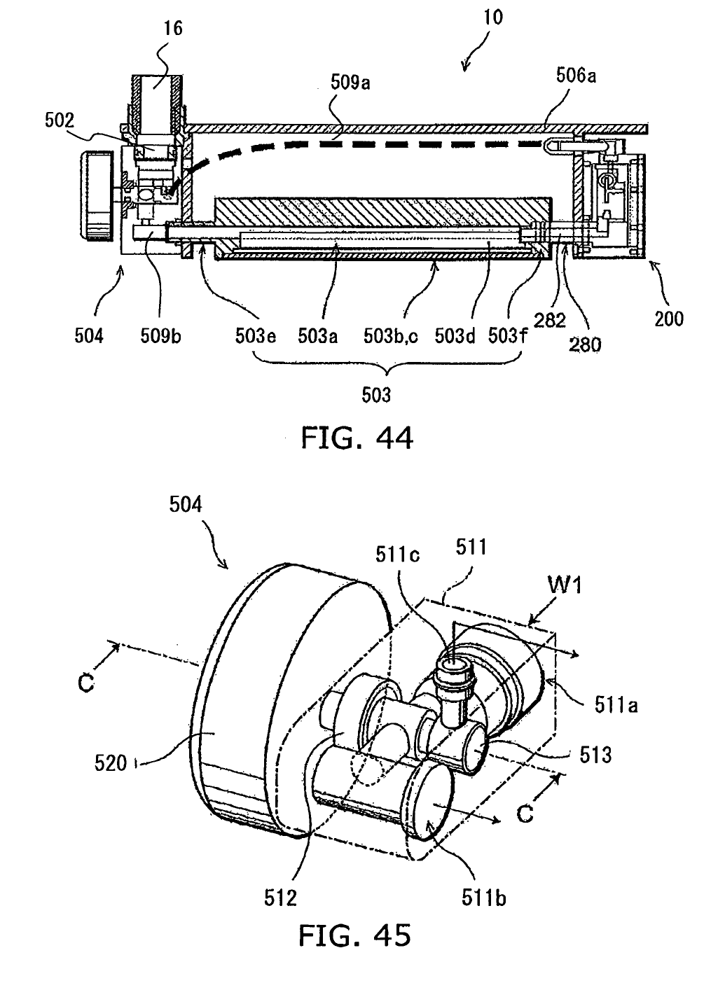

FIG. 44 is a plan cross-sectional view of the shower apparatus 10.

FIG. 45 is a schematic perspective view of a channel switching unit used in the shower apparatus 10.

The same components as those illustrated in the above first embodiment are labeled with like reference numerals, and the description thereof is omitted as appropriate.

As shown in FIGS. 42 to 45, the shower apparatus 10 includes a driving unit 200, a shower unit 503, a channel switching unit 504 including a switching valve 513, and a casing 506. Furthermore, a water stop valve 7 and a temperature adjustment valve 8 are provided on the water supply channel 16 guiding hot water to the shower apparatus 10. The water supply channel 16 is connected to a channel 502 in the incoming water connecting portion of the shower apparatus 10. The channel 502 is branched in the channel switching unit 504 into a driving unit channel 509a leading to the driving unit 200 and a main channel 509b leading to the shower unit 503. Furthermore, a channel 282 leading from the driving unit 200 to the shower unit 503 is provided. Hot water supplied to the temperature adjustment valve 8 is discharged from a shower sprinkling ports 503c of the shower unit 503.

In this embodiment, the channel 502, the driving unit channel 509a, and the channel 282 constitute a shower channel. The switching valve 513 serves as a swing stop mechanism. As described later, the water discharge tubular body 280 of the driving unit 200 is directly connected to the shower unit 503, and the connecting portion serves as a power transmission unit.

The casing 506 includes a frame 506a to which the driving unit 200, the channel switching unit 504 and the like are attached, and a cover 6b for covering these components and pipings. The shower apparatus 10 is attached to the wall surface of a bathroom or a shower room via the frame 506a.

As shown in FIG. 43, the shower unit 503 includes a flat portion in the radial direction of a cylindrical main body 503a, and the flat portion is provided with a plate 3b including a plurality of shower sprinkling ports 503c. A space 503d provided inside the main body 503a communicates with the shower sprinkling ports 503c. On one axial end surface of the main body 503a, a shaft 503e including a channel is provided so as to protrude therefrom, and on the other axial end surface, a hole 503f having a circular cross section is provided. The channel provided in the shaft 503e and the hole 503f communicate with the space 503d provided inside the main body 503a.

The water discharge tubular body 280 (see FIG. 19) is connected liquid-tight to the hole 503f. The shaft 503e is connected liquid-tight to an outflow port 511b of the channel switching unit 504. The shower unit 503 is held by the shaft 503e and the water discharge tubular body 280 so as to be swingable in the direction of arrow R (see FIG. 43). The water discharge tubular body 280 and the main body 503a are connected in a slot-fit connection and move together. Hot water can flow into the space 503d through the channel provided in the shaft 503e and the channel 282 provided in the water discharge tubular body 280. Then, the hot water is discharged from the shower sprinkling ports 503c.

When the driving unit 200 is supplied with a prescribed amount of hot water, the core starts to move and swings the shower unit 503 in the direction of arrow R. At this time, the hot water which has driven the driving unit 200 is sent to the shower unit 503 and discharged. That is, the shower unit 503 discharges water while swinging. As described later, by manipulating the switching valve 513, the swing of the shower unit 503 can be stopped at an arbitrary angle while continuing to discharge water. Here, the switching valve 513 allows the sprinkling flow rate at swing time to be nearly equal to the sprinkling flow rate at swing stop time.

The channel switching unit 504 includes a handle 520, a main body 511, a bearing unit 512, and a switching valve 513.

The main body 511 includes an inflow port 511a and outflow ports 511b, 511c. The inflow port 511a communicates with the water supply channel 16 through the channel 502. The outflow port sub communicates with the shower unit 503 through the main channel 509b. The outflow port 511c communicates with the driving unit 200 through the driving unit channel 509a. In the main body 511, the channel from the inflow port 511a bifurcates and communicates with the outflow ports 511b, 511c.

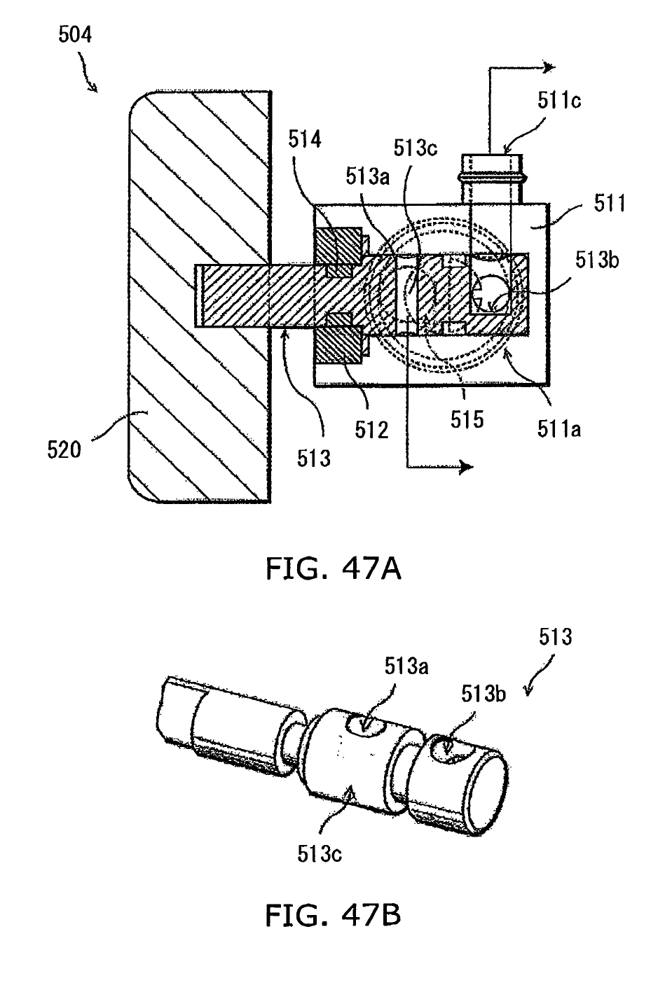

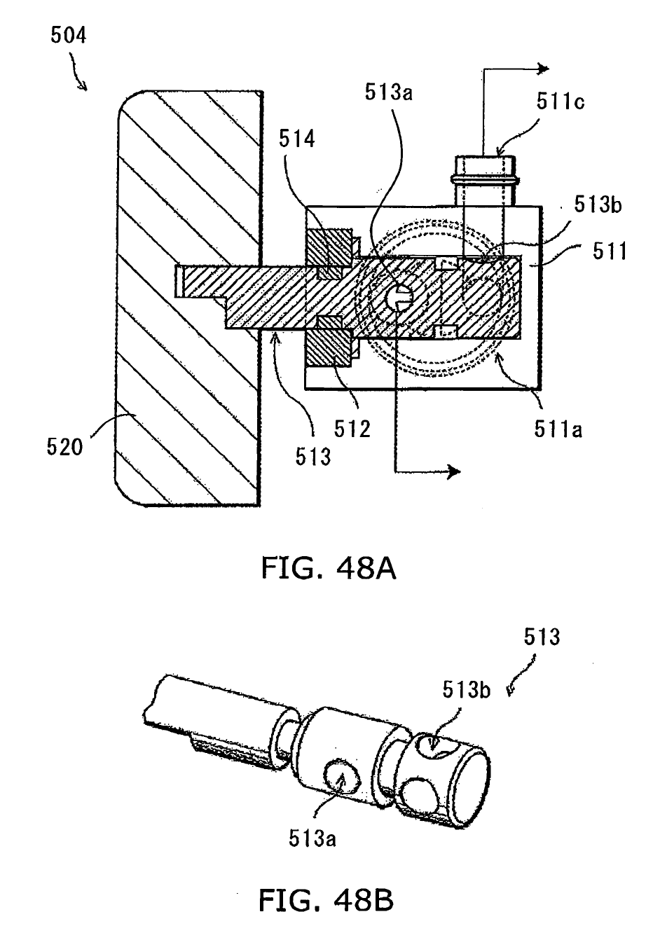

The switching valve 513 is shaped like a cylinder, through which a throttle 513a radially penetrates in a straight line and a throttle 513b radially penetrates in an L-shaped bend (see FIGS. 47 and 48). As described later, by rotating the switching valve 513, the channel cross-sectional area of the portion including the throttles 513a, 513b can be varied.

The throttle 513a is provided on the channel communicating with the outflow port 511b downstream of the bifurcation of the channel from the inflow port 511a. The throttle 513b is provided on the channel communicating with the outflow port 511c downstream of the bifurcation of the channel from the inflow port 511a. Hence, the channel cross-sectional area, or the channel resistance, of each channel can be varied by varying the positional relationship between each throttle and the corresponding channel. Here, the throttle 513b can control the flow rate through the driving unit channel 509a, and the throttle 513a can control the flow rate through the main channel 509b. That is, the switching valve 513 can collectively control the respective flow rates through the driving unit channel 509a and the main channel 509b.

Here, the throttle 513a, the throttle 513b, and the corresponding channels are configured so that the direction of change in the channel cross-sectional area at the throttle 513a is opposite to the direction of change in the channel cross-sectional area at the throttle 513b. That is, when the channel cross-sectional area at the throttle 513a changes from large to small, the channel cross-sectional area at the throttle 513b changes from small to large.

The bearing unit 512 has an annular shape and is fixed to the hole provided in the main body 511. The switching valve 513 is rotatably inserted through the hole provided at the center of the bearing unit 512. Here, a sealing member 514 is provided in the groove portion of the switching valve 513 to maintain liquid-tightness with the bearing unit 512. Furthermore, the bearing unit 512 holds the axial position of the switching valve 513, preventing the throttle 513a and the throttle 513b from being displaced from the associated channels. One end portion of the switching valve 513 protrudes from the main body 511, and the handle 520 is attached thereto.

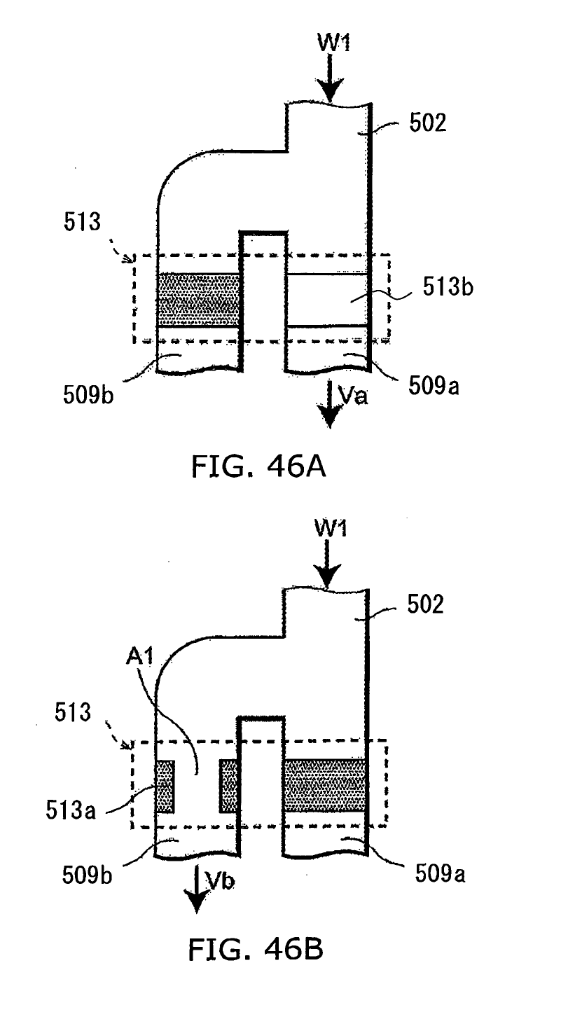

FIG. 46 is a schematic view for illustrating the flow rate control by the switching valve 513, in which FIG. 46A is a schematic view showing the state where the driving unit channel 509a side is opened (hereinafter “first state”), and FIG. 46B is a schematic view showing the state where the driving unit channel 509a side is closed (hereinafter “second state”).

FIG. 47 corresponds to the state of FIG. 46A, in which FIG. 47A is a cross-sectional view of the channel switching unit, and FIG. 47B is a perspective view of the switching valve.

FIG. 48 corresponds to the state of FIG. 46B, in which FIG. 48A is a cross-sectional view of the channel switching unit, and FIG. 48B is a perspective view of the switching valve.

In the first state, the throttle 513b opens the channel communicating between the inflow port 511a and the outflow port 511c. That is, the throttle 513b aligns the axis of the throttle 513b with the axis of the communicating channel to minimize the channel resistance. At this time, the throttle 513a closes the channel communicating between the inflow port 511a and the outflow port 511b. That is, the outer peripheral surface of the switching valve 513 in the portion including the throttle 513a occludes an opening 515 on the main channel 509b side and blocks the communication of the channel.

In the second state, the throttle 513b closes the channel communicating between the inflow port 511a and the outflow port 511c. That is, the outer peripheral surface of the switching valve 513 in the portion including the throttle 513b occludes the opening on the driving unit channel 509a side and blocks the communication of the channel. At this time, the throttle 513a opens the channel communicating between the inflow port 511a and the outflow port 511b. That is the throttle 513a aligns the axis of the throttle 513a with the axis of the communicating channel to minimize the channel resistance.

Here, the throttling amount A1 of the throttle 513a is determined so that the total channel resistance on the main channel 509b side in the second state is nearly equal to the total channel resistance on the driving unit channel 509a side in the first state. The term “total channel resistance” used herein refers to the total of the channel resistance from the channel 502 through the driving unit channel 509a or the main channel 509b to the shower unit 503.

This configuration allows the flow rate Va in the first state to be nearly equal to the flow rate Vb in the second state.

Here, the swing of the shower apparatus 10 is described.

In the first state, the driving unit 200 is supplied with hot water. Hence, a fluid force acts on the core, and the core undergoes repetitive motion. Consequently, the shower unit 503 discharges water while swinging. On the other hand, in the second state, the driving unit 200 is not supplied with hot water, no fluid force acts on the core, and the core stops. At this time, by the action of the switching valve 513, a flow rate nearly equal to the sprinkling flow rate at swing time is supplied to the shower unit 503 through the main channel 509b. That is, the shower unit 503 discharges water with the swing stopped.

The user can switch between the swing state and the swing stop state by rotating the handle 520. At this time, the sprinkling flow rate can be kept nearly unchanged. This serves to eliminate the need of cumbersome adjustment of flow rate at the time of switching the swing state, and to bring no discomfort due to varied flow rate, ensuring the continuity of the feeling of shower bathing. These effects are similar to those of the shower apparatus 4 described above.

Thus, by reducing the flow rate supplied to the driving unit 200, the fluid force acting on the core is reduced, and the swing of the shower unit 503 can be reliably stopped. Furthermore, reduction of the flow rate through the driving unit 200 reduces problems related to water quality and the like (small sand and dust), allowing construction of a reliable system. Furthermore, the switching valve 513 serves for channel switching and flow rate control, achieving a compact configuration.

Furthermore, because the fluid force is reduced, the user can manually move the sprinkling direction of the shower unit 503 in the stopped state of the shower unit 503. Thus, in the stopped state, the user can accurately position the discharged water at a desired site. At this time, the core 220 and the shower unit 503 remain coupled, and are interlocked with each other. That is, no matter how the user manually adjusts the position of the shower unit 503, the core 220 continues to be coupled. Hence, the shower unit 503 can restart swinging without such problems as coupling failure, time-consuming restart, and off-centered swinging. Thus, the swing state can be smoothly and accurately reproduced.

Here, for a driving unit including pressure chambers across a core, such as the driving unit 200 and the driving unit 100, a damper effect acts on the core from hot water in the pressure chambers. Hence, more advantageously, when manually moved, the shower unit 503 can be easily positioned without a jerk, and a moderate feeling of manipulation is achieved. Furthermore, as compared with a waterwheel, the core moves more slowly and does not need a deceleration mechanism such as a multistage gear train, thus simplifying the power transmission unit. Hence, more advantageously, the torque required to manually move the shower unit is reduced.

In the configuration of the driving unit 200, the housing is fixed to the frame 506a, and the core is interlocked with the shower unit 503. Thus, as compared with the configuration in which the core is fixed to the frame and the housing is coupled and interlocked with the shower unit 503, the driving torque can be reduced, and the driving unit is potentially downsized. Thus, the weight of the shower unit is reduced and becomes easy to move manually.

The operation of the switching valve 513 has been described with reference to the first state and the second state. Here, the switching valve 513 can also be configured so as to allow an intermediate state between the first state and the second state. For instance, the shape of the throttle 513a and the throttle 513b can be configured so as to gradually vary in the rotation direction. Then, water discharge is continued also in the process of switching between the swing state and the swing stop state, and the continuity can be maintained. Furthermore, the throttling amount of the throttle 513a and the throttle 513b can be configured so that the total channel resistance on the main channel 509b side is nearly equal to the total channel resistance on the driving unit channel 509a side. Thus, the sprinkling flow rate can be kept constant. In this configuration, more advantageously, the ignition determination of the water heater is not affected, and the temperature of hot water can be kept substantially constant. This configuration is operative to adjust the fluid force acting on the core, and can realize a swing speed between the state of the fastest swing speed (first state) and the swing stopped state (second state). Because the swing speed is controllable, this configuration can respond to the user's preferences.

Thus, the channel communicating with the shower unit is branched into a channel traversing the driving unit and a channel bypassing the driving unit, and a switching valve is provided to control the flow rate through the two channels. This configuration is effective in controlling the swing state of the shower unit. Furthermore, because the driving unit is not moved during the swing stop time of the shower unit, the lifetime is extended. Here, the driving unit used in the shower apparatus is not limited to the piston-cylinder type like the driving units 100, 200 described above, but a driving unit based on a rotatable waterwheel can also be used. In the case of using a rotatable waterwheel, the power transmission unit serves as a mechanism for decelerating the rotation of the waterwheel and converting the rotation into the swinging motion of the shower unit. For instance, it can include a plurality of gear trains and a crank mechanism.

Furthermore, a constant flow rate valve can be provided on the channel 502, and can function as a limiter for protecting the shower apparatus under high hydraulic pressure.

Next, a switching valve 523, which is a second example of the switching valve, is described.

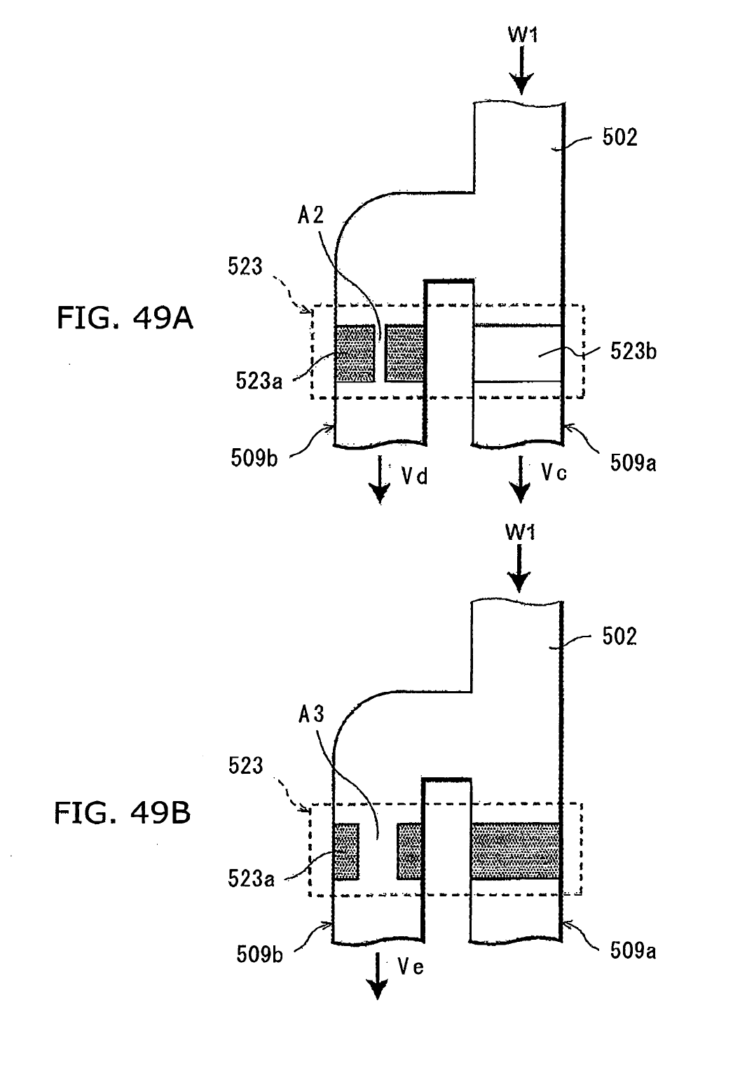

FIG. 49 is a schematic view for illustrating the flow rate control by the switching valve 523, in which FIG. 49A is a schematic view showing the state where the driving unit channel 509a side is opened (hereinafter “first state”), and FIG. 49B is a schematic view showing the state where the driving unit channel 509a side is closed (hereinafter “second state”).

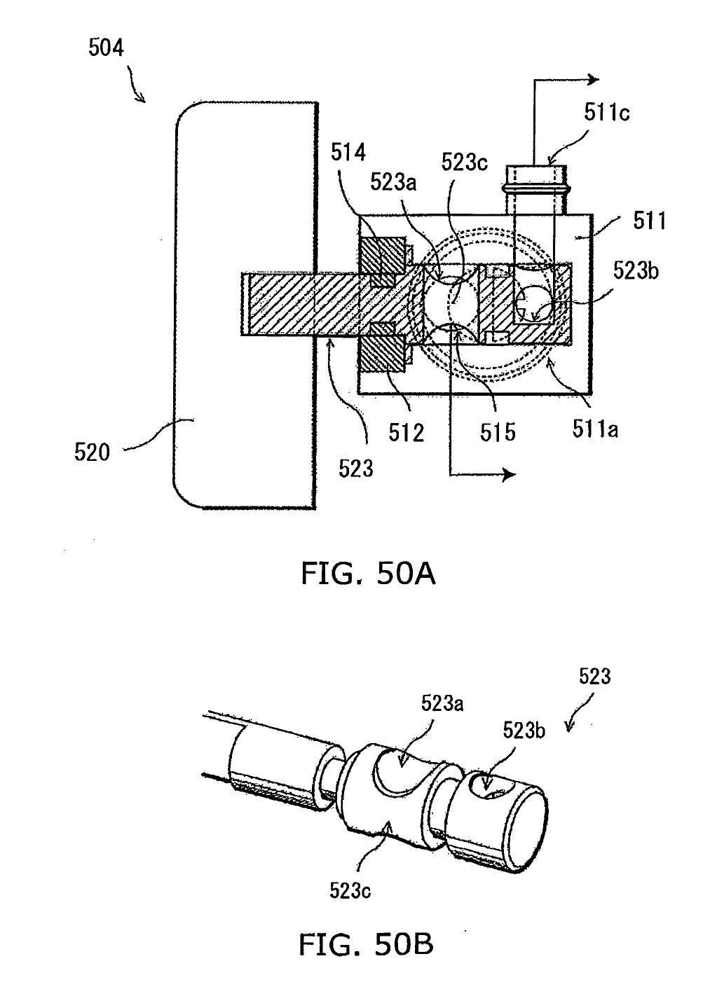

FIG. 50 corresponds to the state of FIG. 49A, in which FIG. 50A is a cross-sectional view of the channel switching unit, and FIG. 50B is a perspective view of the switching valve.

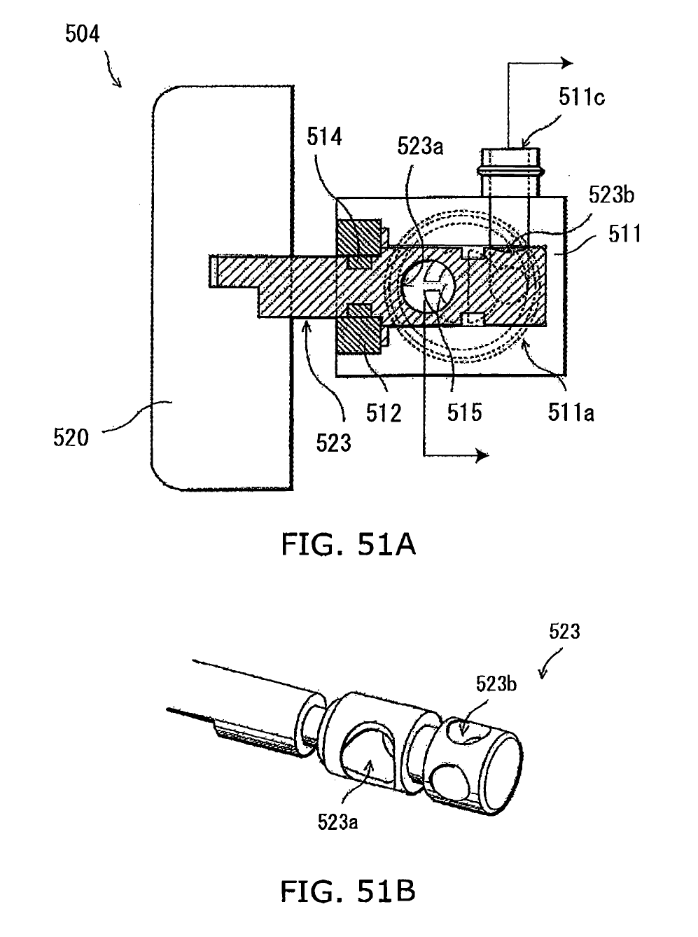

FIG. 51 corresponds to the state of FIG. 49B, in which FIG. 51A is a cross-sectional view of the channel switching unit, and FIG. 51B is a perspective view of the switching valve.

The switching valve 523 has a structure similar to that of the switching valve 513, and is housed in the main body 511. The switching valve 523 includes a throttle 523a and a throttle 523b.

In the first state, the throttle 523b opens the channel communicating between the inflow port 511a and the outflow port 511c. That is, the throttle 523b aligns the axis of the throttle 523b with the axis of the communicating channel to minimize the channel resistance. At this time, the throttle 523a opens the channel communicating between the inflow port 511a and the outflow port 511b in the state of throttling amount A2. That is, the outer peripheral surface of the switching valve 523 in the portion including the throttle 523a partly occludes the opening 515 on the main channel 509b side.

The throttling amount A2 is determined in view of the balance between the total channel resistance on the main channel 509b side and the total channel resistance on the driving unit channel 509a side so as to ensure at least a prescribed flow rate. The term “prescribed flow rate” used herein refers to a flow rate enough to move the core of the driving unit 200. Thus, flow rate Vc flows through the driving unit channel 509a, flow rate Vd flows through the main channel 509b, and the shower unit discharges water at a flow rate equal to the sum of flow rate Vc and flow rate Vd.

In the second state, the throttle 523b closes the channel communicating between the inflow port 511a and the outflow port 511c. That is, the outer peripheral surface of the switching valve 523 in the portion including the throttle 523b occludes the opening on the driving unit channel 509a side and blocks the communication of the channel. At this time, the throttle 523a opens the channel communicating between the inflow port 511a and the outflow port 511b. That is, the throttle 523a aligns the axis of the throttle 523a with the axis of the communicating channel to minimize the channel resistance.

Here, the throttling amount A3 of the throttle 523a is determined so that the total channel resistance on the main channel 509b side in the second state is nearly equal to the total channel resistance of the two channels on the driving unit channel 509a side and the main channel 509b side in the first state.

That is, the throttle 523a and the throttle 523b work cooperatively, and are configured to cancel the variation in flow rate resulting from variation in each channel cross-sectional area.

This configuration allows the sprinkling flow rate Vc+Vd in the first state to be nearly equal to the sprinkling flow rate Ve in the second state.

The shower apparatus using the switching valve 523 also achieves effects similar to those based on the switching valve 513 described above.

Furthermore, in the first state, hot water is supplied also to the main channel 509b side. Hence, as compared to the case of using the switching valve 513, the shower flow rate from the shower unit can be increased. Furthermore, this configuration can also respond to geographic areas with low hydraulic pressure, and can provide the swing shower apparatus to more users. Here, the switching valve 523 serves as a swing stop mechanism.

Furthermore, like the switching valve 513 described above, the switching valve 523 can also be configured to establish an Intermediate state between the first state and the second state.

Next, a switching valve 533, which is a third example of the switching valve, is described.

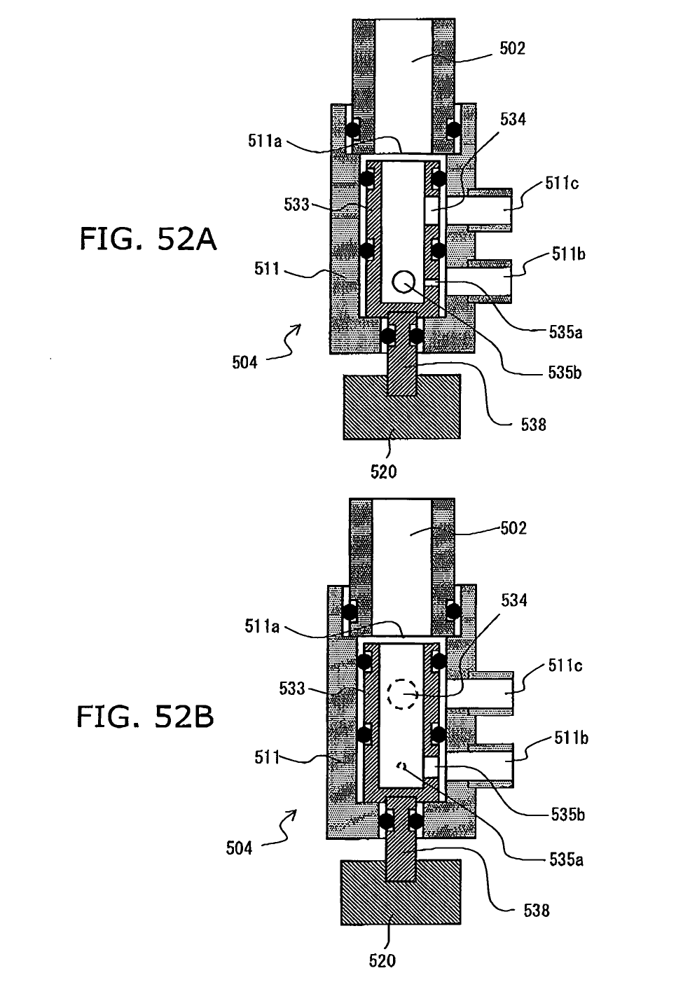

FIG. 52A is a schematic cross-sectional view showing the channel switching unit in the state (first state) where the driving unit channel 509a side is opened, and FIG. 52B is a schematic cross-sectional view showing the channel switching unit in the state (second state) where the driving unit channel 509a side is closed.

The components similar to those of the switching valve and the channel switching unit described above are labeled with like reference numerals, and the description thereof is omitted.

The switching valve 533 is shaped like a cylinder. One of its axial end surfaces is opened, and the other has a shaft portion 538. The shaft portion 538 protrudes from the main body 511, and a handle 520 is connected thereto. A first throttle hole 534 and second throttle holes 535a, 535b are provided in the cylinder side surface of the switching valve 533.

The first throttle hole 534 is provided at the position corresponding to the outflow port 511c, and the second throttle holes 535a, 535b are provided at the position corresponding to the outflow port 511b. In this configuration, in the first state, the outflow port 511c is aligned with the first throttle hole 534, and the outflow port 511b is aligned with the second throttle hole 535a, and in the second state, the outflow port 511c is aligned with no throttle hole, and the outflow port 511b is aligned with the second throttle hole 535b.

The first throttle hole is configured so that its cross-sectional area decreases from the first state (first throttle hole 534) to the second state (no hole), whereas the second throttle hole is configured so that its cross-sectional area increases from the first state (second throttle hole 535a) to the second state (second throttle hole 535b). That is, the first throttle hole and the second throttle hole are opposite to each other in the direction of change in cross-sectional area. The throttling amount thereof is determined like the switching valve 523 described above. That is, the switching valve 533 distributes the flow rate like the switching valve 523, and can reduce the channel resistance of the overall shower apparatus.

In the switching valve 533, the first throttle hole and the second throttle hole can work cooperatively to control the shower unit so that the sprinkling flow rate at swing time is nearly equal to the sprinkling flow rate at swing stop time. These effects are similar to those of the switching valve 513 and the switching valve 523.

In this switching valve 533, the channel is branched from the space inside the cylinder into the first throttle hole and the second throttle hole. Thus, the switching valve 533 is located just at the branch point. This simplifies the internal channel configuration, and the channel switching unit is compact. Furthermore, this facilitates the design of the channel cross-sectional area, or the channel resistance, and enhances controllability.

Furthermore, the switching valve 533 can include a plurality of first throttle holes and second throttle holes to establish intermediate states between the first state and the second state in a stepwise manner. Moreover, the first throttle hole and the second throttle hole can be formed as a single, continuously varied hole so that the switching valve 533 can establish intermediate states between the first state and the second state in a continuous manner. Here, the sprinkling flow rate of the shower is nearly constant, and the swing speed can be gradually varied. Thus, the continuity of the feeling of shower bathing can be ensured.

Next, a channel switching unit 544, which is an alternative example of the aforementioned channel switching unit 504, is described.

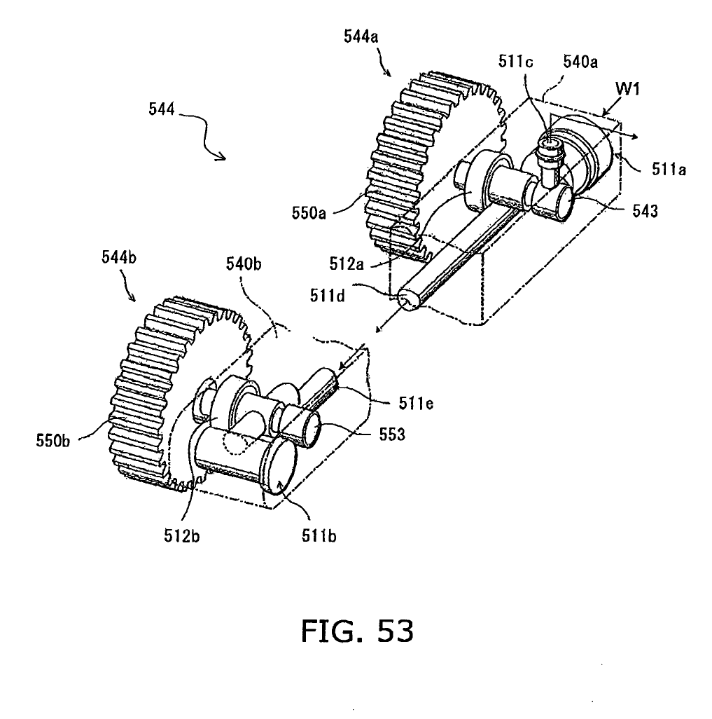

FIG. 53 is a schematic perspective view illustrating the channel switching unit 544.

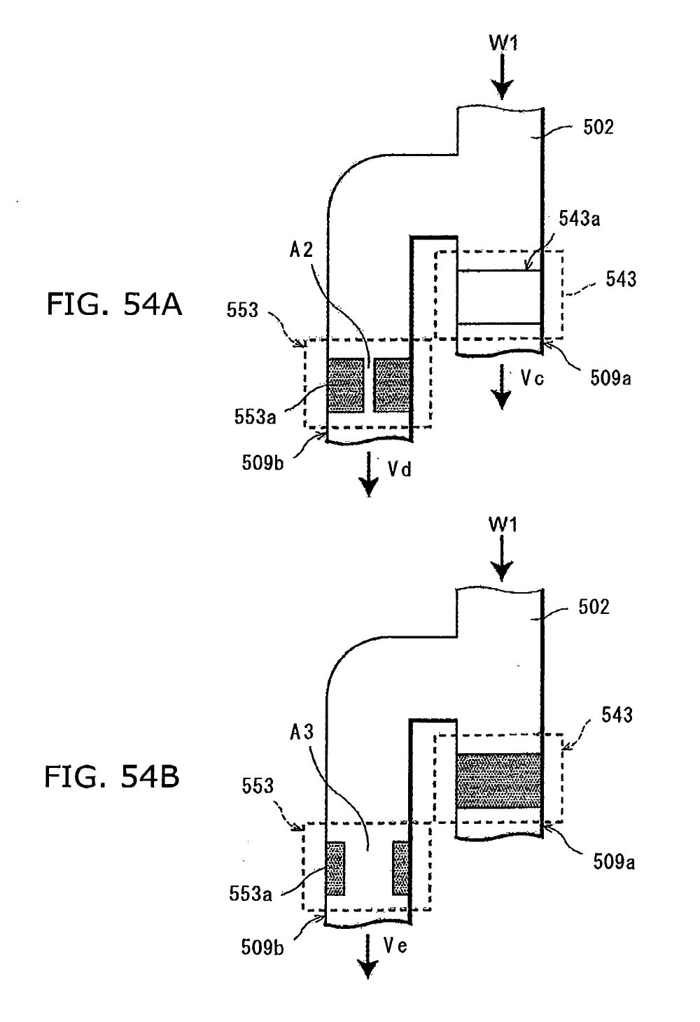

FIG. 54 is a schematic view for illustrating the flow rate control by the channel switching unit 544, in which FIG. 54A is a schematic view showing the state where the driving unit channel 509a side is opened (hereinafter “first state”), and FIG. 54B is a schematic view showing the state where the driving unit channel 509a side is closed (hereinafter “second state”).

The components similar to those of the switching valve and the channel switching unit described above are labeled with like reference numerals, and the description thereof is omitted.

The channel switching unit 544 includes a switching valve 543 including a throttle 543a and a switching valve 553 including a throttle 553a. The switching valve 543 is provided on the driving unit channel 509a and controls the channel resistance of the driving unit channel 509a using the throttle 543a. The switching valve 553 is provided on the main channel 509b and controls the channel resistance of the main channel 509b using the throttle 553a.

The throttling amount of the throttle 543a and the throttle 553a is determined like the switching valve 523 described above. That is, the switching valve 543, 553 distributes the flow rate like the switching valve 523, and can reduce the channel resistance of the overall shower apparatus.

A gear 550a is connected to the switching valve 543, and a gear 550b is connected to the switching valve 553. The switching valve and the gear move together in each combination. The gear 550a and the gear 550b are coupled by a gear, not shown. That is, the switching valve 543 and the switching valve 553 are interlocked. Furthermore, a handle 510 is connected to either the gear 550a or the gear 550b.

In the channel switching unit 544 thus configured, the switching valve 543 and the switching valve 553 separately placed are interlocked to work cooperatively, thereby controlling the channel resistance of each channel so that the sprinkling flow rate at swing time of the shower unit can be nearly equal to the sprinkling flow rate at swing stop time. These effects are similar to those of the switching valves described above. Here, the switching valve 543 and the switching valve 553 serve as a swing stop mechanism.

Furthermore, the switching valve 543 and the switching valve 553 can be placed at any position on the corresponding channel. Furthermore, a throttle adapted to each channel can be selected. This increases the design freedom.

Furthermore, like the switching valve 523 described above, the switching valve 543 and the switching valve 553 can each be configured to establish an intermediate state between the first state and the second state.

The foregoing has described the switching valves used for the swing and swing stop operation of the shower unit by branching the channel communicating with the shower unit. Besides the examples described above, the switching valve can also be shaped like a disc, for instance, and a plurality of throttle holes can be provided in the disc surface.

Next, a third embodiment of the shower apparatus of the invention is described. A shower apparatus 11 of the third embodiment includes a channel guiding hot water to the shower unit after being branched and rejoined, and includes the driving unit 200 described above (the embodiment in which the core undergoes a reciprocating oscillatory motion).

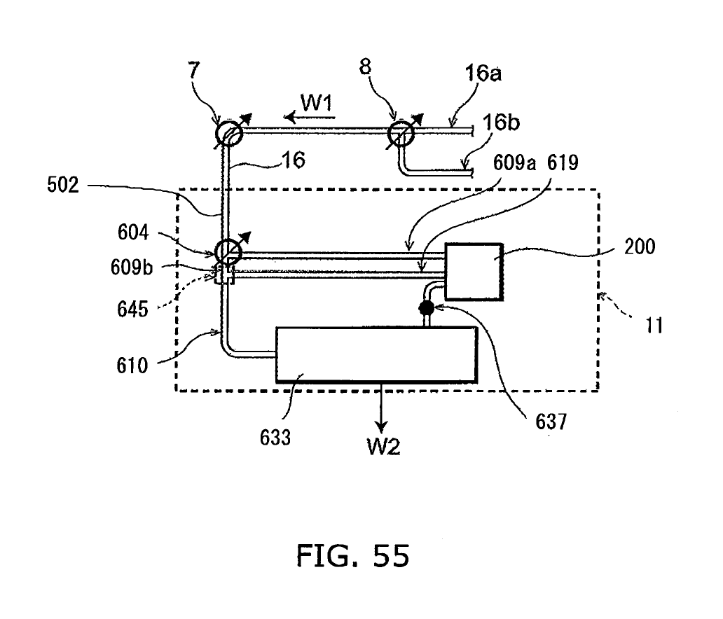

FIG. 55 is a schematic view for illustrating the configuration of the shower apparatus 11 according to the third embodiment.

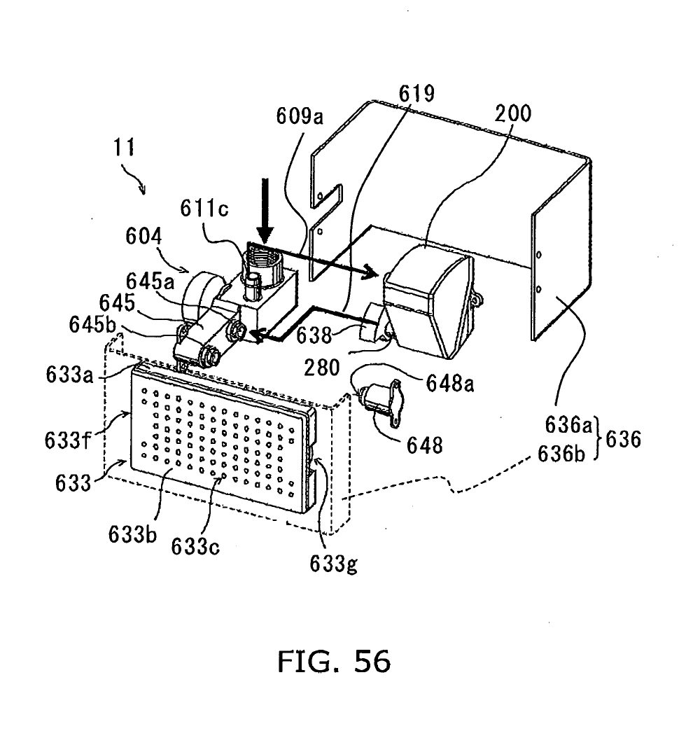

FIG. 56 is a schematic exploded view for illustrating the shape of the shower apparatus 11.

The same components as those illustrated in the above first and second embodiment are labeled with like reference numerals, and the description thereof is omitted as appropriate.

As shown in FIGS. 55 and 56, the shower apparatus 11 includes a driving unit 200, a shower unit 633, a channel switching unit 604 including a switching valve, a confluent portion 645, a casing 636, a power transmission unit 637, and a support body 648. Furthermore, a water stop valve 7 and a temperature adjustment valve 8 are provided on the water supply channel 16 guiding hot water to the shower apparatus 11.

The water supply channel 16 is connected to a channel 502 in the incoming water connecting portion of the shower apparatus 11. The channel 502 is branched in the channel switching unit 604 into a driving unit channel 609a leading to the driving unit 200 and a main channel 609b leading to the confluent portion 645. Furthermore, a channel 619 leading from the driving unit 200 to the confluent portion 645 is provided. Furthermore, a channel 610 leading from the confluent portion 645 to the shower unit 633 is provided. Thus, hot water supplied to the temperature adjustment valve 8 is discharged from the shower sprinkling ports 633c of the shower unit 633.

In this embodiment, the channel 502, the driving unit channel 609a, the channel 619, and the channel 610 constitute a shower channel. The switching valve serves as a swing stop mechanism. Here, the switching valves described above with reference to FIGS. 46 to 54 can be suitably used. A gear 638 coupled to the core and a gear (not shown) fixed to the shower unit 633 serve as the power transmission unit 637.

The casing 636 includes a frame 636a and a cover 636b. The driving unit 200, the channel switching unit 604, the support body 648, and the confluent portion 645 are attached to the frame 636a. The shower apparatus 11 is attached to the wall surface of a bathroom or a shower room via the frame 636a. The cover 636b is provided so as to house pipings and internal components.

Holes 633f, 633g having a circular cross section are provided in the axial end surfaces of a main body 633a of the shower unit 633. A outflow portion 645b described later is attached liquid-tight to one hole 633f. The support body 648 is attached to the other hole 633g. The hole 633f communicates with the shower sprinkling ports 633c through the inside of the main body 633a. The hole 633g does not pass through the inside of the main body 633a, but serves as a bearing.

The shower unit 633 is held so as to be swingable relative to the casing 636 around the axis through the outflow portion 645b and a support body 648a. Hot water flows through the outflow portion 645b into the main body 633a and is discharged from the shower sprinkling ports 633c.

The water discharge tubular body 280, which is the shaft of the core, protrudes from one end surface of the driving unit 200. The water discharge tubular body 280 is mechanically coupled to the gear 638. Furthermore, a gear (not shown) is fixed to the shower unit 633 and meshed with the gear 638. Thus, the motion of the core of the driving unit 200 is transmitted to the swing of the shower unit 633 through the gears.

The confluent portion 645 is connected to the channel switching unit 604. The channel switching unit 604 has the same configuration and function as the channel switching unit 504 described above with reference to FIGS. 45 to 54 except the layout of the inflow port, the outflow port and the like. Hence, the description thereof is omitted.

A channel is formed inside the confluent portion 645 and connected to a channel formed in the channel switching unit 604. This channel constitutes the main channel 609b. Furthermore, the confluent portion 645 includes an inflow portion 645a and the outflow portion 645b, each connected to the channel formed inside the confluent portion 645.

The inflow portion 645a is connected to the water discharge tubular body 280 by a piping, not shown. This piping constitutes the channel 619. Thus, the driving unit channel 609a and the main channel 609b branched in the channel switching unit 604 are joined in the confluent portion 645 and lead to the shower unit 633.

When the channel is connected to the swingable shower unit 633, the connecting portion needs to be liquid-tight, and hence has a higher sliding resistance than a simple bearing. In this respect, a shower apparatus 11 of this embodiment includes the confluent portion 645, which can decrease the number of channel connections to the main body 633a. This can reduce the sliding resistance to the swing of the shower unit 633. Hence, the load on the driving unit 200 can be reduced, which allows downsizing of the driving unit 200 and downsizing of the shower apparatus 11.

Furthermore, when the shower unit 633 stops swinging, the user can manually adjust the sprinkling direction of the shower unit 633 in a lighter operation.

The function of the shower apparatus 11 thus configured is similar to that of the shower apparatus 10 described above, and hence the description thereof is omitted.

Next, a fourth embodiment of the shower apparatus of the invention is described. A shower apparatus 5 of the fourth embodiment is based on the driving unit 100 described above (the embodiment in which the core undergoes a reciprocating linear motion).

FIGS. 57 to 59 are schematic views showing a part of the shower apparatus 5 according to a fourth embodiment of the invention.

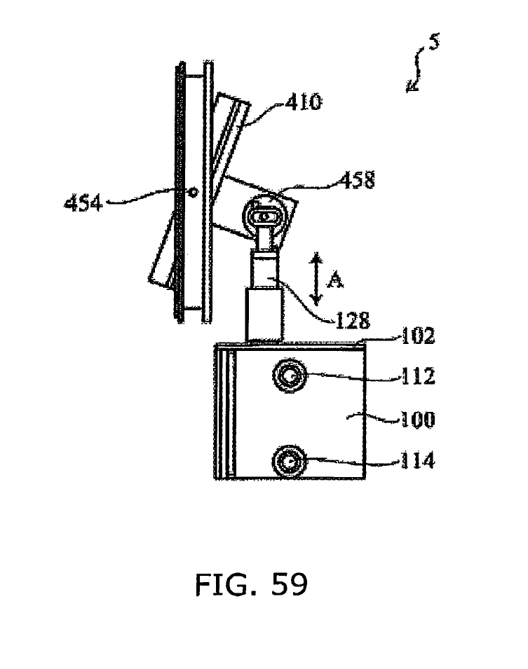

The shower apparatus 5 of this embodiment is also provided with the shower unit 410 supported by the flame not shown in a figure as well as the shower apparatus 4 of the first embodiment and is allowed to be embedded in a wall of the shower booth 950 and a bathroom or the like. The shower unit 410 is axially supported by a pivotal supporting unit 454 and is allowed to swing up and down, as shown in FIG. 58 and FIG. 59. And in this embodiment, the driving unit 100 described previously with reference to FIGS. 1 to 17 is provided. One end 128 of the core 120 provided in the driving unit 100 protrudes from the housing 102 and is coupled to the link mechanism 458. And the reciprocating linear motion shown by arrow A is converted to the reciprocating swing motion of the shower unit 410 (power transmission unit having converting mechanism). In addition, the water discharged from the core inner channel 124 (See FIG. 1) is supplied to the shower unit 410 via the fixed water guide channel described previously with reference to the first embodiment or a flexible water guide pipe or the like.

The link mechanism 458 includes a cam including a long hole, and a pin inserted into the long hole. The cam is connected to the tip of one end 128 of the core 120. The pin is provided on the shower unit 410 at a position distanced from the pivotal supporting unit 454. When the cam vertically moves together with the core 120, the pin vertically moves while moving along the long hole, and reciprocates around the pivotal supporting unit 454. This allows the shower unit to swing. That is, the link mechanism 458 serves as a power transmission unit.

Also in this embodiment, the switch 420, the bypass channel 340, and the opening/closing valve 342 as described above with reference to FIGS. 35 to 41 can be provided to switch on/off the swinging motion of the shower unit 410 in accordance with the user's preferences. Furthermore, in the stopped state, the shower unit 410 can be pushed by a hand or the like to change the sprinkling direction. Furthermore, similar effects are also achieved by providing a plurality of channels, a channel switching unit, or a switching valve as described above with reference to FIGS. 45 to 54. That is, the sprinkling flow rate at swing time of the shower unit 410 can be nearly equal to the sprinkling flow rate at swing stop time, and the continuity of the feeling of shower bathing can be maintained. Furthermore, the shower unit is stopped by decreasing the fluid force required for the motion of the core, and hence the user can manually adjust the sprinkling direction at swing stop time. Furthermore, the link mechanism 458 couples the shower unit 410 to the driving unit 100 irrespective of the swing state of the shower unit. Hence, the shower unit can smoothly restart swinging no matter how it has been manually moved.

Next, a fifth embodiment of the shower apparatus of the invention is described. A shower apparatus 12 of the fifth embodiment includes a channel guiding hot water to the shower unit after being branched and joined in a driving unit, and includes the driving unit based on a waterwheel.

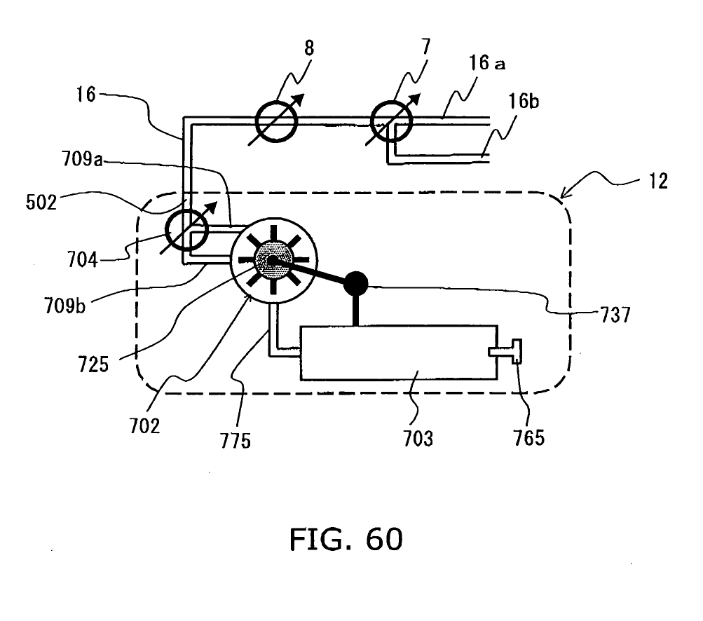

FIG. 60 is a schematic view illustrating the configuration of the shower apparatus 12 according to the fifth embodiment.

The shower apparatus 12 has an appearance similar to that of the shower apparatus 11, and includes a casing, not shown, and a shower unit 703. Furthermore, the shower apparatus 12 includes a channel switching unit 704 similar to that illustrated in FIGS. 45 to 54, and a handle for manipulating the switching valve. In the casing, a driving unit 702 including a waterwheel 725 is provided. Furthermore, a gear box 737 for decelerating the rotation of the waterwheel 725, converting it into repetitive motion, and transmitting it to the shower unit 703, is provided.

A channel 502 in the incoming water connecting portion of the shower apparatus 12 is connected to a water supply channel 16. The channel 502 is branched in the channel switching unit 704 into a driving unit channel 709a and a diversion channel 709b. The driving unit channel 709a communicates with the driving unit 702 so as to generate a fluid force for rotating the waterwheel 725. The diversion channel 709b communicates with the driving unit 702 so as not to generate a fluid force enough to rotate the waterwheel 725. A channel 775 communicates from the driving unit 702 to the shower unit 703 so that hot water poured into the driving unit 702 through the driving unit channel 709a and the diversion channel 709b is collectively guided to the shower unit 703. The shower unit 703 is supported by the channel 775 and a support shaft 765 at its axial end portions so as to be swingable relative to the casing.

In this embodiment, the channel 502, the driving unit channel 709a, and the channel 775 constitute a shower channel. The switching valve serves as a swing stop mechanism. Here, the switching valves described above with reference to FIGS. 46 to 54 can be suitably used. The gear box 737 serves as a power transmission unit.

The driving unit 702 includes a rotatable waterwheel 725, which is rotated by the fluid force generated by hot water poured from the driving unit channel 709a into the driving unit 702. The waterwheel shaft of the waterwheel 725 protrudes outward from the driving unit 702, and a first stage gear rotated together with the waterwheel 725 is provided on the waterwheel shaft. The gear box 737 is coupled to the first stage gear. The last gear of the gear box 737 is meshed with a gear provided in the shower unit 703. A crank mechanism is incorporated in the gear box 737 and configured so that the unidirectional rotation of the waterwheel 725 is decelerated by a plurality of gears and converted into repetitive motion. That is, a decelerated repetitive motion is outputted from the last gear of the gear box 737 and transmitted to the shower unit 703. At this time, the hot water poured into the driving unit 702 is guided through the channel 775 to the shower unit 703 and discharged from the shower unit 703.

Like the channel switching unit 504 described above, the channel switching unit 704 serves so that hot water poured in through the channel 502 is distributed Into the driving unit channel 709a and the diversion channel 709b. Here, hot water poured from the diversion channel 709b into the driving unit 702 does not generate a fluid force rotating the waterwheel 725. That is, by manipulating the switching valve in the channel switching unit 704, the motion of the waterwheel 725 can be controlled, and the shower unit 703 can be controlled to swing and stop swinging. Furthermore, the sprinkling flow rate at swing time can be nearly equal to the sprinkling flow rate at swing stop time. Hence, the continuity of the feeling of shower bathing can be maintained.

Thus, the driving unit 702 serves to generate a driving force, and also serves to join the two channels. This simplifies the channel configuration and improves packaging efficiency in the casing. Furthermore, the channel 775 is the only channel communicating with the shower unit 703. Hence, the shower unit 703 includes only one bearing portion requiring sealing consideration. This increases reliability and reduces the sliding resistance.

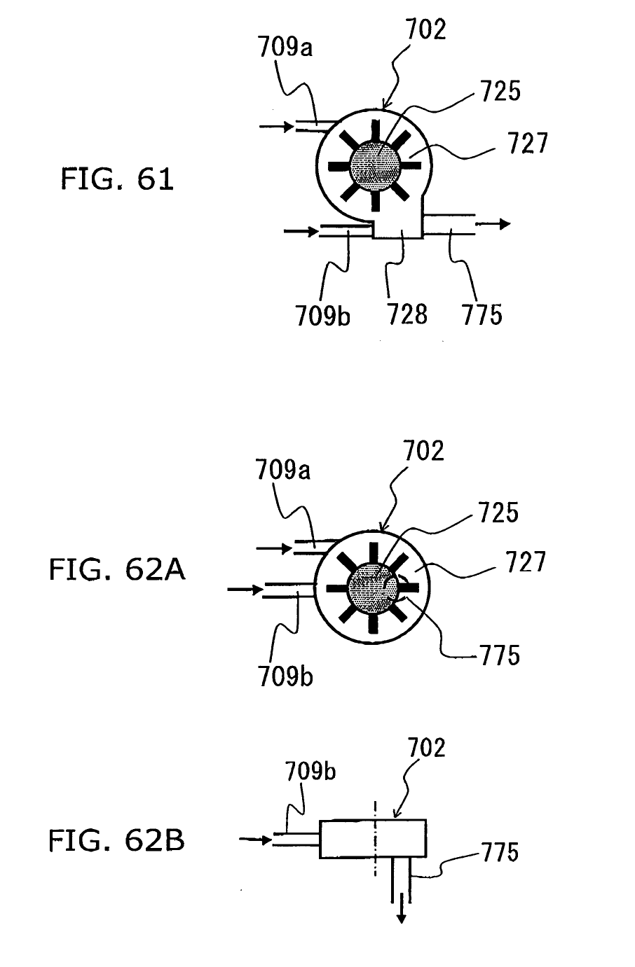

Here, examples of allowing the diversion channel 709b to communicate with the driving unit 702 so as not to generate a fluid force enough to rotate the waterwheel 725 are described with reference to FIGS. 61 and 62.

FIG. 61 is a schematic view illustrating a first example of the driving unit used in the shower apparatus 12.

In this first example, the driving unit 702 includes a waterwheel chamber 727 and a buffer 728, and the waterwheel 725 is housed in the waterwheel chamber 727. The waterwheel chamber 727 communicates with the buffer 728. Furthermore, the driving unit channel 709a communicates with the waterwheel chamber 727, and the diversion channel 709b communicates with the buffer 728. Furthermore, the channel 775 communicates with the buffer 728.

The waterwheel 725 is a centrifugal waterwheel rotatable about an axis perpendicular to the figure. The driving unit channel 709a communicates with the waterwheel chamber 727 at a position distanced from the rotation axis of the waterwheel 725, where the driving unit channel 709a is perpendicular to the blade of the waterwheel 725. That is, hot water poured into the waterwheel chamber 727 through the driving unit channel 709a applies a fluid force to the blade of the waterwheel 725 to rotate the waterwheel 725. On the other hand, hot water poured into the buffer 728 through the diversion channel 709b is guided to the channel 775 without exerting a fluid force enough for rotation on the blade of the waterwheel 725.

In the first example, the waterwheel 725 can be an axial-flow waterwheel instead of the centrifugal waterwheel. In this case, for an axial-flow waterwheel rotatable about an axis perpendicular to the figure, the driving unit channel 709a communicates with the waterwheel chamber 727 in the direction perpendicular to the figure.

FIG. 62 is a schematic view illustrating a second example of the driving unit used in the shower apparatus 12, in which FIG. 62A is a schematic view as viewed in the direction along the rotation axis of the waterwheel, and FIG. 62B is a schematic view as viewed in a direction perpendicular to the rotation axis of the waterwheel.

In this second example, the driving unit 702 includes a waterwheel chamber 727, and the waterwheel 725 is housed in the waterwheel chamber 727. The driving unit channel 709a, the diversion channel 709b, and the channel 775 communicate with the waterwheel chamber 727.

The waterwheel 725 is a centrifugal waterwheel rotatable about an axis perpendicular to FIG. 62A. The position at which the driving unit channel 709a communicates with the waterwheel chamber 727, and the function of the driving unit channel 709a, are as described above with reference to the first example. On the other hand, the diversion channel 709b communicates with the waterwheel chamber 727 at a position where the diversion channel 709b is perpendicular to the rotation axis of the waterwheel 725. That is, hot water flowing into the waterwheel chamber 727 through the driving unit channel 709a is poured into the waterwheel chamber 727 perpendicularly to the rotation axis of the waterwheel 725, and hence guided to the channel 775 without exerting a fluid force enough for rotation on the blade of the waterwheel 725. Here, advantageously, the channel 775 can be placed at a position symmetric with respect to the rotation axis of the waterwheel 725 so that the hot water from the diversion channel 709b can be further prevented from generating a fluid force affecting the rotation. For instance, the position is located on the line connecting the communicating position of the diversion channel 709b and the rotation axis behind the waterwheel chamber 727 in FIG. 62A.

Thus, the waterwheel and the shower unit can be reliably stopped by decreasing the fluid force of rotating the waterwheel. Furthermore, by preventing the waterwheel from rotating at swing stop time of the shower unit, the load on the waterwheel rotating at high speed (several thousand rpm), the waterwheel shaft, and the gear box is reduced, and the reliability is increased.

Next, a sixth embodiment of the shower apparatus of the invention is described. A shower apparatus 13 of the sixth embodiment includes a driving unit based on a waterwheel, and is configured so that the driving unit and the shower unit can be decoupled.

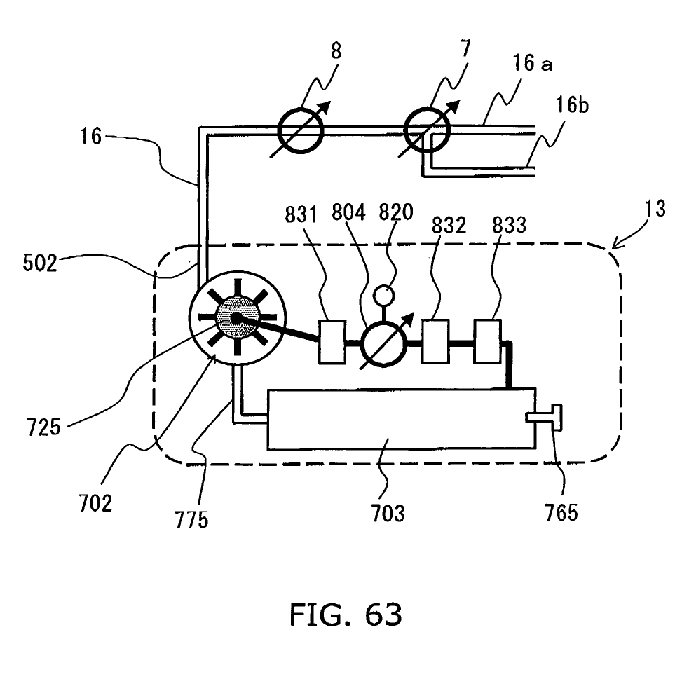

FIG. 63 is a schematic view showing the configuration of the shower apparatus 13 according to the sixth embodiment.

The shower apparatus 13 has an appearance similar to that of the shower apparatus 11, and includes a casing, not shown, and a shower unit 703. In the casing, a driving unit 702 including a waterwheel 725 is provided. A channel 502 in the incoming water connecting portion of the shower apparatus 13 is connected to a water supply channel 16. The channel 502 communicates with the driving unit 702 so as to generate a fluid force for rotating the waterwheel 725. Furthermore, a channel 775 communicates from the driving unit 702 to the shower unit 703. The shower unit 703 is supported by the channel 775 and a support shaft 765 at its axial end portions so as to be swingable relative to the casing. Furthermore, a deceleration mechanism 831 for decelerating the rotation of the waterwheel 725, a link mechanism 832 for converting the decelerated rotation into repetitive motion, and a conversion mechanism 833 for converting the repetitive motion into swinging motion are coupled in this order between the driving unit 702 and the shower unit 703. Furthermore, a clutch mechanism 804 is provided between the deceleration mechanism 831 and the link mechanism 832.

In this embodiment, the channel 502 and the channel 775 constitute a shower channel. The clutch mechanism 804 serves as a swing stop mechanism. The deceleration mechanism 831, the link mechanism 832, and the conversion mechanism 833 serve as a power transmission unit.

The deceleration mechanism 831 includes a multistage gear train. The link mechanism 832 has a crank structure. The conversion mechanism 833 includes a single-stage gear. Coupling of these mechanisms allows the rotation of the waterwheel 725 to be converted into the swinging motion of the shower unit 703.

The clutch mechanism 804 is located between the last gear of the deceleration mechanism 831 and the rotary link of the link mechanism 832 and controls the coupling state of the two mechanisms. That is, the clutch mechanism 804 can couple and decouple them. In other words, the clutch mechanism 804 can control the coupling state between the driving unit 702 and the shower unit 703, thereby controlling the swing state of the shower unit 703. Here, the user controls the clutch mechanism 804 by a manipulator 820.

When the clutch mechanism 804 is manipulated to block the transmission of the motion of the driving unit 702, the shower unit 703 stops swinging. At this time, what is coupled to the shower unit 703 is the conversion mechanism 833 and the link mechanism 832. Hence, the shower unit 703 is not affected by the sliding torque of the driving unit 702 and the deceleration mechanism 831. Thus, the user can manually and easily change the sprinkling direction of the shower unit 703. Furthermore, no overload due to inverse input is applied to the driving unit 702 and the deceleration mechanism 831, and hence such problems as breakage of gear teeth and wear of the rotary shaft can be prevented. Furthermore, the clutch mechanism 804 is located between the deceleration mechanism 831 and the link mechanism 832 to couple and decouple between the rotary motions. Hence, at the time of restarting swinging, the clutch mechanism 804 does not need to align the coupling position, and swinging can be smoothly restarted.

Alternatively, the clutch mechanism 804 can be a mechanism for controlling slipperiness between rotators. In this case, in addition to the coupled and decoupled state, an intermediate state (half clutch) can be established, and the swing speed can be controlled.

Up to this point the embodiment of the invention has been described. However, the invention is not limited to these examples. That is, any ones to which a person skilled in the art added design modification with respect to any element comprising the shower apparatus of the invention are also encompassed with the scope of the invention as long as they include the features of the invention.

### INDUSTRIAL APPLICABILITY

This invention can improve feeling of shower bathing. More advantageously, this invention can provide a shower apparatus with improved usability when switched between the state of discharging water while swinging the shower unit and the state of discharging water with the shower unit fixed.

1. A shower apparatus comprising:
a shower unit operable for swinging and sprinkling water while swinging;
a driving unit configured to generate driving force which is used for the swing of the shower unit by water;
a shower channel configured to guide water to the shower unit via the driving unit;
a power transmission unit configured to couple the driving unit with the shower unit and transmit the driving force generated by the driving unit to the shower unit; and
a swing stop mechanism operable to stop the swinging of the shower unit,
wherein the shower unit sprinkles the water that is used for generating the driving force at the driving unit,
the swing stop mechanism is configured to stop the swinging of the shower unit while keeping sprinkling water from the shower unit, and
the sprinkling flow rate from the shower unit before stopping the swinging is equal to the sprinkling flow rate from the shower unit after stopping the swinging.

2. The shower apparatus according to claim 1, wherein the power transmission unit couples between the driving unit and the shower unit in both the state of the shower unit at the time of the swinging and the state thereof at the time of stopping the swinging.

3. The shower apparatus according to claim 1, wherein sprinkling from the shower unit continues in process of switching the state where the shower unit sprinkles the water while swinging to the state where the shower unit sprinkles with the swinging stopped.

4. The shower apparatus according to claim 1, wherein the
driving unit includes a core to which fluid force generated by water guiding into the driving unit is acted,
the driving unit is configured to generate the driving force by a motion of the core that is generated by receiving the fluid force,
the swing stop mechanism is configured to stop the swinging by decreasing the fluid force acting on the core.

5. The shower apparatus according to claim 1, wherein
a plurality of routes guiding the water to the shower unit are provided,
at least one of the routes includes the shower channel, and
the swing stop mechanism decreases flow rate flowing from the shower channel into the driving unit.

6. A shower apparatus comprising:
a shower unit operable for swinging and sprinkling water while swinging;
a driving unit configured to generate driving force which is used for the swing of the shower unit by water;
a shower channel configured to guide water to the shower unit via the driving unit;
a power transmission unit configured to couple the driving unit with the shower unit and transmit the driving force generated by the driving unit to the shower unit; and
a swing stop mechanism operable to stop the swinging of the shower unit,
wherein the shower unit sprinkles the water that is used for generating the driving force at the driving unit,
the swing stop mechanism is operable to restart the swinging of the shower unit by operation of the driving unit irrespective of the stopped position of the shower unit, and
a sprinkling direction of the shower unit can be manually changed in a state where the swinging of the shower unit is stopped while keeping sprinkling the water.

7. The shower apparatus according to claim 6, wherein the power transmission unit couples between the driving unit and the shower unit in both the state of the shower unit at the time of the swinging and the state thereof at the time of stopping the swinging.

8. The shower apparatus according to claim 6, wherein
the driving unit includes a housing having a space inside thereof and guiding water therein, and a core on which fluid force generated by water guiding into the housing is acted, the core dividing the space of in the housing into a first pressure chamber and a second pressure chamber and generating the driving force by a motion of the core which is generated when the core receives the fluid force.

9. The shower apparatus according to claim 8, further comprising:
a control mechanism configured to reverse moving direction of the core.

10. The shower apparatus according to claim 6, wherein sliding torque for changing the sprinkling direction of the shower unit is in a range of 10-1500 mN·m.

11. The shower apparatus according to claim 6, wherein
the power transmission unit includes a deceleration mechanism, a link mechanism, and a conversion mechanism,
the deceleration mechanism, the link mechanism, and the conversion mechanism are arranged in this order between the driving unit and the shower unit,
the swing stop mechanism is located between the deceleration mechanism and the link mechanism,
the driving unit generates rotary motion,
the deceleration mechanism decelerates the rotary motion of the driving unit,
the link mechanism converts the decelerated rotary motion into repetitive motion,
the conversion mechanism converts the repetitive motion into the swinging of the shower unit, and
the swing stop mechanism is configured to transmit the motion of the driving unit to the shower unit and disable the transmission.

12. A shower apparatus comprising:
a shower unit operable for swinging;
a shower channel configured to guide water to the shower unit;
a driving unit provided on the shower channel and including a core moved by water and two pressure chambers formed across the core;
a control mechanism configured to reverse moving direction of the core;
a power transmission unit configured to couple between the driving unit and the shower unit and transmit motion of the core to the shower unit; and
a bypass channel communicating between the two pressure chambers; and
an opening degree adjustment valve provided on the bypass channel,
the opening degree adjustment valve being operable to adjust pressure difference occurring between the two pressure chambers.

13. The shower apparatus according to claim 12, wherein the control mechanism is a mechanism including one of an elastic body and a magnet.

14. The shower apparatus according to claim 12, wherein the opening degree adjustment valve can be adjusted to stop the swinging of the shower unit while keeping sprinkling from the shower unit.
